(19) United States
(12) Patent Application Publication
(10) Pub. No.: US 2006/0136275 A1
(43) Pub. Date: Jun. 22, 2006

(54) Method and a device for optimizing a company structure

(76) Inventor: Liviu Cotora, Neuilly/Seine (FR)

Correspondence Address: Lawrence G. Fridman, Esq.;SILBER & FRIDMAN, Suite 207, 1037 Rt 46 East, Clifton, NJ, 07013, US

(21) Appl. No.: 11/264,343

(22) Filed: Oct. 25, 2005

Related U.S. Application Data
(63) Continuation of application No. PCT/EP03/01943, filed on Feb. 25, 2003.

(51) Int. Cl. G06F 9/44

(52) U.S. Cl. 705/7; 705/8

(57) ABSTRACT

A method for optimizing a company structure consists of subdividing the company structure at least into a producing section and a non-producing section. For each section, value chains are generated with their respective participating structural elements. A matrix is build by optimizing the value chains. A device for optimizing a company structure contains a computer arrangement including an input device and an output device. A value chain generator arrangement generates digital value chains of different company components by assigning a value to each participating structure element of the company components. An evaluation unit is provided for building and evaluating a matrix representing the company structure generated by the value chains. Qualified arrangements are included for optimizing the value chain matrix.

This application is continuation of International application PCT/EP 2003/001943 filed Feb. 25, 2003.

### FIELD OF THE INVENTION

The present invention relates generally to a method for optimizing a company structure. Furthermore the invention relates to a device for optimizing a company structure.

### BACKGROUND OF THE INVENTION

A company often has a very complex business structure. It is difficult for a manager to make effective operating decisions. With the exception of cash flow, managers lack tools and methods to assist in decision making.

For example, a company manager must decide whether a new machine is a wise company investment. The purchase often has many consequences. Perhaps the company can employ fewer workers with this machine and save money because the work is done by the new machine. On the other hand, the company may now require an operator to check the machine. This operator requires better training and the cost for such a well qualified person are oftentimes higher than that of the previous worker. Furthermore, the company may need a bank loan to procure the new machinery. Procuring the machine binds capacity of work and capital. The manager must also account for future costs related to the new machine. Therefore, he must calculate the risk for such an investment with several factors. Further complicating the matter, many sectors of the company may be involved in making the expected decision.

Still further, when a new service or product is introduced, the manager needs a tool or method to provide a quick overview of the various implications to his company. What is the influence of such a new product to the company? The manager must estimate the risk of the new product and the necessary changes to the company. As an example, the personnel may need to be sent to training centres. The manager needs a tool or a method to optimize the structure of his company, and especially the way of decision making process in his company.

This invention provides a method and/or a device which supports a manager of a company and gives him the best overview of the company so that he may make his decisions in a manner so as to optimize the structure of his company.

The aforementioned problem is solved by a method of optimizing a company structure using the following steps:
(a) subdividing the company structure into at least a producing and non-producing section,

generating a value chain for the producing section by assigning a value to each participating structure element,

generating a value chain for the non-producing section by assigning a value to each participating structure element,
(b) building a matrix by the chains, and
(c) optimizing every value in the matrix and considering the influence to the whole structure of the company represented by the matrix. The invention also provides by a device for optimizing a company structure comprising the following elements:
(a) a computer device including an input device and an output device,
(b) a value chain generator which generates digital value chains of different company components by assigning a value to each participating structure element of the said company components,
(c) an evaluation unit for building and evaluating a matrix representing the company structure generated by the said value chains, and
(d) optimizing means for optimizing each value of the value chains.

The advantage to the present invention is that a manager can overview the whole company structure and optimize its decisive parameters. Early in the decision making process, he can discover effects to the company through a simulation. Therefore, by using the present invention it is possible to predict probably outcomes as to the future of the company. The method and device show the manager the influence of individual values to the entire system. Changing a single value can effect the whole company structure.

### BRIEF DESCRIPTION OF THE DRAWINGS

FIG. 1 shows in principle a company structure;

FIG. 2 demonstrates the principles of generating value chains;

FIG. 3 illustrates the main steps of the suggested method of the invention;

FIG. 4 shows a value chain matrix with two dimensions;

FIG. 5 shows a multi value chain matrix with three dimensions;

FIG. 6 shows in principle a device of the invention for optimizing a company structure;

FIG. 7 shows an example of the value flow balance;

FIG. 8 shows an example of the multi value balance;

FIG. 9 shows one value flow balance for each value;

FIG. 10 shows a value flow balance;

FIG. 11 shows a multi value flow balance;

FIG. 12 shows a multi-value center;

FIG. 13 shows, the flowing values in between the different value types and the different value centers inside the same value type;

FIG. 14 shows a multi-value management engine;

FIG. 15 shows the influence of multi value flow balance;

FIG. 16-19 shows Organizational multi-value cells;

FIG. 20 shows a functional domain multi-value chain;

FIG. 21 shows a Multi-value flow measurement cell;

FIG. 22 shows a multi-value measurement center in which is fixed the measure unit “u” and the “value multiplier;

FIG. 23 shows a multi flow cell;

FIG. 24 shows a value chain consolidation in the value balance;

FIG. 25 shows the conjunction of the value flow balance with the value measurement flow balance;

FIG. 26 shows the conjunction of the value flow balance with the value measurement flow balance;

FIG. 27 shows the principles of a first example measuring and assigning values;

FIG. 28 shows the principles of a second example measuring and assigning values;

FIG. 29 shows the conjunction of the value flow balance with the value measurement flow balance;

FIG. 30 shows the principles of a third example measuring and assigning values;

FIG. 31 shows an organizational know-how value cell;

FIG. 32 shows an organizational know-how value cell;

FIG. 33 shows an organizational multi-value cell;

FIG. 34 shows a section of the organizational multi-value cell at department level;

FIG. 35 shows organizing the value centers in value-flow balances; and

FIG. 35a shows that the sum of three categories of value centers will be contained in the total production category.

### Brief Description of the Tables

Table 1 shows a table of a know-how value flow balance;

Table 1a-1g shows the concrete allocation of values for the know-how;

Table 2, 2a shows a table of a partnership value flow balance;

Table 2b-2e shows the concrete allocation of values for the partnership;

Table 3, 3a shows a table of a production value flow balance;

Table 3b-3e shows the concrete allocation of values for the production;

Table 4 shows a table of a competence value flow balance;

Table 4a shows a legend for different competence values;

Table 4b-4e shows the concrete allocation of values for the competence;

Table 5 shows a legend and an interpretation for different values contributions; and

Table 5a-5s shows the concrete multi-value allocation of values for product-production.

### DESCRIPTION OF THE PREFERRED EMBODIMENT

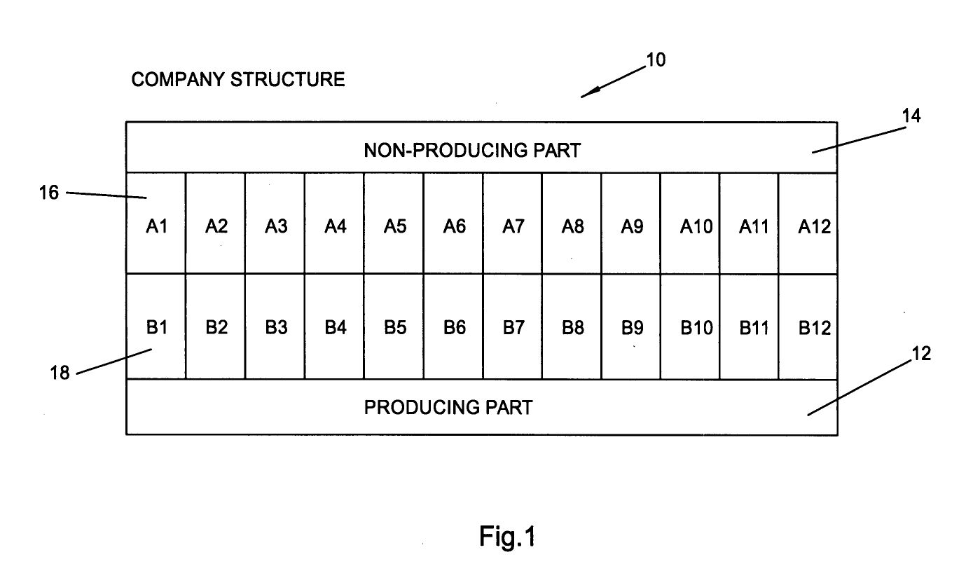

FIG. 1 shows in principle a company structure 10. The company structure 10 is subdivided at least into a producing section 12 and a non-producing section 14. The said producing 12 section and the said non-producing section 14 each consist of structure elements 16 respectively 18. The structure elements 16, 18 are designated as A1 up to A12 or B1 up to B12. The number of structure elements 16, 18 is selected as required. The structure elements 16 and 18 may be, by means of example, different departments, such as an administration department and production department of the company. The ready products also represent parts of the producing section 12.

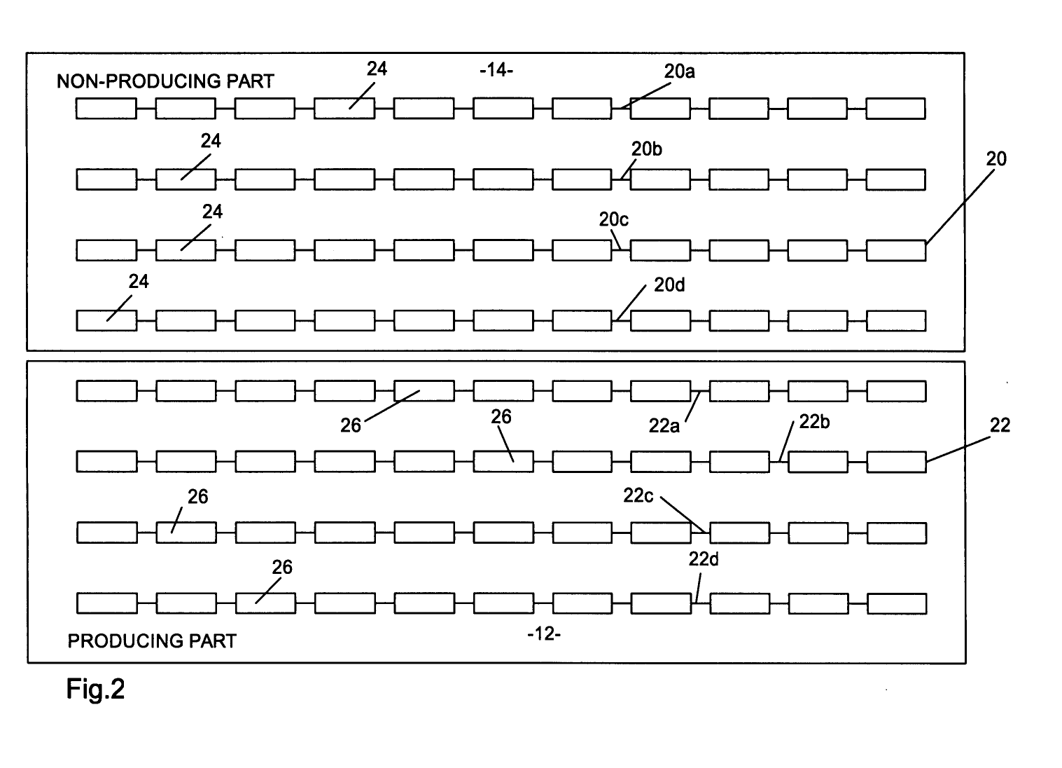

FIG. 2 shows the principles of generating value chains 20, 22. The present example contains four value chains 20a, 20b, 20c 20d in the non-producing section 14 and four value chains 22a, 22b, 22c 22d in the producing section 12. The value chains 20, 22 are composed of said structure elements 16 and 18 joined to value chains 20, 22. Said structure elements 16, 18 are symbolized by small rectangles 24 and 26.

For example, value chain 20a of the non-producing section 14 contains all structure elements 24 of the company comprising the internal know-how. Generally, the know-how is defined as the sum of all informational values linked to a clearly defined operation or process, specifically dedicated to him. The know-how is not formalized.

Furthermore value chain 20b of the non-producing section 14 contains all structure elements 24 of the company which comprises external know-how, i.e. know-how from outside, which influences the company. The external know-how comprises the exchange of know-how between all external companies and the own company. External know-how as mentioned in present invention additionally contains for example know-how brought by customers, partners etc. to the company.

Value chain 20c represents the internal respectively external competences and all their participating structure elements 24. The competence is defined as the sum of all cognitive, training educational, courses and generally every informational values which are not specifically dedicated to an operation or process or producing a specific product. The competence is like a general basis making possible to receive, produce and distribute know-how. A simple competence value can only receive a simple know-how value. The competence is structured and formalized in a clearly defined acquisition-production-distribution.

Another value chain 20d represents the partnerships. The different structure elements 24 are representing the influence of the corresponding partnerships to the company. In principle it is possible to generate an unlimited number of value chains 20, 22.

Analogous to generating the value chains 20 of the non-producing section 14 the value chains 22 of the producing section 12 are prepared. Value chain 22a represents the components of a product, especially for example the material. The structure elements 18 of the value chains 22 are generally symbolized by rectangles 26.

Value chain 22b of the producing section 12 represents the employed machines. Value chain 22c perhaps represents the employees which are busy in the production of the company. Furthermore value chain 22d is generated for the external suppliers.

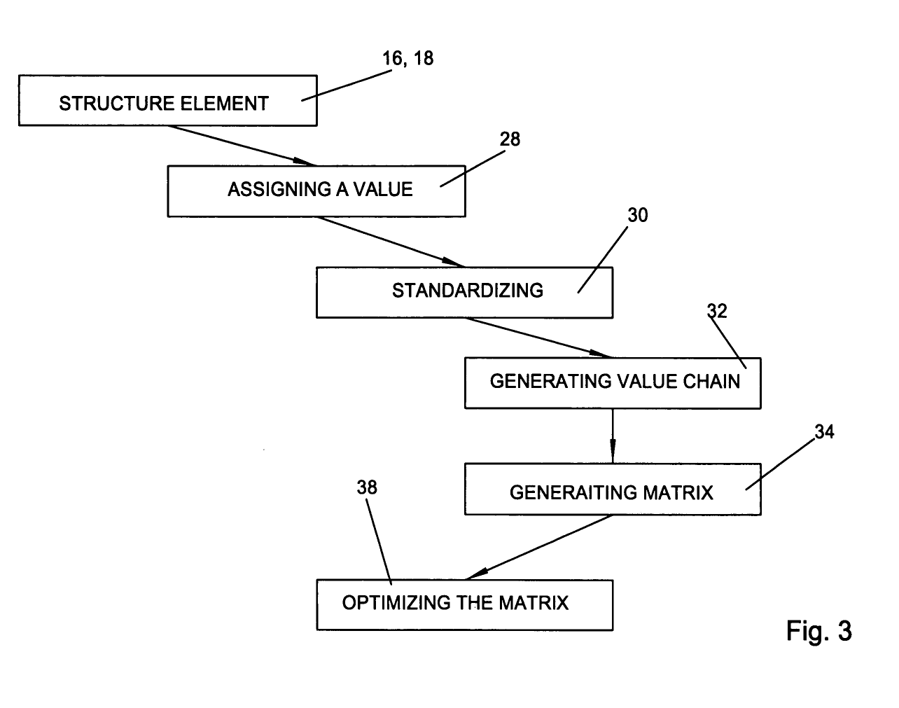

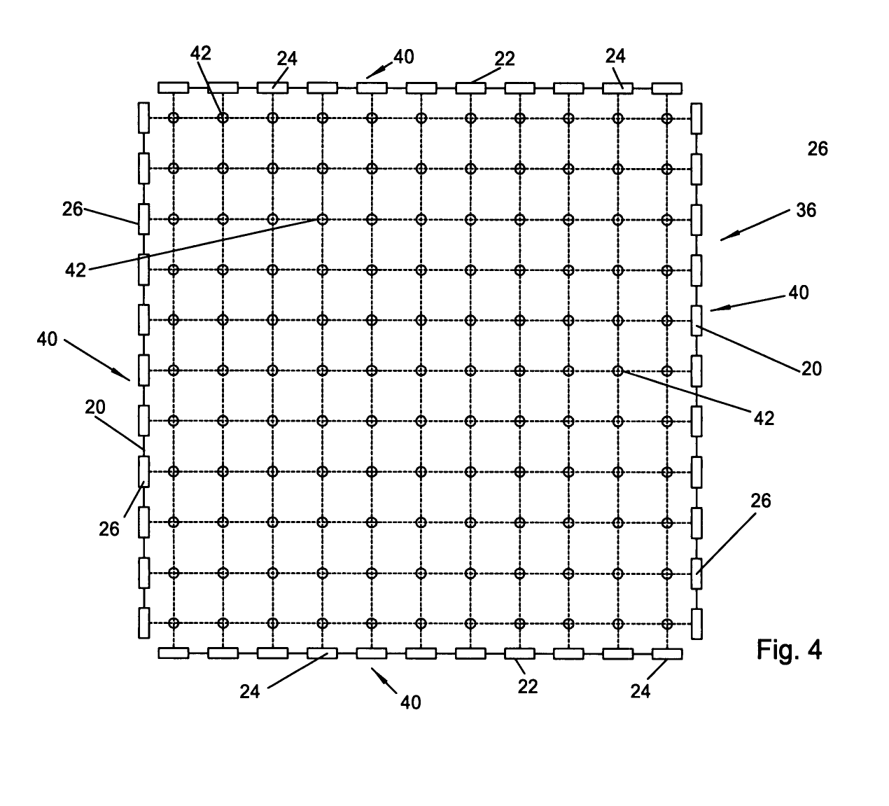

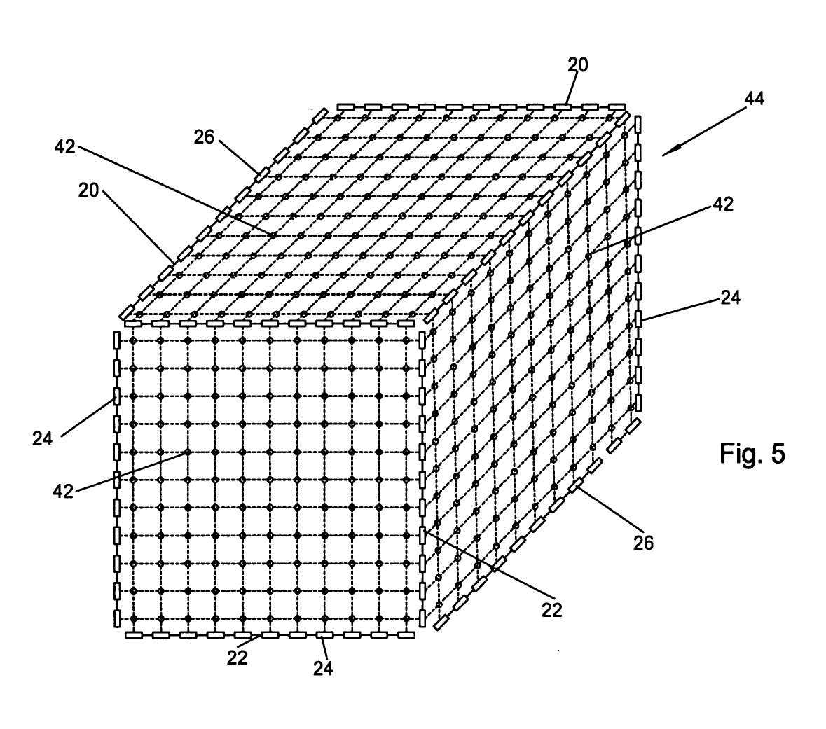

Relating to FIG. 3 the most important steps of the method are now described. Each structure element 16, 18 a value is assigned to. The scale for the values which are assigned to the structure elements 16, 18 are often chosen arbitrarily but in a qualified manner. The process of assigning a value is symbolized by rectangle 28. After assigning a value they are usually standardized to represent comparable values, symbolized by rectangle 30. This step is helpful but not absolutely necessary for the invention. Then the standardized values are combined to form value chains 20, 22 respectively as already described above. Generating of value chains 20, 22 is symbolized by rectangle 32. Rectangle 34 illustrates the process of building a value chain matrix 36, 44 as shown for example in FIGS. 4 and 5. The last step of the method of the invention is the optimizing of the value chain matrix 36. The process of optimizing the value chain matrix 36 should be illustrated by rectangle 38. The value chain matrix 36 is also called (multi) value flow balance.

The value chains 20, 22 are joined to the said value chain matrix 36 as shown in FIG. 4. FIG. 4 shows a two dimensional matrix 36. The borders 40 of the matrix 36 consist of the said value chains 20, 22. Each node 42 of the matrix 36 represents a mathematical function which sets the values of the value chains 20, 22 into mutual relationship. If even any value of a structure element 16, 18, from a value chain 20, 22 changes the value of corresponding nodes 42 of the value chain matrix 36 will change as well. The value chain matrix 36 should always represent the complete company structure to have the best effect. By optimizing the value chain matrix 36, for instance by well known mathematical optimization of n-dimensional matrixes, the whole company structure may be optimized with this suggested method.

FIG. 5 shows analogous to the previous figure a multi value chain matrix 44. Therefore, the same elements are marked by the same reference numerals. But instead of two dimensions the present multi value chain matrix 44 has three dimensions. This example shall especially demonstrate that is possible to use a n-dimensional multi value chain matrix 44. Using a multi dimensional value chain matrix 44 allows optimizing very complex company structures.

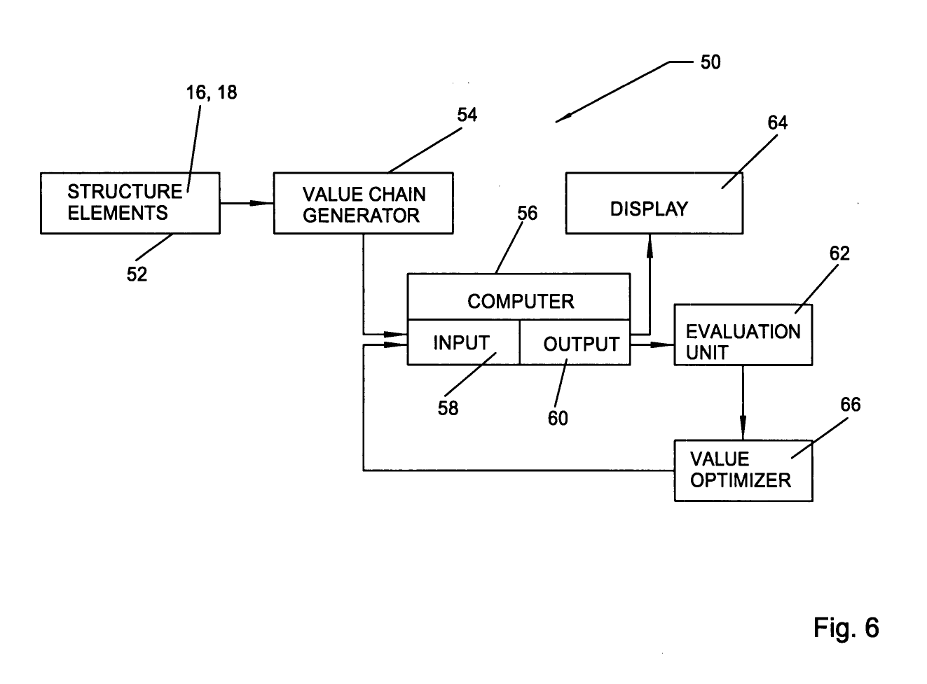

FIG. 6 shows an inventive device 50 for optimizing a company structure. Structure elements 16, 18 are represented by rectangle 52. The structure elements 16, 18 are feed to a value chain generator 54. The value chain generator 54 generates digital value chains of different company components by assigning a value to each participating structure element 16 respectively 18. The digital data are administered and saved in a memory of a computer device 56. The computer device contains an input device 58 and an output device 60. The output device 60 is connected with an evaluation unit 62 and a display 64. The evaluation unit 62 builds a value chain matrix 36, 44 by using the said generated value chains 20, 22 of the value chain generator 54. The value chain matrix 36, 44 will be optimized by a value optimizer device 66. The value optimizer device 66 optimizes the said value chain matrix 36, 44 by using a mathematical optimization algorithm. The optimized value chain matrix is feed to the input device 58 of the computer device 56. From the output device 60 the optimized result is shown on the display 64.

Following example is explained in more detailes:

Value is different from the money value of a product, even if sometimes it can be the same or become the same with this money value. But, the “perimeter” of the value is larger and has a volatile and subjective aspect.

The value is context sensitive. For the R&D department a value unit, as a result of their activity, is not necessary a value for the sales or production department. The value of a technological innovation for a competitive advantage is valid during the time that it still provides a competitive advantage and no longer after the competition included it in its product also. For these reasons the know-how, or competence, or partnership value are contextual and time sensitive.

Moving from one business cell to another (from R&D to Marketing department) the value can change the value chain. So, a value included in the know-how chain of one of the company business cells (department or value process) can be converted into a value of the product-production value chain in another business cell or even in the same one. Within the same business cell, a value center can move from one chain to another (e.g.: an R&D project from an internal production chain to the product-production chain).

To be an integrated system (engine) for a complete management of the values created around an activity dedicated to a determined objective.

The exemplification of this mechanism is made under the condition that the values necessary to generate and influence an activity are:
1. partnership
2. competencies
3. know-how
4. the realization (production) of the product (physical, services etc . . . )

From the functionality point of view, the objective of this engine is to be able to track and measure value flows and contribution for each type of values and each specific center of value. Thus, it is important to have a complete picture of what value center or group of value centers are contributing and with what amount of value, to the other value chains or other value centers.

The engine must provide also the “picture” of the contribution of each entity of the organizational and functional domain, down to group and personal level, to each value center or group of value centers or entire value chains.

The multi-value management engine (MVME) has also an engine-block which is dedicated to measure the flow of values in different measurement units (money, man/days . . . ) and also has a business intelligence engine-block in order to measure the values center and the cost of value created.

General Concept:

The value centers existing around an activity are classified in some major value groups:
product-production
know-how
competence
partnership

The value creation is structured in a value-chain in some major and significant value generation phases. A suite of very clear and simple operations, represented like an operational flowchart also sustains each of these value operations inside a business or activity process.

For the execution of each simple operation up to a very complex activity process is needed a synchronized participation of all the four value processes, or value chains, down to their operational flowchart.

In order to execute an operation, it is necessary to have more than the workplace and tools. It is necessary to have the right persons, which mean: the right education, cognitive, cognitive level (competence); the right know-how (unformalized experience coming from an specific activity) and definitely a partner (customer, supplier, sponsor . . . ).

All these values are going together in order to do the right activities with the right result.

The activity is the source of creation of these values, such different values as: competence, know-how and partnership created by the activities have to be identified, structured in value-flows, measured and analyzed how they are employed as resources in the production process and to obtain the proposed activity result.

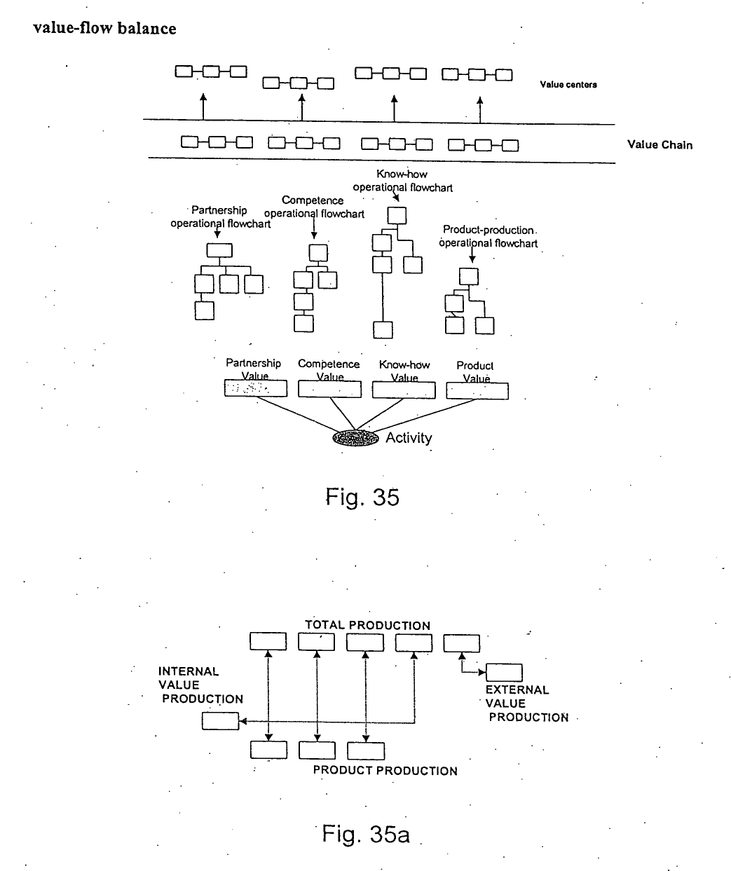

It is necessary to organize the value centers in this value-flow balance as shown in FIG. 35.

The value centers inside of the same value are classified in three classes:
for internal use as a competitive advantage
for external use as the free-value distribution inside a sponsorship or joint-partner project
the product-production, that means the value that is included in the product

The sum of these three categories of value centers will be contained in the total production category, as shown in FIG. 35a.

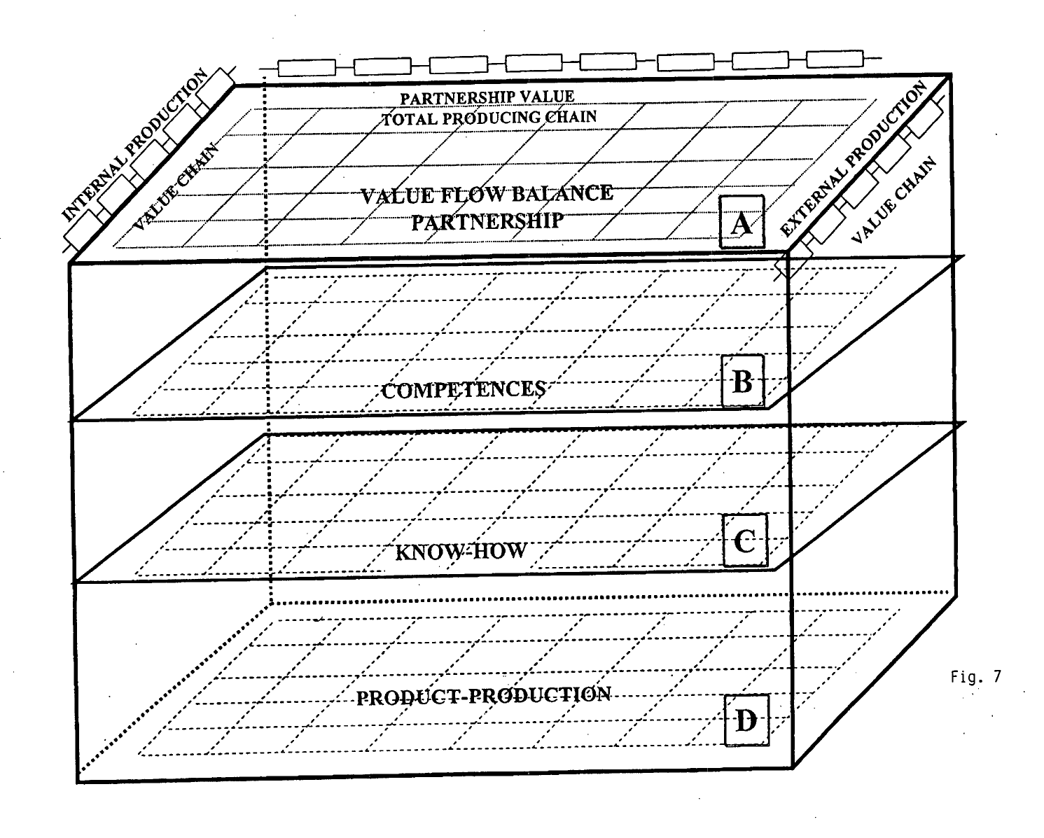

There will be as many value-flow balances as values, shown in FIG. 7:

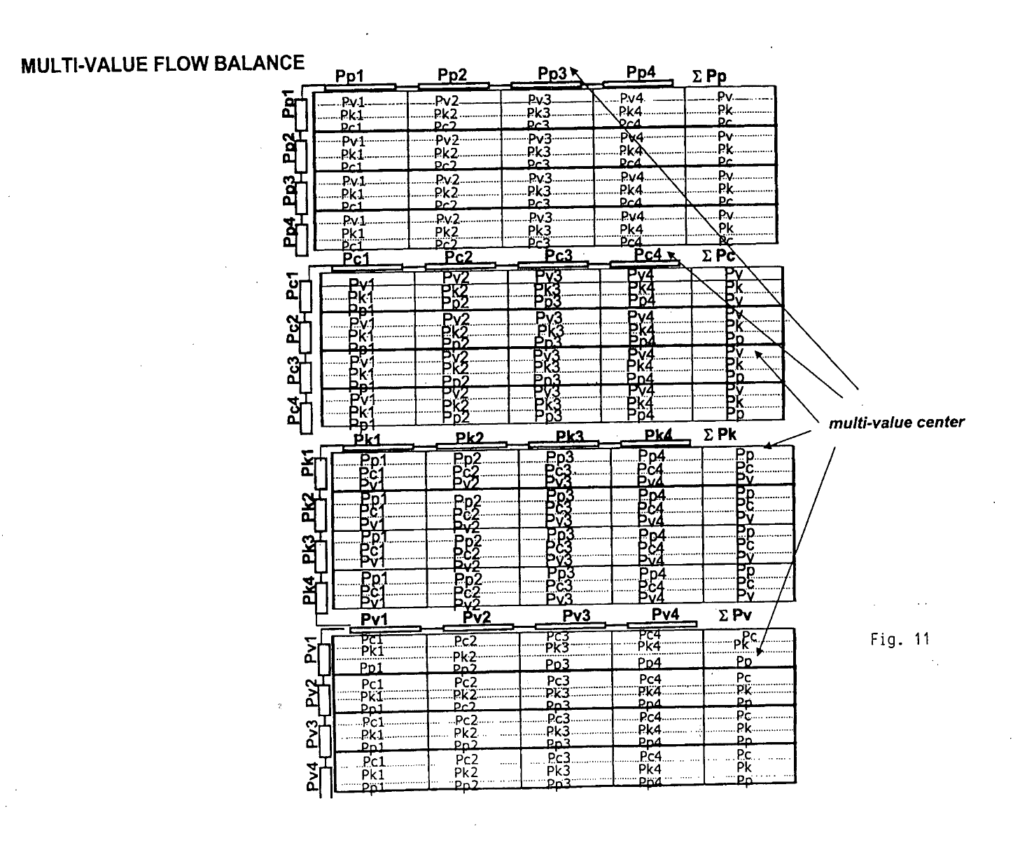

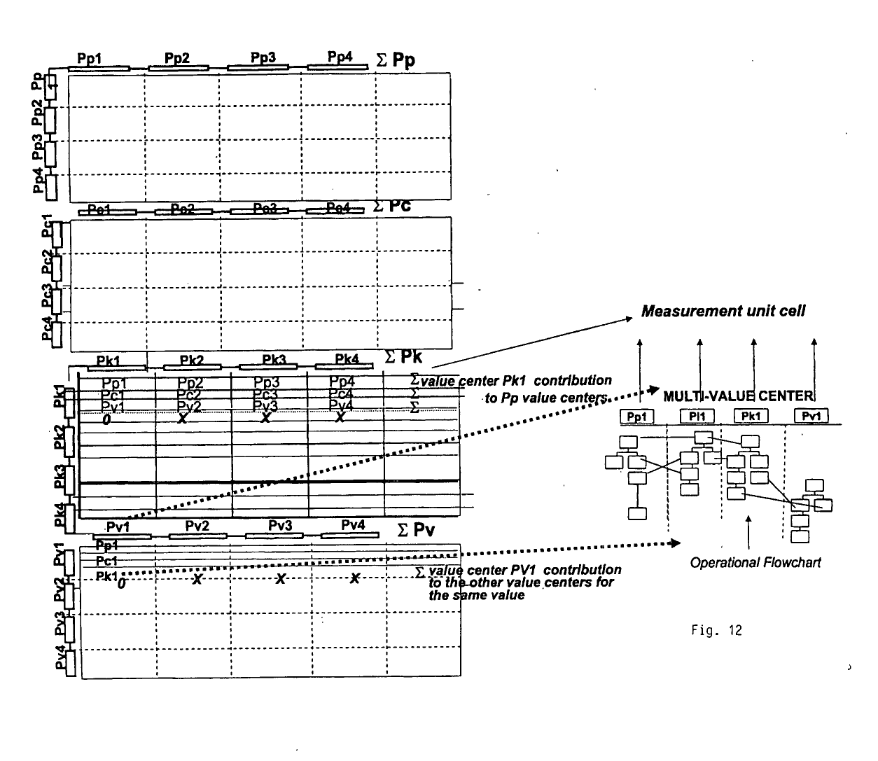

FIG. 11 illustrates how these values are circulating from one value center to another and from one type of value chain (production) to another one (know-how) is formalized in the multi-values flow balance.

In this part of the value management system, the participation from one value center to another is fixed and analyzed. This occurs when these elements are inside of different values. For example, what is the contribution of a know-how value center (special software tool usage) like competitive advantage in the product-production value center (“as is” business model) if it is considered these in a business consulting activity?

What is the value contribution to the product, of the fact that the competence of the peoples involved in the product production process has been increased by a specialized training?

The multi-values flow balance is composed by a multitude of multi-value centers.

A multi-value center is a combination of value centers, each coming from the four value types; compare FIG. 35d.

If the multi-value centers are represented by value-chains or significant phases from the value chains, the multi-value center will contain, down on the flowchart, the integration mechanism of these value types existing inside an activity operation or process.

Through this multi-value flow balance we can obtain the sum of value contribution from one value center to another (from a different value type) or, the contribution from a whole value category to another value center like the total contribution of a R&D project on the assembling phase of a car producer.

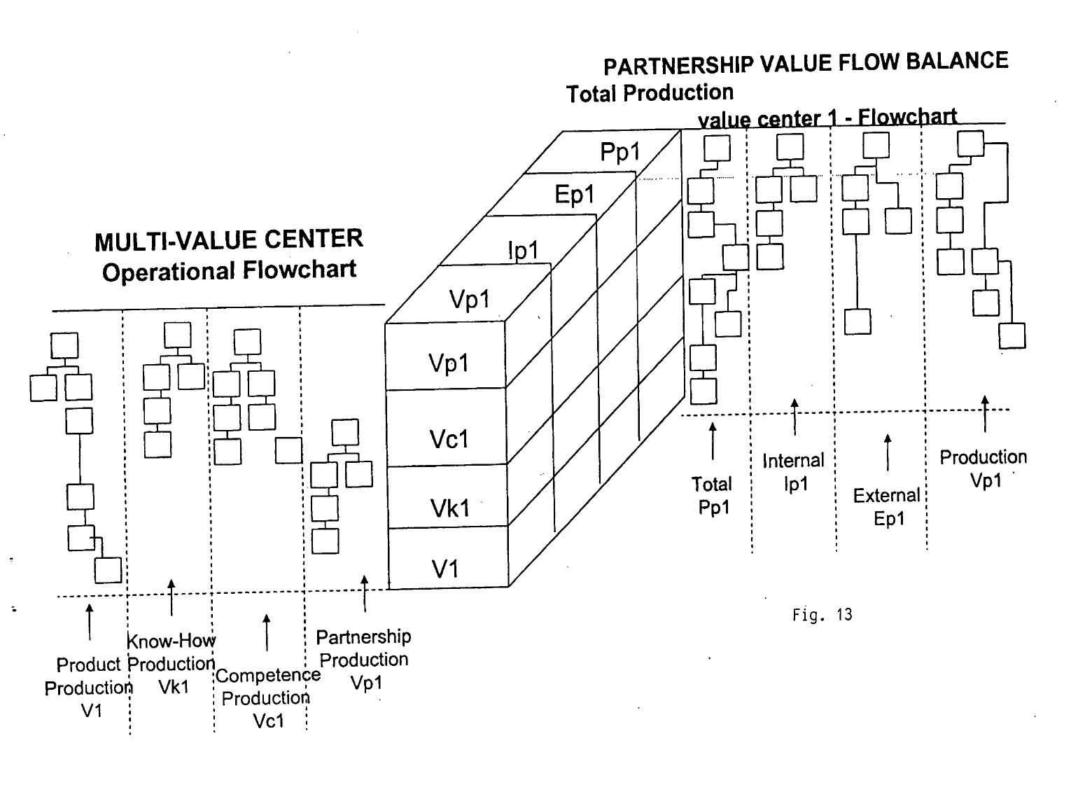

FIG. 13 illustrates how the values are flowing in between the different value types and the different value centers inside the same value type is presented.

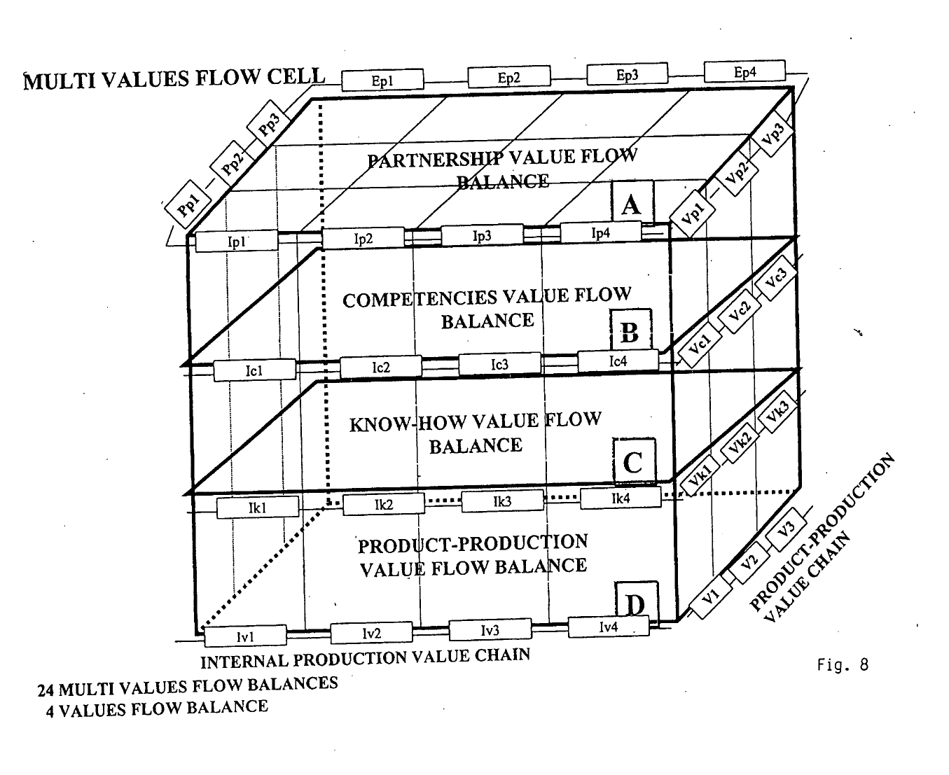

The value-flow balances and the multi-value-flow balances are integrated in the multi-value flow cell shown in FIG. 8.

The value is a context and time sensitive concept so, is important to know from where is coming like organizational and functional domains.

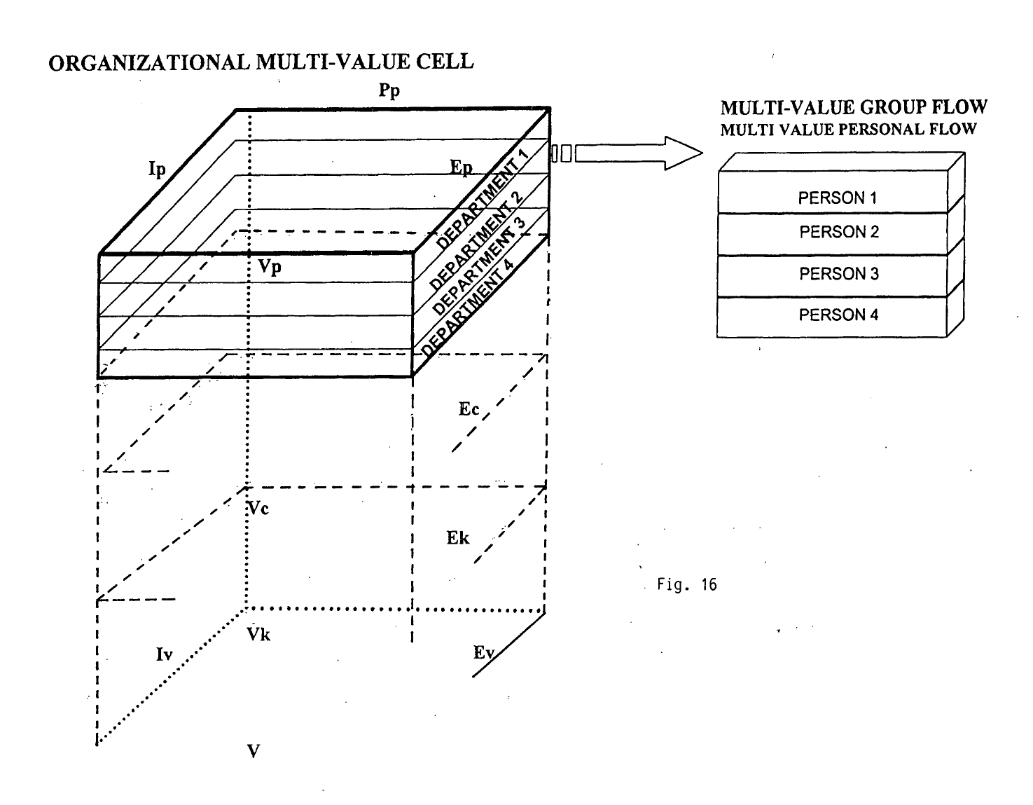

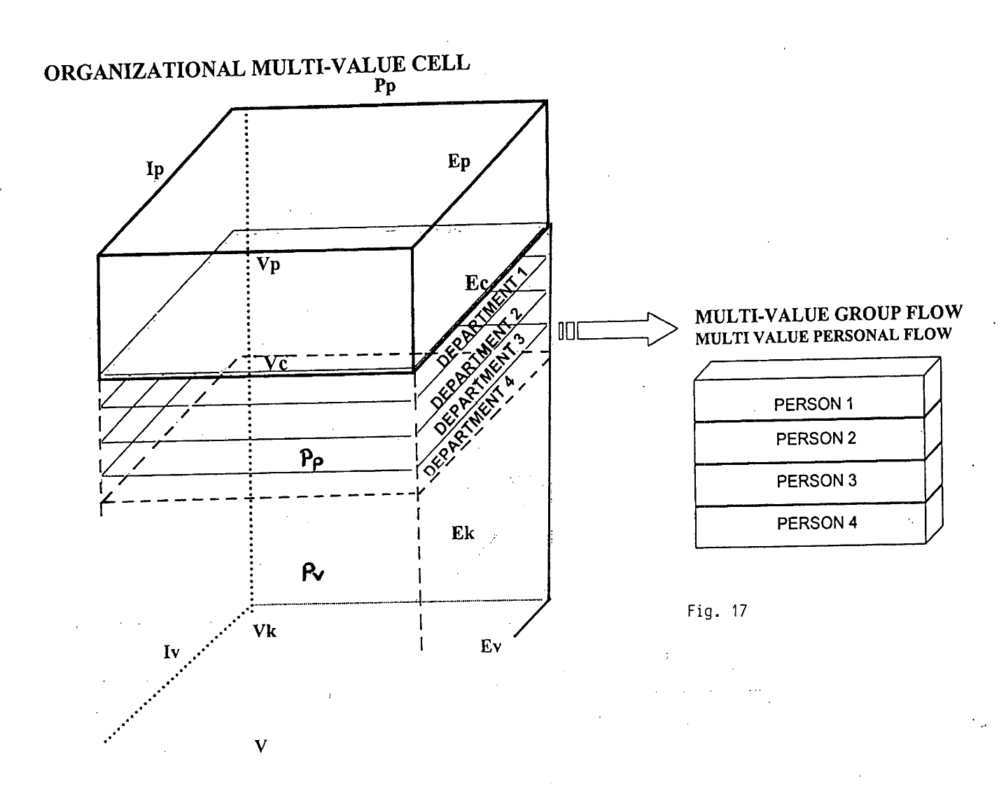

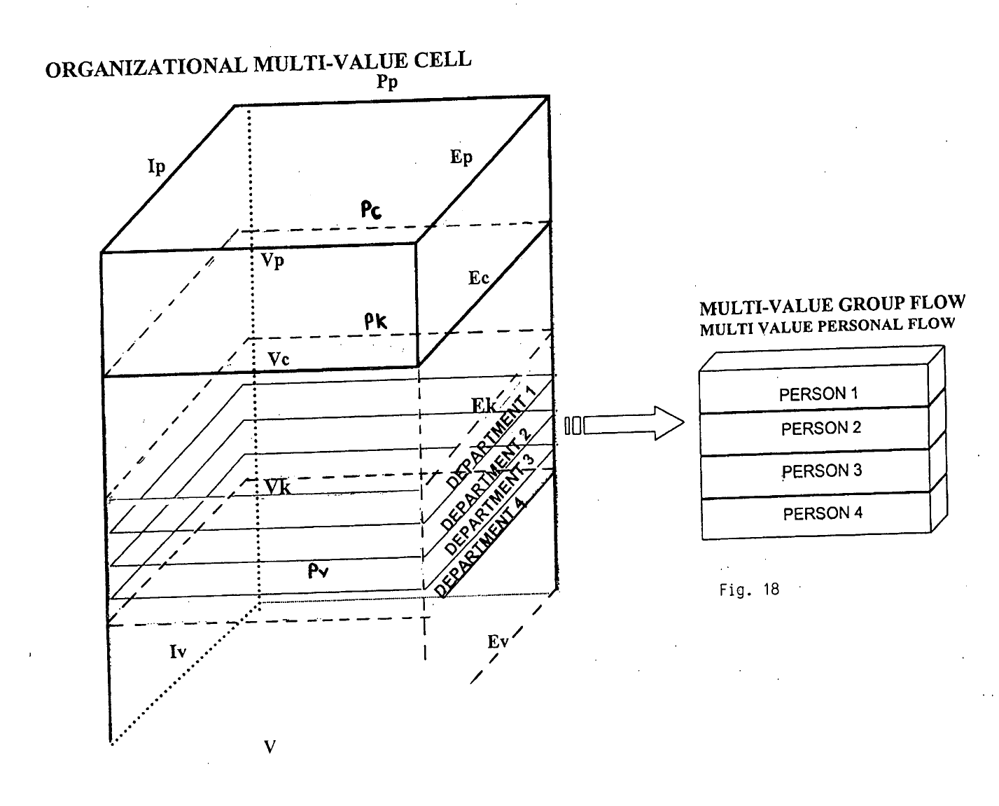

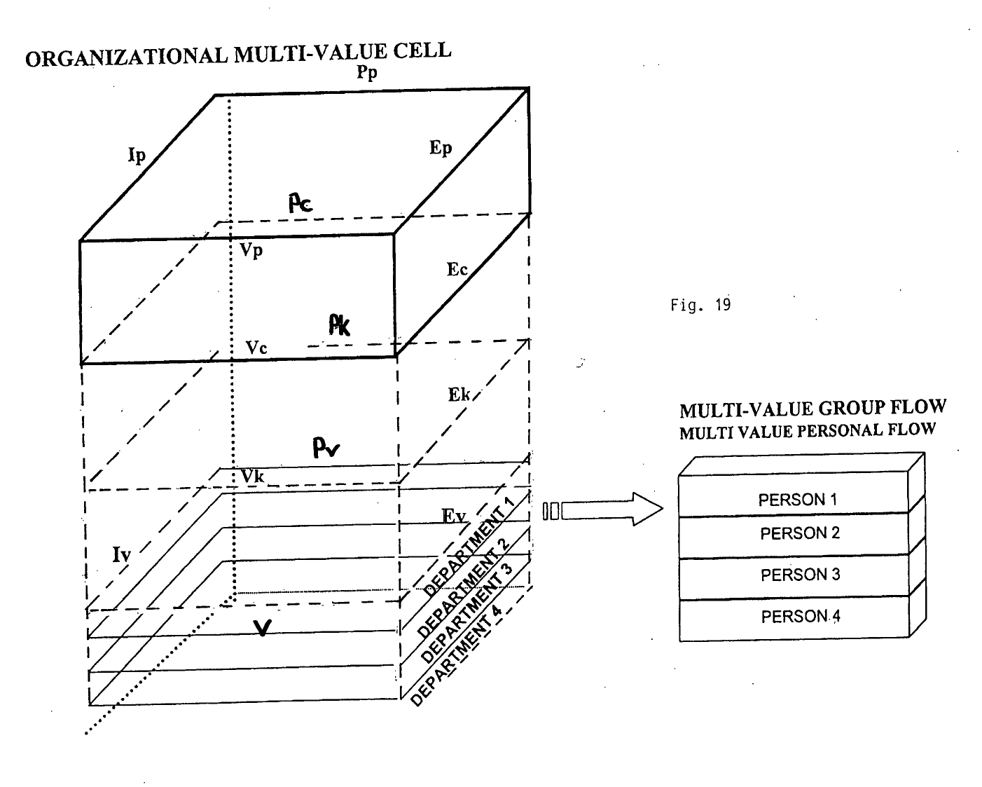

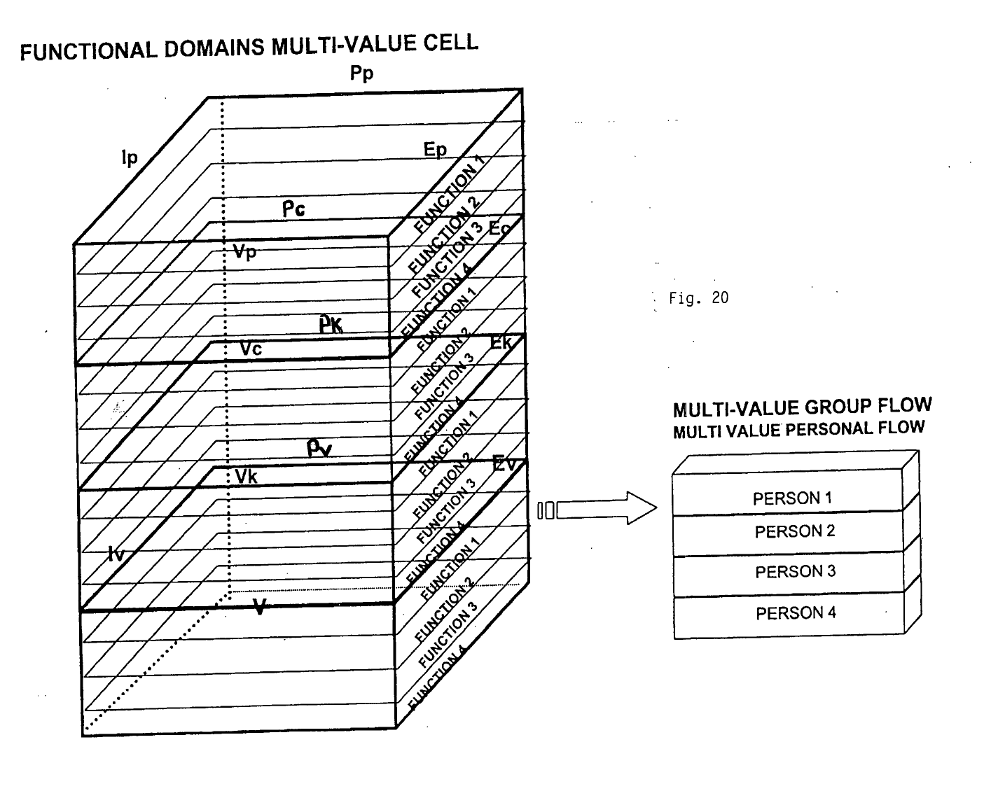

So, there are integrated in the MVME (multi-value management engine) another two blocks: Organizational multi-value cell FIG. 16-19 and the functional domain multi-value chain FIG. 20.

The value contribution from one value center to another or from one value process to another must be measured with probably different measure units and with different weights.

A man/day in different competencies and different know-how can not have the same value contribution.

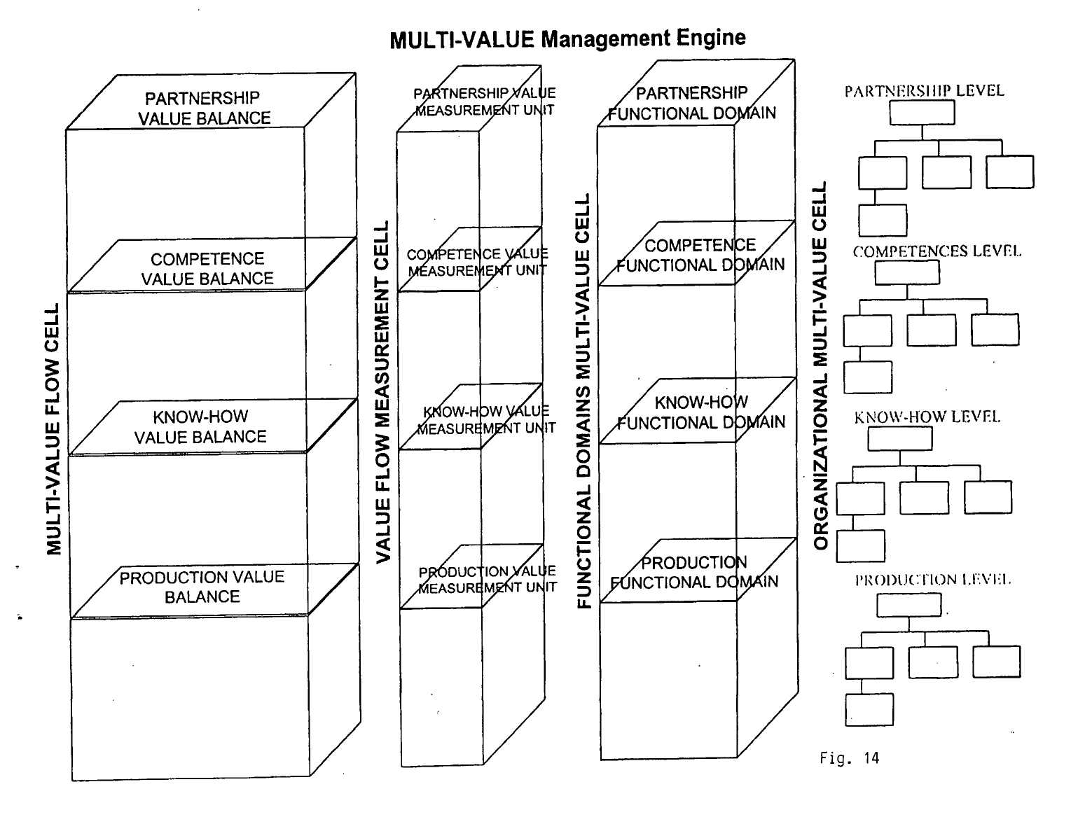

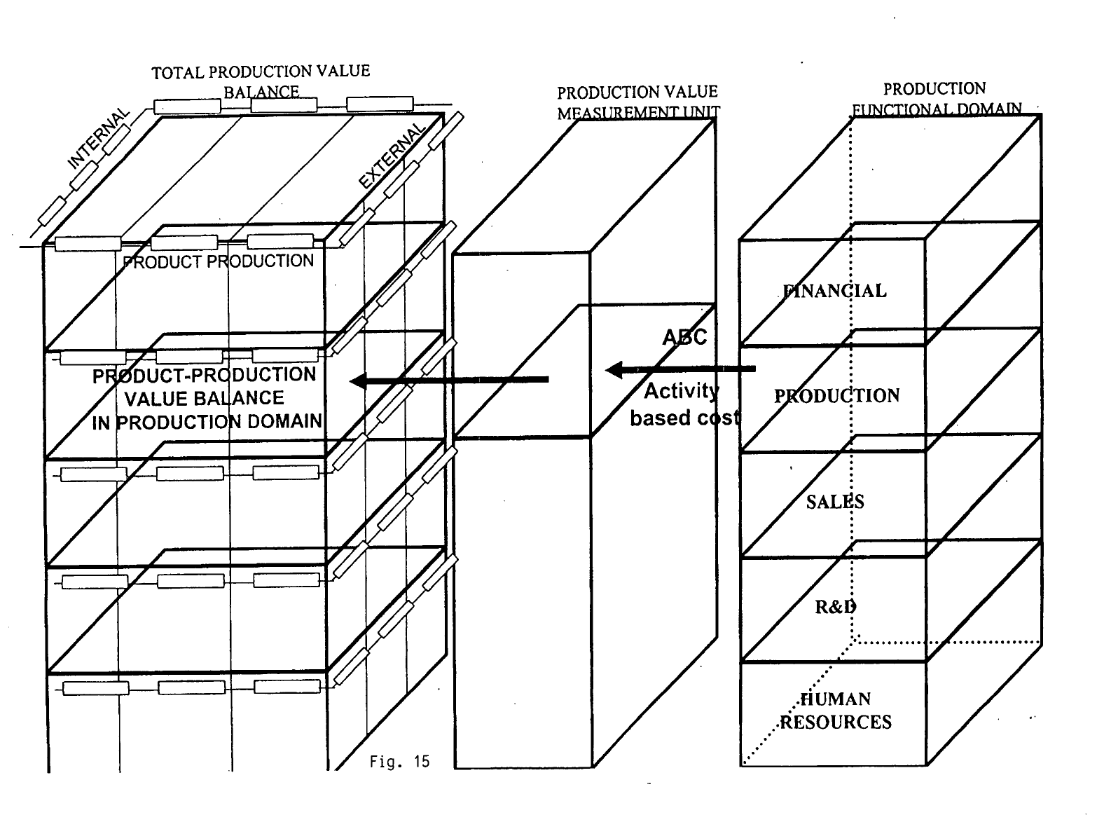

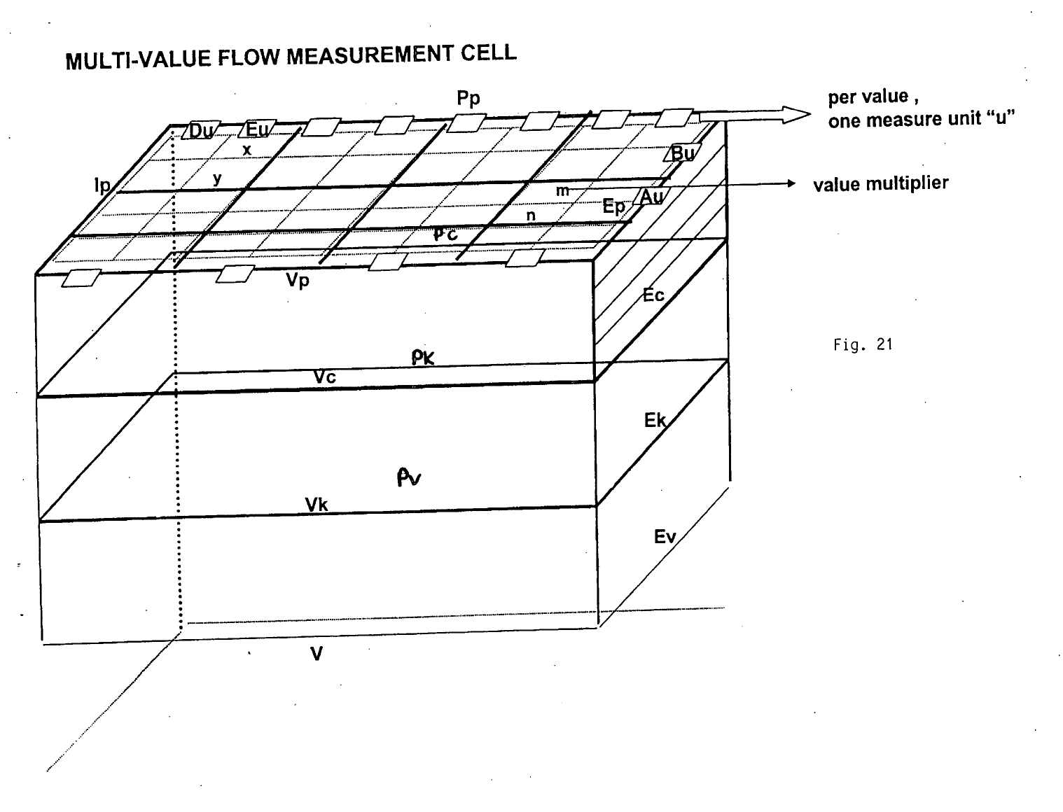

The weight defined as value multiplier and the measure unit “u” are structured in a special block inside of the MVME named Multi-value flow measurement cell FIG. 21. The entire MVME engine is represented like blocks in FIG. 14.

The appurtenance of the value centers or operations in a value chain process can be formalized down to each person or job description level. And it is the same if we wish to formalize the value centers appurtenance to the functional domains (FIG. 20).

Concerning the multi-value flow measurement cell (FIG. 21) for each value flow balance we can fix the same measure unit “u”.

Inside this value flow balance for each contribution from one value center to another, we can have a different value multiplier. For example, if a specialist from the R&D department is moving from a internal production center (development of a new product) to an external production center (seminar to explain the new product concept) or to participate direct in the product-production value-chain, his value will be different. So, the same, know-how and competencies value centers will contribute with a different value amount to others value centers (FIG. 21).

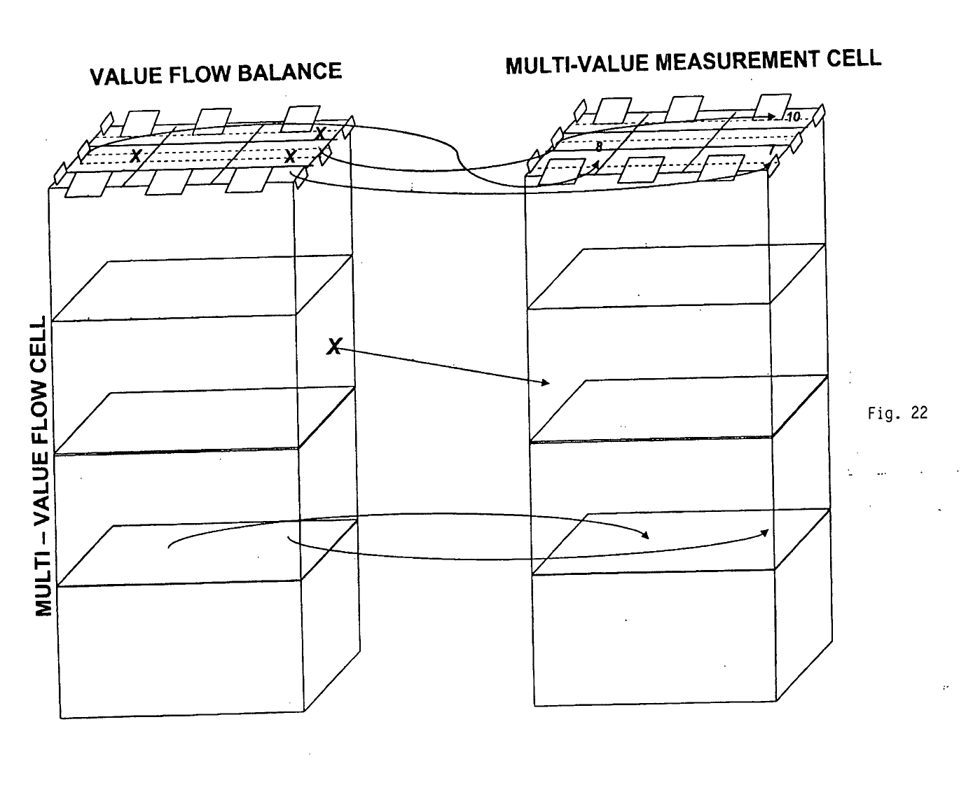

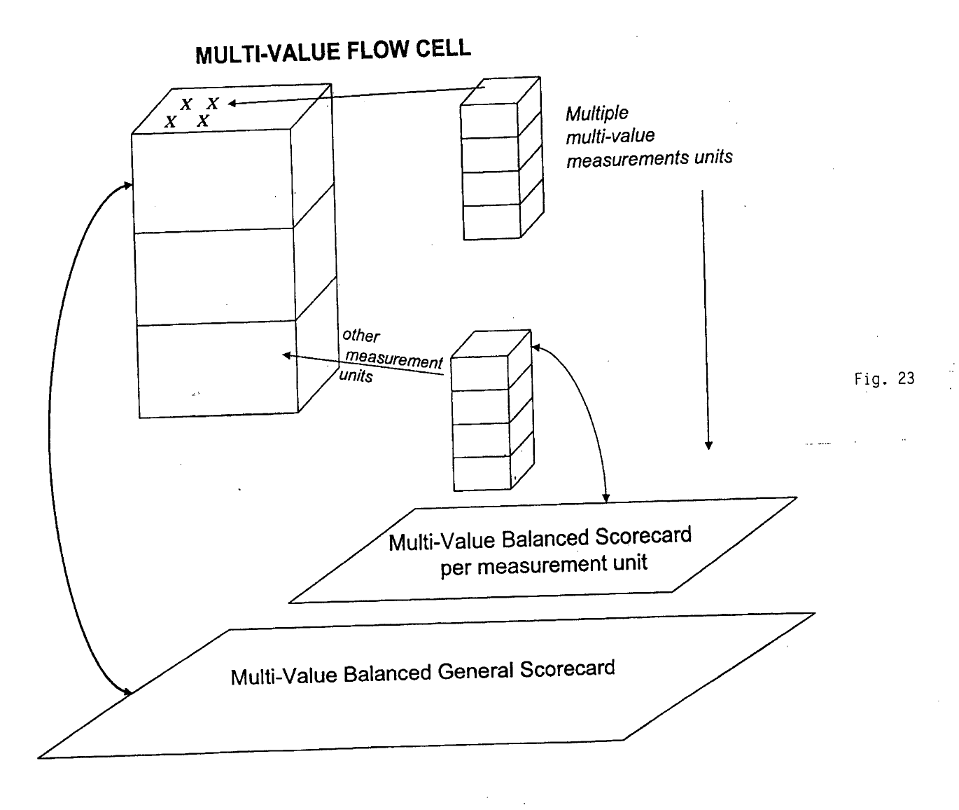

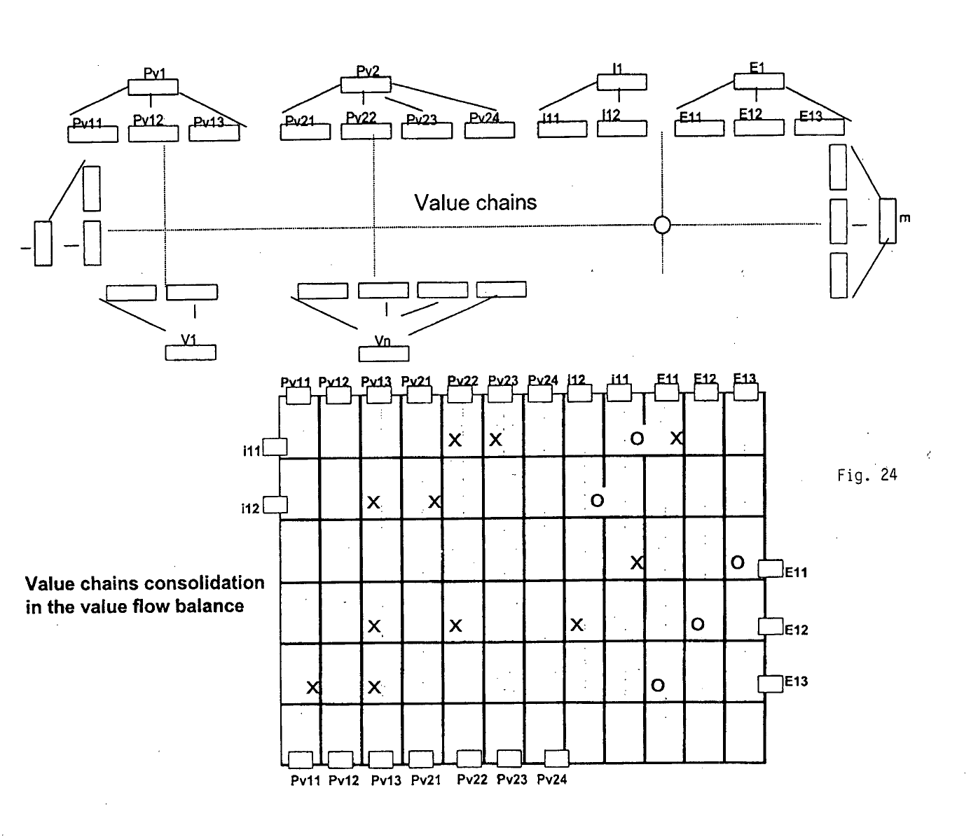

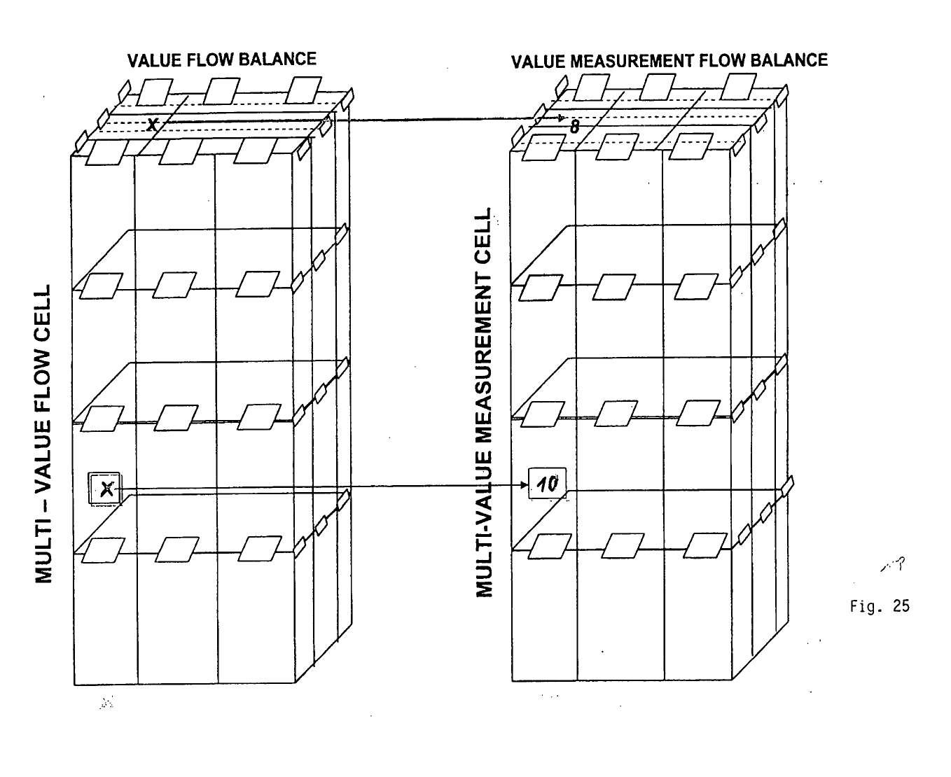

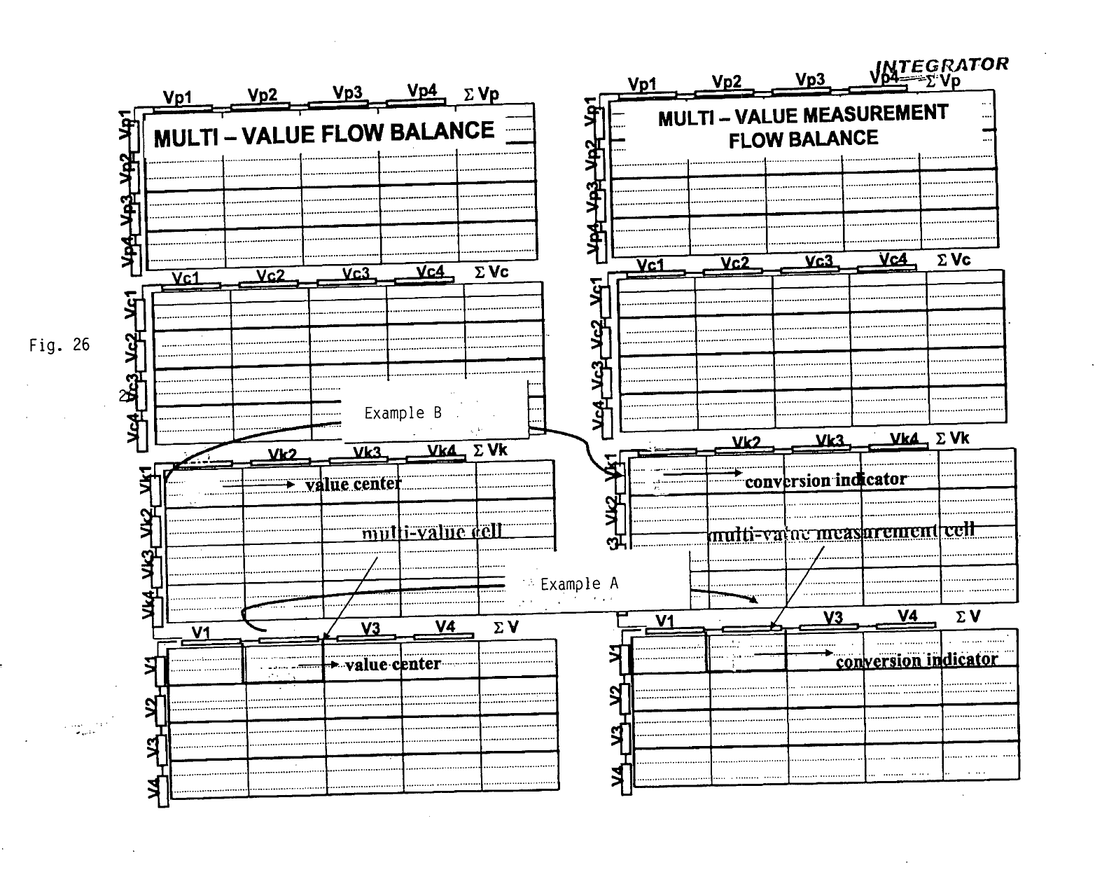

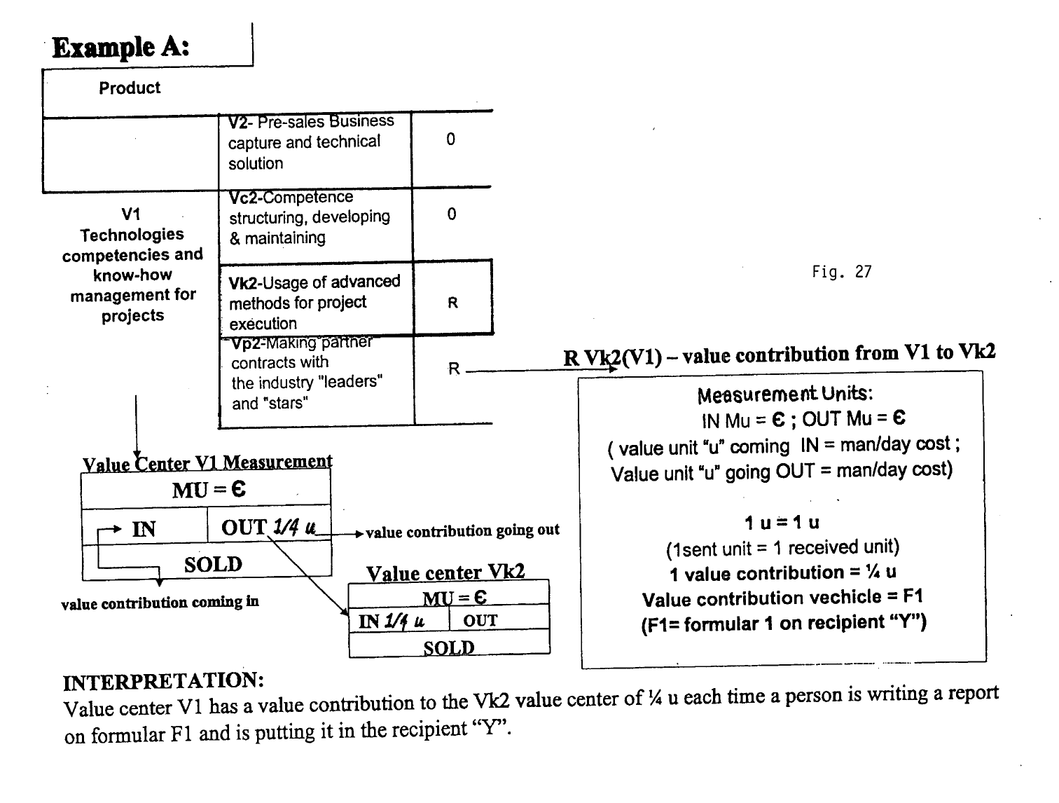

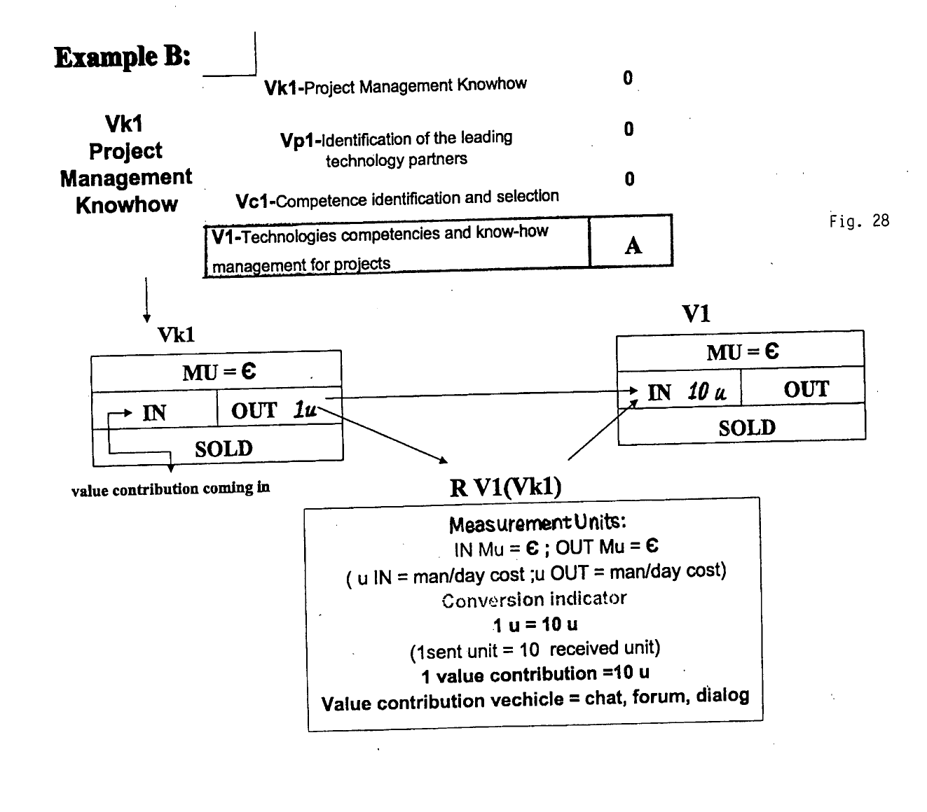

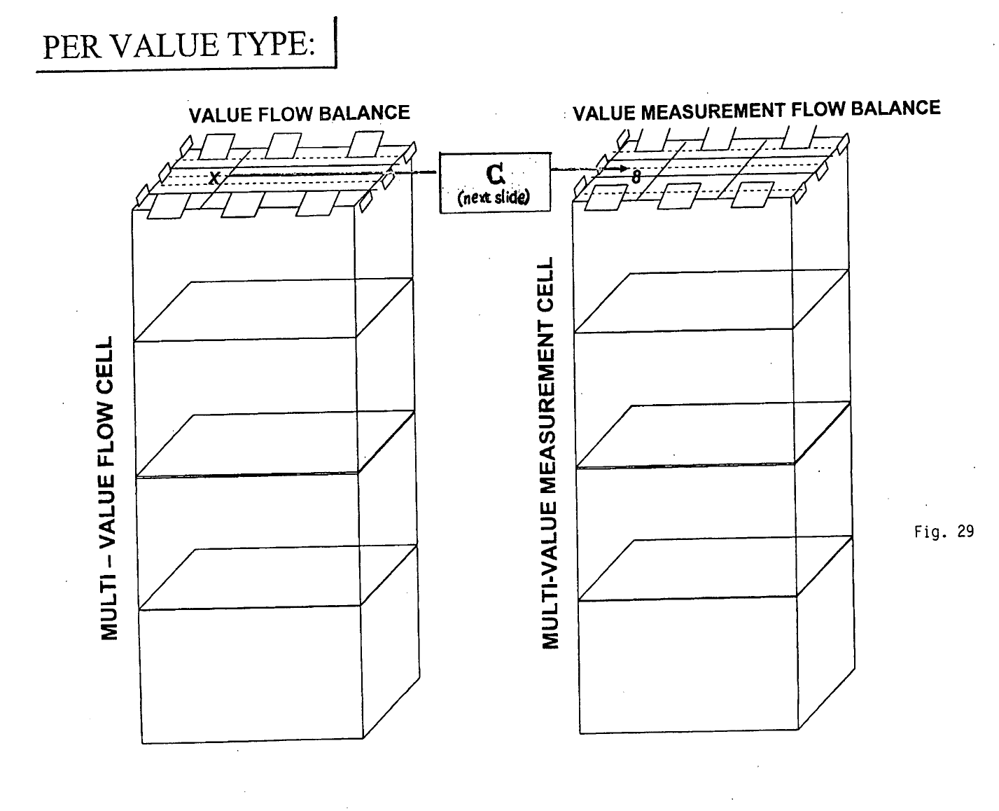

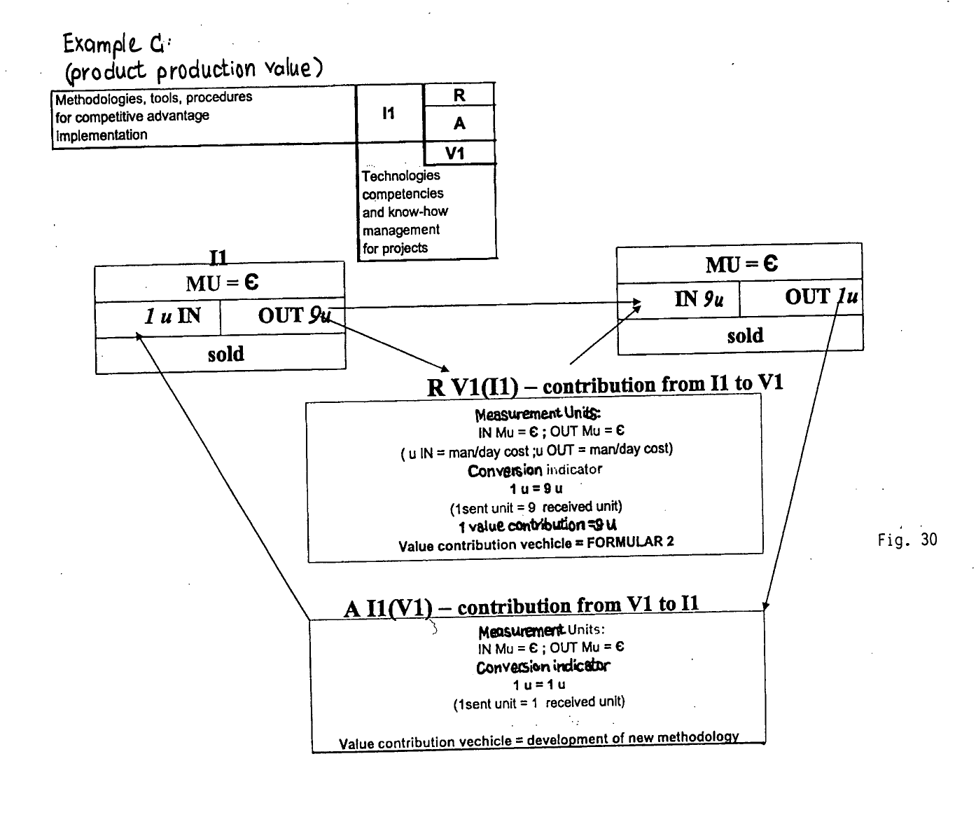

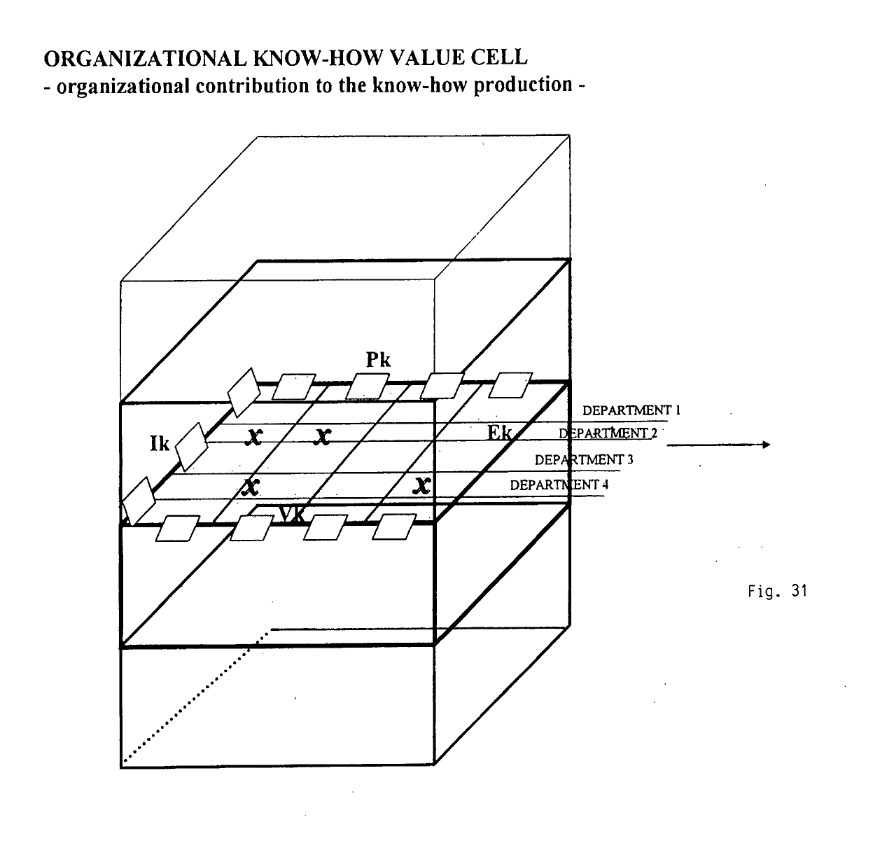

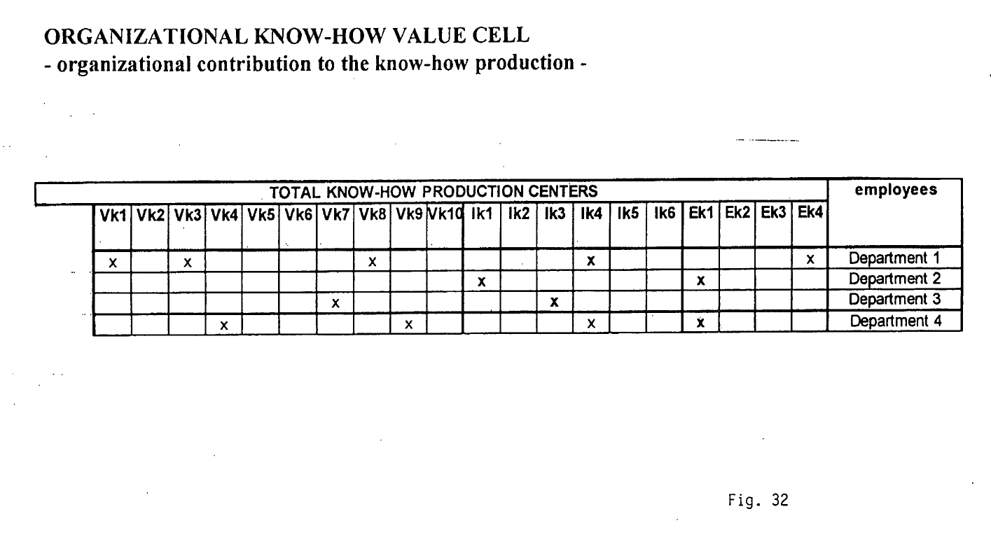

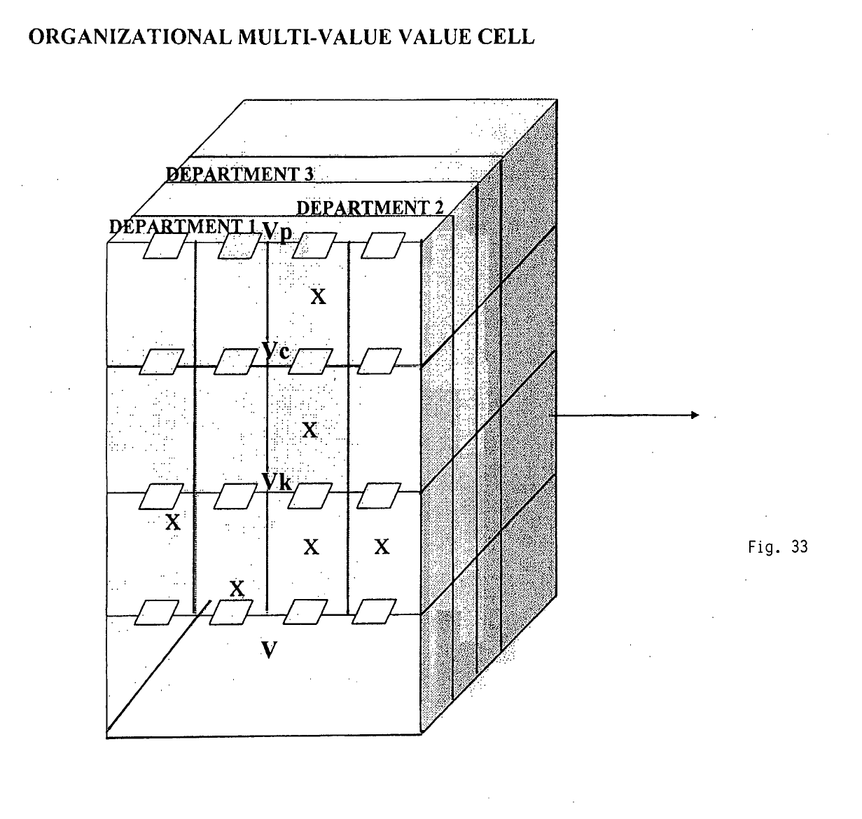

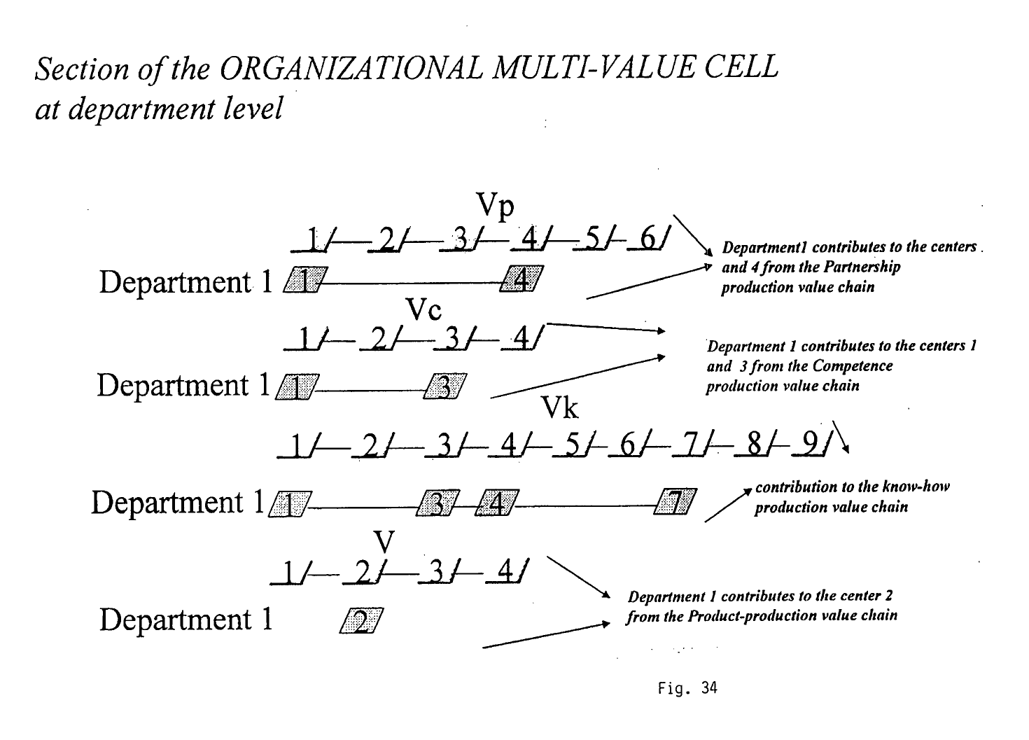

We can make to correspond for each value centers, process or activity on all value types, a value or multi-value measurement center in which we fix the measure unit “u” and the “value multiplier” (FIG. 22).

Different measure systems and units can measure the same value. We can measure a R&D project in man/days, cost, time or in productivity variation (percentage) or in all of them. And for that purpose we can have multiple multi-value flow measurement cells inside the same MVME.

A Multi-Value Management Engine (MVME) is a mechanism that is optimizing the entire activity of a company. This activity is generating different value production processes. Each generated value: product, competence, know-how, partnership can be represented by the most representative parts of this whole value generating process, called value centers, the most simple expression of the value chain.

The Multi-Value Management Engine (MVME) is built in the following manner:

Each value is generating value chains structured in:
1. internal value used only for competitive advantage and internal projects.
2. production value, which is the value incorporated in the product designated for sale
3. external value, which is the value designated to be given outside the company for free (demo, seminars, and sponsorship . . . )

All three parts of the value chain are linked to one another and build together a matrix with the fourth side. The fourth side is the total value production chain, the sum of the internal value, production value and external value.

The dimensions of this matrix will be fixed by:
one dimension which is the number of value segments corresponding to the total value production value-chains.
the second dimension of the matrix will be the sum of the internal value plus external value. In this matrix each internal or external value segment has its own matrix line.

This matrix is named the “value flow balance” and we have one matrix for each of the four value types.

In this matrix, each cell formed by the intersection of the matrix line from the internal or external value segments and the value segment corresponding to the total value production is divided in two parts:
The upper side is to record the value contribution coming from the internal or external value center line in regard to all other value centers, and
the lower side is to record the contribution coming from the production value center line regarding internal and external value centers.

If there is no value contribution, the cell will be marked “0”. If it is a value contribution it will be a number which is the value contribution, known as the “conversion indicator”. (1 or 2 or 3 in our example are indicating the ascending grade of the value contribution corresponding to small, medium or high).

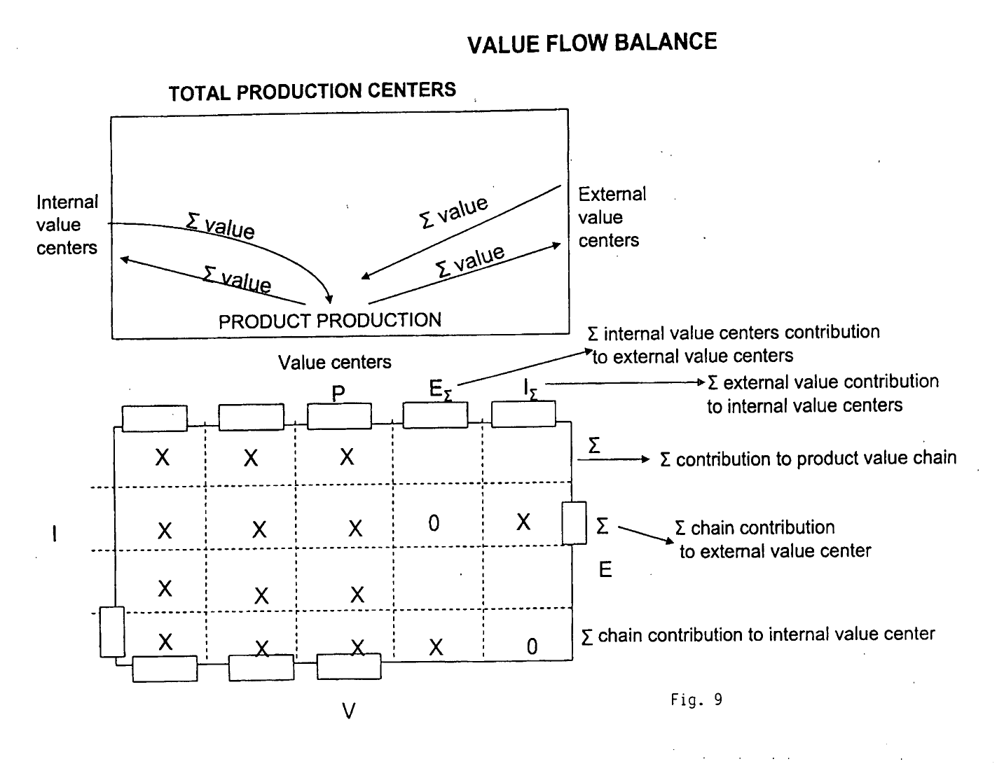

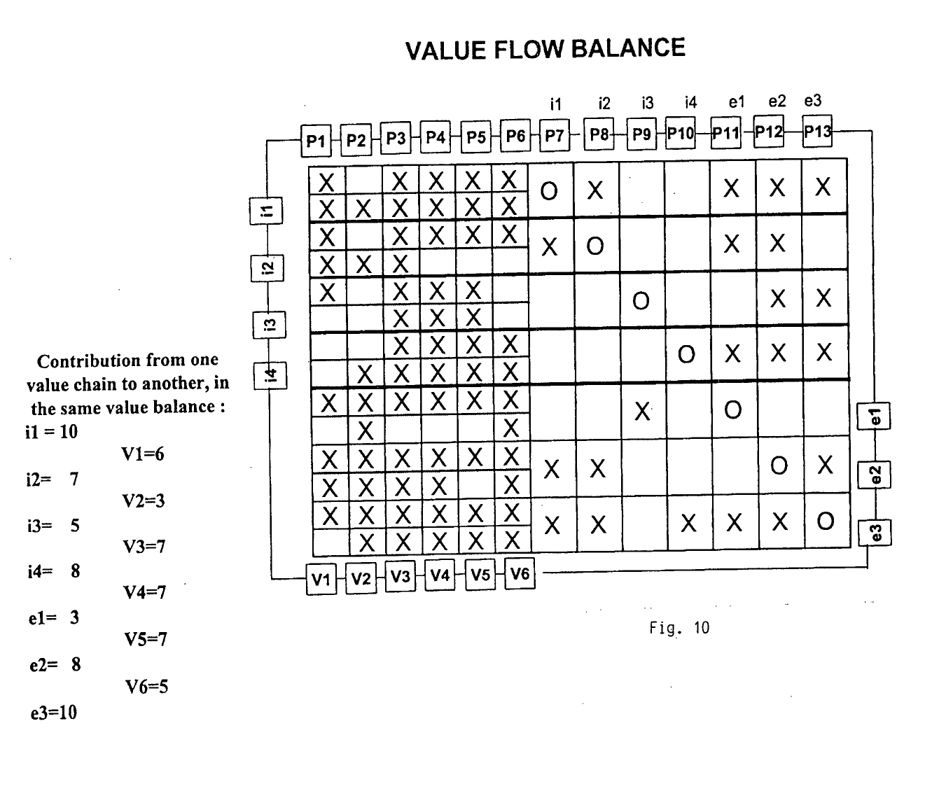

There is one value flow balance for each value, as best illustrated in FIG. 9.

The Multi-Value Flow Block: Build the value flow block by taking the value flow balance of the partnership value and generate from each corner of this matrix a lateral block side equal with the length of the total production value matrix side.

Take the competence value flow balance and generate on each corner a lateral block side equal with the length of the competence total production side.

Take the know-how value flow balance and generate on each corner a lateral block side equal with the length of the know-how total production side.

Take the production value flow balance and we generate on each corner a lateral block side equal with the length of the product-production total production side.

Take the biggest internal value or external value from the four matrixes and align the other three on this dimension.

Take the side of the matrix which are the external plus the internal values and extend the other 3 matrixes on the same dimension of the internal plus external value.

Take the biggest total production value side of the matrix and align the other 3 matrixes to this length.

Now, build the Multi Value Flow Balance with the generated segments in the following way:
the internal value from the partnership, from the competence, from the know-how and from the product will be each under another on the same lateral side of the block.
the production value from the partnership, from the competence, from the know-how and from the product will be each under another on the same lateral side of the block.
the external value from the partnership, from the competence, from the know-how and from the product will be each under another on the same lateral side of the block.
the total production value from the partnership, from the competence, from the know-how and from the product will be each under another on the same lateral side of the block.

The generated segments from the corner of the partnership will be attached to the corresponding corner from the next value flow balance: competence.

The segment generated from each corner of the competence value flow balance will be attached to the corresponding corner of the next value flow balance: know-how.

The segment generated from each corner of the know-how value flow balance will be attached to the corresponding corner of the next value flow balance: production.

On each of the lateral block sides we will have a matrix with all the value sides linked one to another creating a bigger matrix.

On each one of the sides is a value: internal, external, total production or production.

The opposite is a side from a different value but of the same type of production (internal, external, production or total production).

The other side of the matrix will be the sum of: the total production value for partnership plus the total production value for competence plus the total production value for know-how plus total production value for product-production.

For the matrix side created by connecting the four different total production value sides, draw a line like a row which goes around the block and this row can contain only one value center for each intersection between the row and the lateral block side.

For each segment of value from the top side of the matrix we draw a column down to the total height of the block and from each value side intersected by this column we put a value center.

Each intersection between a row and a column is named as the “multi-value cell”. The multi-value cell is splitted in 4 parts.

Each of these 4 parts is dedicated to inform a user about the value contribution of the lateral value center to the row value centers.

The Measurement Unit Block will be generated like a perfect copy of the Multi-Value Flow Block. For each value center, exactly in the same place of the block will be generated a measurement unit for this value center.

For each value contribution mentioned in each part of the value or multi-value cell it will be generated, exactly in the same place of the block, a conversion indicator. All the measurement unit and value centers and conversion indicators will go to a balance scorecard which makes a multidimensional analysis about the value contribution on each type of value to other type of value and each value to another value center and links them to the strategic Key Performance Indicators of the company.

The conversion indicators is adapted so as to reflect the company strategy and the importance of each type of value in this strategy.

As many measurement unit multi-value blocks as desired each of these different measurement blocks to be linked to different policy or strategy scenarios.

The goal is to optimize the result of the company whole activity by structuring the different value flows.

Organizational block:

Generate now the third block, which is the “Multi-Value Organizational Block”.

The goal of the Organizational Block is to link the value center or the value chain to the individual, group or department, which is creating that value.

The value flow organizational balance is generated, which is the link between each value center of a value type and the organization unit (individual, group, department, functional domain) contributing to this value centers.

The analysis will be made per value but also per type of value production (internal, external, production and total production).

In order to create the value flow organization balance for a specific value we need to generate a perfect copy of this value flow balance and we deactivate three sides of this matrix.

Keep active only the side that is wished to analyze. Take a side of the balance that is in junction with the active side and we generate as many segments on the side as organizational units. For each organizational unit segment we generate a row and for each segment of active value centers we generate a column.

The intersection of each row and column is named the “value organizational cell”. In this cell, we'll mention if the organizational unit from the row is contribution to the value center from the column. The Multi-Value Management Engine is the total of the multi-value flow blocks, all the multi-value measurement unit blocks and the total value flow organizational balances.

TABLE 1
KNOW HOW VALUE FLOW BALANCE

| | | 13 | 12 | 19 | 17 | 8 | 15 | 10 | 16 |
|---|---|---|---|---|---|---|---|---|---|
| | TOTAL: | Vk1 | Vk2 | Vk3 | Vk4 | Vk5 | Vk6 | Vk7 | Vk8 |
| scale 1-3 | Ek4 | | 1 | 2 | 1 | | | 2 | 2 |
| Impact mic: 1 | | 1 | | 2 | 1 | 1 | 1 | 1 | 2 |
| Impact mediu: 2 | Ek3 | | | | 1 | | 2 | | |
| Impact mare: 3 | | | | | 1 | | | | 1 |
| | Ek2 | | | | | | | | |
| | | | | 2 | 2 | 1 | 2 | 3 | 1 |
| | Ek1 | | | | 1 | | | 1 | 1 |
| | | | | | 1 | | | | 1 |
| Marketing, | Ik6 | | | 1 | | | | 2 | |
| sales, CRM | | 1 | 1 | 3 | 2 | | 1 | 1 | 2 |
| Customer contract | Ik5 | | | 1 | | | | | |
| and technical | | 2 | 1 | | | | 2 | 1 | 2 |
| sales proposal | | | | | | | | | |
| Component | Ik4 | 3 | 3 | 3 | 3 | 1 | 3 | 1 | 3 |
| development | | 3 | 3 | 3 | 3 | 3 | 3 | 1 | 1 |
| for fast | | | | | | | | | |
| implementation | | | | | | | | | |
| Project | Ik3 | 3 | 3 | 3 | 3 | 1 | 3 | 1 | 3 |
| management | | 3 | 3 | 3 | 3 | | 3 | 1 | 1 |
| optimization | | | | | | | | | |
| techniques | | | | | | | | | |
| Training | Ik2 | 3 | 3 | 3 | 3 | 2 | 3 | 2 | 3 |
| support & | | 1 | 2 | 3 | 1 | 2 | | | 2 |
| assimilation of | | | | | | | | | |
| complex | | | | | | | | | |
| technologies | | | | | | | | | |
| Methodologies, | Ik1 | 3 | 3 | 3 | 3 | 3 | 3 | 3 | 3 |
| tools, procedures | | 2 | 2 | 3 | 3 | 1 | 3 | 2 | 3 |
| for | | | | | | | | | |
| excellance | | | | | | | | | |
| in BM | | | | | | | | | |
| | | Vk1 | Vk2 | Vk3 | Vk4 | Vk5 | Vk6 | Vk7 | Vk8 |
| | | Competencies | Usage of | Competitive | Business | Specific | Go-live | Product | Infrastructure |
| | | management | advanced | price/quality | capture | programming | procedure & | localization | modelling |
| | | for project | methods | project | and | ABAP, HTML, | production | | |
| | | | for project | execution | modelling | JAVA | assitance | | |

| | | 19 | 17 | 53 | 44 | 36 | 36 | 4 | 21 | 11 | 12 | 9 | 29 | | |
|---|---|---|---|---|---|---|---|---|---|---|---|---|---|---|---|
| | TOTAL: | Vk9 | Vk10 | Ik1 | Ik2 | Ik3 | Ik4 | Ik5 | Ik6 | Ek1 | Ek2 | Ek3 | Ek4 | | |
| scale 1-3 | Ek4 | 2 | 3 | 2 | 3 | 1 | 1 | 2 | 2 | 2 | 1 | 2 | | Ek4 | Partnership |
| Impact mic: 1 | | 2 | 3 | | | | | | | | | | | | development |
| Impact mediu: 2 | Ek3 | | 3 | | | | | | 2 | | | | 1 | Ek3 | Customer |
| Impact mare: 3 | | 1 | 3 | | | | | | | | | | | | services |
| | Ek2 | | 1 | | 1 | | | 3 | 3 | 2 | | 1 | 1 | Ek2 | Presales |
| | | 1 | 1 | | | | | | | | | | | | activity |
| | Ek1 | 1 | 1 | | | | | 1 | 1 | | 2 | 1 | 1 | Ek1 | Seminars, |
| | | 1 | 1 | | | | | | | | | | | | sales |
| Marketing, | Ik6 | | 3 | | 3 | | | 2 | | 2 | 2 | 3 | 3 | | |
| sales, CRM | | 2 | 3 | | | | | | | | | | | | |
| Customer contract | Ik5 | | 1 | | | | | | 2 | | | | | | |
| and technical | | 2 | | | | | | | | | | | | | |
| sales proposal | | | | | | | | | | | | | | | |
| Component | Ik4 | 3 | 1 | 3 | | 3 | | | 1 | 3 | 2 | | | | |
| development | | 3 | 1 | | | | | | | | | | | | |
| for fast | | | | | | | | | | | | | | | |
| implementation | | | | | | | | | | | | | | | |
| Project | Ik3 | 3 | 1 | 3 | | | 3 | | 1 | 3 | 2 | | | | |
| management | | 3 | 1 | | | | | | | | | | | | |
| optimization | | | | | | | | | | | | | | | |
| techniques | | | | | | | | | | | | | | | |
| Training | Ik2 | 3 | 3 | | | | 1 | | 3 | 3 | 3 | 3 | 3 | | |
| support & | | 1 | 2 | | | | | | | | | | | | |
| assimilation of | | | | | | | | | | | | | | | |
| complex | | | | | | | | | | | | | | | |
| technologies | | | | | | | | | | | | | | | |
| Methodologies, | Ik1 | 3 | 3 | | 3 | 3 | 3 | 3 | 3 | 2 | 2 | 2 | 2 | | |
| tools, procedures | | 3 | 2 | | | | | | | | | | | | |
| for | | | | | | | | | | | | | | | |
| excellance | | | | | | | | | | | | | | | |
| in BM | | | | | | | | | | | | | | | |
| | | Vk9 | Vk10 | | | | | | | | | | | | |
| | | Business | Customer | | | | | | | | | | | | |
| | | Intel- | service | | | | | | | | | | | | |
| | | ligence | and | | | | | | | | | | | | |
| | | | education | | | | | | | | | | | | |

TABLE 1a

| | | Influence | |
|---|---|---|---|
| | | Value | |
| | | 3 - Strong | KNOW HOW |
| | | 2 - Medium | Value Flow Balance |
| | | 1 - Low | Influence description |
| Ik6 | Vk1 | | No value added detected |
| | Vk2 | | |
| | Vk3 | 1 | internal knowhow materialized in tools and metodologies contribute to the competitive price/quality execution |
| | Vk4 | | No value added detected |
| | Vk5 | | No value added detected |
| | Vk6 | | No value added detected |
| | Vk7 | 2 | Know how in Sales and CRM identifies customer requirements which increase the localisation know-how |
| | Vk8 | | No value added detected |
| | Vk9 | | No value added detected |
| | Vk10 | 3 | Know how in Sales and CRM increase the added value for customer service and education |
| | Ik1 | | No value added detected |
| | Ik2 | 3 | Know how in Sales and CRM identifies the customer requirements for new technologies and creates the need for assimilation |
| | Ik3 | | No value added detected |
| | Ik4 | | No value added detected |
| | Ik5 | 2 | Know how in Sales and CRM has a direct contribution to the know how in commercial an technical proposal |
| | Ek1 | 2 | Know how in Sales and CRM has a direct contribution to the know how in commercial an technical presentation |
| | Ek2 | 2 | Know how in Sales and CRM has a direct contribution to the know how in commercial an technical presentation |
| | Ek3 | 2 | Know how in Sales and CRM has a direct contribution |
| | Ek4 | 2 | Know how in Sales and CRM increases the added value of the partnership know how |
| Ik5 | Vk1 | | No value added detected |
| | Vk2 | | No value added detected |
| | Vk3 | 1 | kowhow in building the commercial and technical proposal may influence the knowhow to be price/time/quality competitive |
| | Vk4 | | No value added detected |
| | Vk5 | | No value added detected |
| | Vk6 | | No value added detected |
| | Vk7 | | No value added detected |
| | Vk8 | | No value added detected |
| | Vk9 | | No value added detected |
| | Vk10 | 1 | Commercial an technical proposal know how increase the added value of the CRM know how |
| | Ik1 | | No value added detected |
| | Ik2 | | No value added detected |
| | Ik3 | | No value added detected |
| | Ik4 | | No value added detected |
| | Ik6 | 2 | How well we do the technical proposal can help us in wining the contract |
| | Ek1 | | No value added detected |
| | Ek2 | | No value added detected |
| | Ek3 | | No value added detected |
| | Ek4 | | No value added detected |
| Ik4 | Vk1 | 3 | component development form fast implementation contribute to the knowhow of competence management |
| | Vk2 | 3 | internal component developmet to help fasten implementation will eventualy become advanced methods |
| | | | for project implementation |
| | Vk3 | 3 | are in important factor of a competitive price even raising the time&quality of the implementation |
| | Vk4 | 3 | business modelling and capture might be the beneficiar of new developed components for fast implementation |

TABLE 1b

| | | Influence | |
|---|---|---|---|
| | | Value | |
| | | 3 - Strong | KNOW HOW |
| | | 2 - Medium | Value Flow Balance |
| | | 1 - Low | Influence description |
| | Vk5 | 1 | requests specific programming |
| | Vk6 | 3 | accelerates Go-live |
| | Vk7 | 1 | accelerates product localization |
| | Vk8 | 3 | interacts with infrastructure; may communicate modelling requirements form the infrastructure |
| | Vk9 | 3 | interacts with business intelligence |
| | Vk10 | 1 | interacts with customer services |
| | Ik1 | 3 | Ik4 is formalized in tools and included in procedures and metodologies |
| | Ik2 | | |
| | Ik3 | 3 | reprezents a project optimization techniques only if it is integrated within the project management metodology |
| | Ik5 | | |
| | Ik6 | 1 | it is an element worth to be mentioned through Mkt/sales/CRM channels |
| | Ek1 | 3 | it is an element worth to be mentioned through in seminars |
| | Ek2 | 2 | it is an important element in pre-sales efforts |
| | Ek3 | | No value added detected |
| | Ek4 | | No value added detected |
| Ik3 | Vk1 | 3 | development of optimisation techniques (competencies management, component development . . . ) |
| | | | determines continuos development of project management know-how |
| | Vk2 | 3 | development of optimisation techniques (competencies management, component development . . . ) |
| | | | might result in advanced methods |
| | Vk3 | 3 | optimisation techniques have as result also competitive price/quality execution |
| | Vk4 | 3 | different project management optimisation techniques interact with business capture and modelling know-how |
| | Vk5 | 1 | the need for project management optimisation might create a need to improve know-how in specific programming |
| | Vk6 | 3 | different project management optimisation techniques interact with GO-Live and assistance |
| | Vk7 | 1 | different project management optimisation techniques could improve the know-how in localisation |
| | Vk8 | 3 | different project management optimisation techniques interact with infrastructure modelling |
| | Vk9 | 3 | different project management optimisation techniques interact with business intelligence |
| | Vk10 | 1 | project management requires a direct relationship with customer service know-how |
| | Ik1 | 3 | project management optimisation determines a continuos development of metodologies, tools, procedures |
| | Ik2 | | |
| | Ik4 | 3 | the need for project management optimisation creates the need for component development which to help fast implementation |
| | Ik5 | | |
| | Ik6 | 1 | project management optimzation know-how value is also reflected in the marketing, sales and CRM know-how value |
| | Ek1 | 3 | project management optimzation know-how value is also included in the presales and sales |
| | Ek2 | 2 | project management optimzation know-how value is also included in the presales and sales |
| | Ek3 | | |
| | Ek4 | | |
| Ik2 | Vk1 | 3 | knowhow in training has a direct input to the project management knowhow |
| | Vk2 | 3 | knowhow in training and assimilation of complex technologies accelerates the usage of advanced methods for project |
| | | | execution |
| | Vk3 | 3 | knowhow in training and assimilation of complex technologies benefits the to the price/time/quality equation |
| | Vk4 | 3 | training knowhow has a direct input to the business capture and modelling knowhow |
| | Vk5 | 2 | training knowhow determines the specific programming know how |
| | Vk6 | 3 | training knowhow has a direct input to the go-live and assistance knowhow |
| | Vk7 | 2 | training knowhow determines the localisation knowhow |
| | Vk8 | 3 | training knowhow has a direct input to the infrastructure modelling knowhow |

TABLE 1c

| | | Influence | |
|---|---|---|---|
| | | Value | |
| | | 3 - Strong | KNOW HOW |
| | | 2 - Medium | Value Flow Balance |
| | | 1 - Low | Influence description |
| | Vk9 | 3 | training knowhow has a direct input to the business intelligence knowhow |
| | Vk10 | 3 | training knowhow has a direct input to the customer service and education knowhow |
| | Ik1 | | |
| | Ik3 | | |
| | Ik4 | 1 | fast implementation using different accelerators is pending by a well done training |
| | Ik5 | | |
| | Ik6 | 3 | training knowhow has a direct input in the forming of sales force |
| | Ek1 | 2 | training know how increase the added value of the presales and sales know how |
| | Ek2 | 2 | training know how increase the added value of the customer services know how |
| | Ek3 | | |
| Ik1 | Vk1 | 3 | the internal knowhow materialised in metodologies, tools and procedures will be entirely found in project management |
| | | | knowhow |
| | Vk2 | 3 | the internal knowhow materialised in metodologies, tools and procedures is also advanced method for |
| | | | project implementation |
| | Vk3 | 3 | the competitive advantage given by different metodologies etc . . . is materialised in a competitive price/quality |
| | Vk4 | 3 | the internal knowhow materialised in metodologies, tools and procedures is included in business capture&modelling |
| | Vk5 | 1 | internal formalised knowhow have some contribution to programming |
| | Vk6 | 3 | the internal knowhow materialised in metodologies, tools and procedures is included in go-live & assistance |
| | Vk7 | 3 | the internal knowhow materialised in metodologies, tools and procedures is included in product localisation |
| | Vk8 | 3 | the internal knowhow materialised in metodologies, tools and procedures is included in infrastructure modelling |
| | Vk9 | 3 | the internal knowhow materialised in metodologies, tools and procedures is included in business intelligence |
| | Vk10 | 3 | the internal knowhow materialised in metodologies, tools and procedures is included in customer service |
| | Ik2 | 2 | metodologies, tools& procedures accelerate the process of complex technologies assimilation |
| | Ik3 | 3 | the internal knowhow materialised in metodologies, tools and procedures is the most important part of project |
| | | | management optimisation knowhow |
| | Ik4 | 3 | must of them are developed to fasten implementation |
| | Ik5 | 3 | metodologies, tools& procedures development benefit to a well-structuring of the commercial and technical proposal |
| | Ik6 | 3 | metodologies, tools & procedures development benefit also to the support activities as marketing, sales and CRM |
| | Ek1, | 2 | part of the internal knowhow (metodologies, tools, procedure) will be subject of the knowhow distributed through |
| | Ek2 | | seminars, sales presentations |
| | Ek3 | 2 | part of the internal knowhow (metodologies, tools, procedure) will be subject of the knowhow distributed through |
| | | | customer services and education |
| | Ek4 | 2 | part of the internal knowhow (metodologies, tools, procedure) will be subject of the knowhow externally |
| | | | distributed through partnership |
| Ek1 | Vk1 | | |
| | Vk2 | | |
| | Vk3 | | |
| | Vk4 | 1 | knowhow externally distributed through seminars must have an feedback in the business capture and modelling knowhow |
| | Vk5 | | |
| | Vk6 | | |
| | Vk7 | 1 | seminars distributing knowhow determine a feedback in knowhow value for localisation |
| | Vk8 | 1 | seminars distributing knowhow determine a feedback in knowhow value for infrastructure modelling |
| | Vk9 | 1 | seminars distributing knowhow determine a feedback in knowhow value for business intelligence |
| | Vk10 | 1 | seminars distributing knowhow determine a feedback in knowhow value for customer service and education |
| | Ik1 | | |
| | Ik2 | | |
| | Ik3 | | |
| | Ik4 | | |

TABLE 1d

| | | Influence | |
|---|---|---|---|
| | | Value | |
| | | 3 - Strong | KNOW HOW |
| | | 2 - Medium | Value Flow Balance |
| | | 1 - Low | Influence description |
| | Ik5 | 3 | externally distributed knowhow through seminars determines a value feedback in commercial and technical proposal |
| | | | knowhow |
| | Ik6 | 3 | externally distributed knowhow through mkt, presales &sales effort determines a value-feedback in the internal |
| | | | corresponding departments |
| | Ek2 | 1 | interacts |
| | Ek3 | 1 | externally distributed knowhow through mkt, presales &sales effort interacts with the externally distributed knowhow |
| | | | through customer service |
| | Ek4 | 1 | externally distributed knowhow through mkt, presales &sales effort interacts with the externally distributed knowhow |
| | | | through partnership |
| Ek2 | Vk1 | | |
| | Vk2 | | |
| | Vk3 | | |
| | Vk4 | 1 | knowhow externally distributed through presales, sales and marketing activities must have an input in the business capture |
| | | | and modelling knowhow |
| | Vk5 | | |
| | Vk6 | | |
| | Vk7 | 1 | marketing, presales, sales distributing knowhow determine a feedback in knowhow value for localisation |
| | Vk8 | 1 | marketing, presales, sales distributing knowhow determine a feedback in knowhow value for infrastructure modelling |
| | Vk9 | 1 | marketing, presales, sales distributing knowhow determine a feedback in knowhow value for business intelligence |
| | Vk10 | 1 | marketing, presales, sales distributing knowhow determine a feedback in knowhow value for customer service and |
| | | | education |
| | Ik1 | | |
| | Ik2 | | |
| | Ik3 | | |
| | Ik4 | | |
| | Ik5 | 3 | externally distributed knowhow through mkt, presales &sales effort determines a value feedback in commercial and |
| | | | technical proposal knowhow |
| | Ik6 | 3 | externally distributed knowhow through mkt, presales &sales effort determines a value-feedback in the internal |
| | | | corresponding departments |
| | Ek3 | 1 | externally distributed knowhow through mkt, presales &sales effort interacts with the externally distributed knowhow |
| | | | through customer service |
| | Ek4 | 1 | externally distributed knowhow through mkt, presales &sales effort interacts with the externally distributed knowhow |
| | | | through partnership |
| Ek3 | Vk1 | | |
| | Vk2 | | |
| | Vk3 | | |
| | Vk4 | 1 | externally distributed knowhow through customer services must have an input in the business capturing and modelling |
| | Vk5 | | |
| | Vk6 | 2 | externally distributed knowhow through customer services educates the client for go-live |
| | Vk7 | | |
| | Vk8 | | |
| | Vk9 | | |
| | Vk10 | 3 | externally distributed knowhow through customer services directly helps the activity of customer service and education sold |
| | Ik1 | | |
| | Ik2 | | |
| | Ik3 | | |
| | Ik4 | | |
| | Ik5 | | |
| | Ik6 | 1 | externally distributed knowhow through customer services interacts with the internal distribution through |
| | | | marketing, sales &CRM |
| | Ek1 | | |
| | Ek2 | | |
| | Ek4 | 1 | the relationship with a client is also view as a partnership |

TABLE 1e

| | | Influence | |
|---|---|---|---|
| | | Value | |
| | | 3 - Strong | KNOW HOW |
| | | 2 - Medium | Value Flow Balance |
| | | 1 - Low | Influence description |
| Ek4 | Vk1 | | |
| | Vk2 | | |
| | Vk3 | 2 | partnership might influence productivity (outsourcing) |
| | Vk4 | 1 | external knowhow of partnership improves the business capturing and modelling |
| | Vk5 | | |
| | Vk6 | | |
| | Vk7 | 2 | indentification of the specific partner business may |
| | Vk8 | 2 | Determines updates in infrastructure modelling |
| | Vk9 | 2 | Determines updates in infrastructure modelling |
| | Vk10 | 3 | Provides inputs |
| | Ik1 | 2 | Determines updates |
| | Ik2 | 3 | Improves the process of assimilation |
| | Ik3 | 2 | Determines updates |
| | Ik4 | 1 | Contributes to optimisation |
| | Ik5 | 2 | Provides inputs |
| | Ik6 | 2 | Provides feedback |
| | Ek1 | 2 | Provides input |
| | Ek2 | 1 | Provides input |
| | Ek3 | 2 | Provides input |
| Vk1 | Ik1 | 2 | Project management know how identifies the methodologies, tools and procedures to be developed |
| | Ik2 | 1 | Project management know how may indicates what technologies to be assimilated |
| | Ik3 | 2 | Project management know how is the start-up factor for project management optimisation |
| | Ik4 | 3 | Project management know how is the start-up factor for the development of accelerators |
| | Ik5 | 2 | Project management know how determines the way in which commercial and technical proposal are made |
| | Ik6 | 1 | Project management know how may influence the sales and CRM |
| | Ek1 | | |
| | Ek2 | | |
| | Ek3 | | |
| | Ek4 | 1 | Project management know how may influence the partnership development |
| Vk4 | Ik1 | 3 | Business capture and modelling know influences the methodologies, tools and procedures |
| | Ik2 | 1 | Business capture and modelling may determine the technologies to be assimilated |
| | Ik3 | 3 | Business capture and modelling generates the need for accelerators |
| | Ik4 | 3 | Business capture and modelling generates the project management optimisation |
| | Ik5 | 1 | Business capture and modelling know is reflected in the commercial and technical proposal |
| | Ik6 | 2 | Business capture and modelling know how must be reflected in marketing, sales and CRM know how |
| | Ek1 | 1 | Business capture and modelling know how must be reflected in sales and presales |
| | Ek2 | 2 | Business capture and modelling determines the development of the customer service |
| | Ek3 | 1 | Business capture and modelling may influence the partnership development |
| Vk5 | Ik1 | 1 | Specific programming know how may determine the development of the different tools and metodologies |
| | Ik2 | 2 | Specific programming know how may ask to assimilate new technologies |
| | Ik3 | | |
| | Ik4 | | |

TABLE 1f

| | | Influence | |
|---|---|---|---|
| | | Value | |
| | | 3 - Strong | KNOW HOW |
| | | 2 - Medium | Value Flow Balance |
| | | 1 - Low | Influence description |
| | Ik5 | 3 | Specific programming know increases the project management optimisation |
| | Ik6 | | |
| | Ik7 | | |
| | Ek1 | | |
| | Ek2 | 1 | advanced programming might be a part of the advantage |
| | Ek3 | | |
| | Ek4 | 1 | might consider a good point in a partnership |
| Vk6 | Ik1 | 3 | Go live know how asks for continuos improvement of metodologies tools and procedures |
| | Ik2 | | |
| | Ik3 | 3 | Go live know how asks for continuos improvement the project management optimisation |
| | Ik4 | 3 | Go live know how asks for continuos improvement of different components |
| | Ik5 | 2 | Go live know how asks for updating commercial and technical proposal |
| | Ik6 | 1 | Production assistance provides feed back to marketing, sales and CRM |
| | Ek1 | 2 | Go live know how is partially distributed through seminars and sales efforts |
| | Ek2 | | |
| | Ek4 | 1 | Go live know how is partially distributed to partners |
| Vk7 | Ik1 | 2 | Product localisation know how is asking for updating of procedures and metodolgies |
| | Ik2 | | |
| | Ik3 | 1 | Product localization know how has to be included in the project management optimization |
| | Ik4 | 1 | Product localization know how contributes to fasten implementation |
| | Ik5 | 1 | Product localization know how has to be included in contract and technical sales proposal |
| | Ik6 | 1 | Product localization know how provides inputs |
| | Ek1 | | |
| | Ek2 | 3 | Product localization know how must be presented in seminars, presales and sales efforts |
| | Ek3 | | |
| | Ek4 | 1 | Product localization know how is a value contribution to the partnership |
| Vk8 | Ik1 | 3 | Infrastructure modelling know how asks for improvement of metodologies tools and procedures |
| | Ik2 | 2 | Infrastructure modelling know how asks for complex technologies assimilation |
| | Ik3 | 1 | Infrastructure modelling know how determines the project management optimization |
| | Ik4 | 1 | Infrastructure modelling know how determines some components development form fast implementation |
| | Ik5 | 2 | Infrastructure modelling know how provides inputs for commercial and technical proposal |
| | Ik6 | 2 | Infrastructure modelling know how provides inputs for marketing, sales and CRM |
| | Ek1 | 1 | Infrastructure modelling know how provides inputs |
| | Ek2 | 1 | Infrastructure modelling know how provides inputs |
| | Ek3 | 2 | Infrastructure modelling know how provides inputs |
| Vk9 | Ik1 | 3 | Business intelligence know how asks for improvement |
| | Ik2 | 1 | Business intelligence know how asks for complex technologies assimilation |
| | Ik3 | 2 | Business intelligence know how determines the project management optimization |
| | Ik4 | 1 | determines the development of components to fasten implementation |
| | Ik5 | 2 | Business intelligence provides inputs |
| | Ik6 | 2 | Business intelligence provides inputs |
| | Ek1 | 1 | Business intelligence provides inputs |

TABLE 1g

| | | Influence | |
|---|---|---|---|
| | | Value | |
| | | 3 - Strong | KNOW HOW |
| | | 2 - Medium | Value Flow Balance |
| | | 1 - Low | Influence description |
| | Ek2 | 1 | Business intelligence provides inputs |
| | Ek3 | 2 | Business intelligence provides inputs |
| Vk10 | Ik1 | 2 | Customer service and education know how determines the improvement of the |
| | | | metodologies, tools and procedures |
| | Ik2 | 2 | Customer service and education know how creates the need for new technologies |
| | Ik3 | 1 | Customer service and education influences the project optimization |
| | Ik4 | 1 | Customer service and education influences the usage of accelerators |
| | Ik5 | 1 | provides inputs |
| | Ik6 | 3 | Customer service and education provides inputs |
| | Ek1 | 1 | Customer service and education provides inputs |
| | Ek2 | 1 | Customer service and education provides inputs |
| | Ek3 | 3 | provides materials to be freely distributed to customers |
| | Ek4 | 3 | Customer service and education provides inputs |

TABLE 2
Partnership Value Flow Balance influences representation

| | | | | | | | | ip1 | ip2 | ip3 | ip4 | ep1 | ep2 | ep3 | | |
|---|---|---|---|---|---|---|---|---|---|---|---|---|---|---|---|---|
| | | P1 | P2 | P3 | P4 | P5 | P6 | P7 | P8 | P9 | P10 | P11 | P12 | P13 | | |
| 11 | ip1 | x | x | x | x | x | x | 0 | x | x | x | | x | x | | |
| | | x | x | x | x | x | x | | | | | | | | | |
| 10 | ip2 | | x | x | x | x | x | x | 0 | x | x | | x | x | | |
| | | | x | x | x | x | x | | | | | | | | | |
| 11 | ip3 | | x | x | x | x | x | x | x | 0 | x | x | x | x | | |
| | | | x | x | x | x | x | | | | | | | | | |
| 12 | ip4 | x | x | x | x | x | x | x | x | x | 0 | x | x | x | | |
| | | | x | x | x | x | x | | | | | | | | | |
| | | | x | x | x | x | x | x | x | x | x | 0 | x | x | ep1 | 10 |
| | | | x | x | x | x | x | | | | | | | | | |
| | | | x | | x | | x | x | x | | x | x | 0 | x | ep2 | 8 |
| | | | x | x | x | x | x | | | | | | | | | |
| | | | x | | x | x | | x | | | x | x | x | 0 | ep3 | 8 |
| | | x | x | x | x | x | x | | | | | | | | | |
| | | Vp1 | Vp2 | Vp3 | Vp4 | Vp5 | Vp6 | | | | | | | | | |
| | | 2 | 7 | 7 | 7 | 7 | 7 | | | | | | | | | |

TABLE 2a
Partnership Value Flow Balance

| | Vp1 | Vp2 | Vp3 | Vp4 | Vp5 | Vp6 |
|---|---|---|---|---|---|---|
| ip1 = 30 | 2 | 2 | 3 | 3 | 3 | 3 |
| Know how | 2 | 1 | 2 | 2 | 3 | 2 |
| transfer | | | | | | |
| ip2 = 24 | | 1 | 3 | 3 | 3 | 3 |
| Develop methods | | 1 | 2 | 3 | 2 | 2 |
| and tools to | | | | | | |
| improuve the partner | | | | | | |
| product usage | | | | | | |
| in our projects | | | | | | |
| ip3 = 25 | | 1 | 3 | 3 | 3 | 2 |
| Localization of the product | | 1 | 2 | 2 | 3 | 2 |
| ip4 = 28 | 2 | 2 | 3 | 3 | 2 | 3 |
| Competence and | | 1 | 3 | 3 | 3 | 3 |
| know how build | | | | | | |
| to give | | | | | | |
| a competitive | | | | | | |
| advantage for | | | | | | |
| the partner | | | | | | |
| products | | | | | | |
| | | 2 | 1 | 3 | 3 | 3 |
| | | 2 | 1 | 3 | 2 | 2 |
| | | 1 | | 3 | | 3 |
| | | 1 | 1 | 2 | 2 | 3 |
| | | 2 | | 2 | 2 | |
| | 3 | 3 | 2 | 3 | 3 | 3 |
| | Vp1 = 5 | Vp2 = 10 | Vp3 = 13 | Vp4 = 18 | Vp5 = 18 | Vp6 = 17 |
| | Identification | Making | Packaging | Business | Partner | Competence |
| | of the | partner | the | development in | technology | building for |
| | leading | contracts | partnetship | partnetship | localization | the product |
| | technology | with the industry | product with | | | |
| | partners | “leaders” and | our own | | | |
| | | “stars” | added value | | | |

| | ip1 | ip2 | ip3 | ip4 | ep1 | ep2 | ep3 | |
|---|---|---|---|---|---|---|---|---|
| ip1 = 30 | 0 | 3 | 3 | 3 | | 2 | 3 | |
| Know how | | | | | | | | |
| transfer | | | | | | | | |
| ip2 = 24 | 1 | 0 | 2 | 3 | | 2 | 3 | |
| Develop methods | | | | | | | | |
| and tools to | | | | | | | | |
| improuve the partner | | | | | | | | |
| product usage | | | | | | | | |
| in our projects | | | | | | | | |
| ip3 = 25 | 2 | 2 | 0 | 3 | 1 | 2 | 3 | |
| Localization of the product | | | | | | | | |
| ip4 = 28 | 1 | 2 | 2 | 0 | 2 | 3 | 3 | |
| Competence and | | | | | | | | |
| know how build | | | | | | | | |
| to give | | | | | | | | |
| acompetitive | | | | | | | | |
| advantage for | | | | | | | | |
| the partner | | | | | | | | |
| products | | | | | | | | |
| | 3 | 1 | 2 | 2 | 0 | 2 | 2 | ep1 = 24 |
| | | | | | | | | Quality and transparent |
| | | | | | | | | relation ship |
| | 3 | 1 | | 3 | 2 | 0 | 3 | ep2 = 19 |
| | | | | | | | | High qualified |
| | | | | | | | | competencies and know |
| | | | | | | | | how contribution |
| | 1 | | | 1 | 2 | 2 | 0 | ep3 = 12 |
| | | | | | | | | Strong customer bases |
| | | | | | | | | and high market image |

TABLE 2b
Description of interactions in Pamership Value Flow Balance

| | | Influence Value | |
|---|---|---|---|
| | | 3 - Strong | |
| | | 2 - Medium | |
| | | 1 - Low | Influence description |
| Ip1 | Vp1 | 2 | Know how transfer makes the identification of the leading technology partners easier |
| | Vp2 | 2 | Know how transfer helps making partners contracts with the industry “leaders” and “stars”; contrats will be safer and |
| | | | more proffesional |
| | Vp3 | 3 | Know how transfer improuves the ability to package the partner's product with our own added value |
| | Vp4 | 3 | Know how transfer will develop the existing business in partnership and create new business opportunities |
| | Vp5 | 3 | An efficient know how transfer makes the partner technology localization easier and more proffitable |
| | Vp6 | 3 | An efficient know how transfer will build competence for the product |
| | Ip2 | 3 | Know how transfer helps to develop methodologies and tools in order to improuve the partner product usage in our |
| | | | projects |
| | Ip3 | 3 | Localization of the partner product is easier if the know how transfer was efficient |
| | Ip4 | 3 | An efficient know how transfer will increase the competence and know how build to give a competitive advantage for |
| | | | the partner product |
| | ep1 | | No added value detected |
| | ep2 | 3 | Know how transfer will make high competencies and know how transfer available |
| | ep3 | 3 | Know how transfer will improuve our own market image |
| Ip2 | Vp1 | | No added value detected |
| | Vp2 | 1 | Development of methodologies and tools in order to improuve the partner product usage in our |
| | | | projects makes helps making partners contracts with the industry “leaders” and “stars”; contrats will be safer and more |
| | Vp3 | 3 | Development of methodologies and tools in order to improuve the partner product usage |
| | | | in our projects improuves the ability to package the partner's product with our own added value |
| | Vp4 | 3 | Development of methodologies and tools in order to improuve the partner product usage |
| | | | in our projects with develop the existing business in partnership and create new business opportunities |
| | Vp5 | 3 | New or improuved methodologies and tools coud have an essential contribution in the partner technology localization |
| | Vp6 | 3 | New or improuved methodologies and tools with increase the competence for the product |
| | Ip1 | 1 | New or improuved methodologies and tools make know haw transfer easier |
| | Ip3 | 2 | Localization of the partner product could be accelerated by the new technologies and tools |
| | Ip4 | 3 | Development of methodologies and tools has as a consequence a higher competence and know how |
| | ep1 | | No added value detected |
| | ep2 | 2 | Development of methodologies and tools will make high competencies and know how transfer available |
| | ep3 | 3 | Our own market image will be better if we will develop methodologies and tools |
| Ip3 | Vp1 | | No added value detected |
| | Vp2 | 1 | Localization of the product could help making partner contracts with thw industry “leaders” and “stars” |
| | Vp3 | 3 | Localization of the product increases our own added value in packaging the parner product |
| | Vp4 | 3 | The business development in parnership has many chances if the product is localized |
| | Vp5 | 3 | Localization of the product is a part of localization of the technology |
| | Vp6 | 2 | Localization of the product will increase the competence building for the product |
| | Ip1 | 2 | Localization of the product will make the know how transfer more efficient |
| | Ip2 | 2 | Localization of the product could have as a result the delopement of methodologies and tools |
| | Ip4 | 3 | The competence and know how build to give a competitive advantage in the partnership product will be higher if we will |
| | | | develop methodologies and tools |
| | ep1 | 1 | A quality and transparent relationship with the partner will be stimulated if we will develop methodologies and tools |
| | ep2 | 2 | More high-qualified competencies and know how transfer contribution will be available |
| | ep3 | 3 | Localization of the product will improuve our market image |

TABLE 2c
Description of interactions in Parnership Value Flow Balance

| | | | |
|---|---|---|---|
| Ip4 | Vp1 | 2 | Competence and know how build to give a competitive advantage for the partnership |
| | | | products will make easier the identification of the leading technologies |
| | Vp2 | 2 | Competence and know how build to give a competitive advantage for the partnership |
| | | | products help making contracts with the industry “leaders” and “stars” |
| | Vp3 | 3 | Competence and know how build to give a competitive advantage for the partnership |
| | | | products help packaging the partner product with our own value |
| | Vp4 | 3 | A high competence and know how develop the business in parnership develop the business in parnership |
| | Vp5 | 2 | A high competence and know how make the partner technology localization easier |
| | Vp6 | 3 | Competence and know how build to give a competitive advantage for the partnership |
| | | | products reflect the competence building for the product |
| | Ip1 | 1 | A high competence and know how develop the business in parnership help a continue know how transfer |
| | Ip2 | 2 | A high competence and know how develop the business in parnership have as a |
| | | | result the development of methods and tools |
| | Ip3 | 2 | A high competence and know how make the partner product localization easier |
| | ep1 | 2 | The quality of relationship will be improuved by a high competence |
| | ep2 | 3 | Competence and know how build to give a competitive advantage for the partnership |
| | | | products will make high qualified competencies available |
| | ep3 | 3 | A high competence and know how will improuve our market image |
| ep1 | Vp1 | | No added value detected |
| | Vp2 | 2 | A quality and transparent relationship helps making fair contracts with the industry “leaders” and “stars” |
| | Vp3 | 1 | Packaging the partnet product with our own value will be improuved by a quality and transparent relationship |
| | Vp4 | 3 | If a transparent relationship is a fact, the business in partnership will develop |
| | Vp5 | 3 | A transparent relationship will help in the partner technology localization process |
| | Vp6 | 3 | A transparent relationship will increase the competence building for the product |
| | Ip1 | 3 | Know how transfer will be more efficient in case of a quality relationship |
| | Ip2 | 1 | A quality and transparent relationship could help in the development of methodologies and tools process |
| | Ip3 | 2 | A transparent relationship will help in the partner product localization process |
| | Ip4 | 2 | Competence and know how could increase in the case of a quality relationship |
| | ep2 | 2 | A transparent relationship will increase our high qualified contribution |
| | ep3 | 2 | A quality and transparent relationship will improuve our market image |
| ep2 | Vp1 | | No added value detected |
| | Vp2 | 1 | Our high qualified competencies and know how contribution will help the making contracts process |
| | Vp3 | | No added value detected |
| | Vp4 | 3 | Our high qualified competencies and know how contribution will help the business development |
| | Vp5 | | No added value detected |
| | Vp6 | 3 | Our high qualified competencies and know how contribution will increase the competence building process |
| | Ip1 | 3 | Our high qualified competencies and know how contribution will make the know how transfer more efficient |
| | Ip2 | 1 | Development of methods and tools could be help by our high qualified competencies end know how contribution |
| | Ip3 | | No added value detected |
| | Ip4 | 3 | Our high qualified competencies and know how contribution has a strong impact in building competence process |
| | ep1 | 2 | Our high qualified competencies and know how contribution will make the relationship stronger |
| | ep3 | 3 | Our high qualified competencies and know how contribution will highly improuve our market image |
| ep3 | Vp1 | | No added value detected |
| | Vp2 | 2 | Our strong customer bases and market image will help making contract process |

TABLE 2d
Description of interactions in Parnership Value Flow Balance

| | Vp3 | | No added value detected |
|---|---|---|---|
| | Vp4 | 2 | Our strong customer bases and market image could help the packaging process |
| | Vp5 | 2 | Our strong customer bases and market image will develop the business |
| | Vp6 | | No added value detected |
| | Ip1 | 1 | Our strong customer bases and market image could help the know how transfer process |
| | Ip2 | | No added value detected |
| | Ip3 | | No added value detected |
| | Ip4 | 1 | Our strong customer bases and market image could increase our competence as a competitive advantage |
| | ep1 | 2 | A high market image will improuve our relationship |
| | ep2 | 2 | A high market image will make high qualified competencies available |
| Vp1 | Ip1 | 2 | The identification of leading technology partners process is a know how transfer |
| | Ip2 | | No added value detected |
| | Ip3 | | No added value detected |
| | Ip4 | | No added value detected |
| | ep1 | | No added value detected |
| | ep2 | | No added value detected |
| | ep3 | 3 | The identification of leading technology partners process will highly increase our market image |
| Vp2 | Ip1 | 1 | Making partner contracts with thw industry “leader” and “stars” will create new know how transfer opportunities |
| | Ip2 | 1 | Making partner contracts with thw industry “leaders” and “stars” can create the nedd to develop methods and tools |
| | Ip3 | 1 | Making partner contracts with thw industry “leaders” and “stars” can create the nedd to localization of the product |
| | Ip4 | 1 | Making partner contracts with thw industry “leaders” and “stars” will increase the competence build to give a |
| | | | competitive advantage for the partner products |
| | ep1 | 2 | Making partner contracts with thw industry “leaders” and “stars” has a result a quality relationship |
| | ep2 | 1 | Making partner contracts with thw industry “leaders” and “stars” will make high qualified competencies available |
| | ep3 | 3 | Making partner contracts with thw industry “leaders” and “stars” will highly improuve our market image |
| Vp3 | Ip1 | 2 | Packaging the partnership product with our own added value will accelerate the know how transfer process |
| | Ip2 | 2 | Packaging the partnership product with our own added value will create a development of methods and tools need |
| | Ip3 | 2 | Packaging the partnership product with our own added value can help the product localization process |
| | Ip4 | 3 | Packaging the partnership product with our own added value will increase our competence |
| | ep1 | 1 | Packaging the partnership product with our own added value will improuve the quality of relationship |
| | ep2 | 1 | Packaging the partnership product with our own added value will make competencies available |
| | ep3 | 2 | Packaging the partnership product with our own added value can increase our market image |
| Vp4 | Ip1 | 2 | Business development in partnership will stimulate the know how transfer |
| | Ip2 | 3 | Business development in partnership will determine development of metods and tools |
| | Ip3 | 2 | Business development in partnership will help the product localization process |
| | Ip4 | 3 | Business development in partnership will increase our competence and know how |
| | ep1 | 3 | Business development in partnership will stimulate a transparent and quality relationship |
| | ep2 | 2 | Business development in partnership will make new competencies available |
| | ep3 | 3 | Business development in partnership will highly improuve our market image |

TABLE 2e
Description of interactions in Parnership Value Flow Balance

| | | | |
|---|---|---|---|
| Vp5 | ip1 | 3 | The partner technology localization will highly improuve the know how transfer process |
| | ip2 | 2 | The partner technology localization can create development of methods and tools need |
| | ip3 | 3 | The partner product localization is part of technology localization |
| | ip4 | 3 | The partner technology localization will highly improuve our competencies |
| | ep1 | 2 | The partner technology localization will improuve our relationship |
| | ep2 | 2 | The partner technology localization will make competencies contribution available |
| | ep3 | 3 | The partner technology localization will highly improuve our market image |
| Vp6 | ip1 | 2 | Competence building process for the product will accelerate the know how transfer |
| | ip2 | 2 | Competence building process for the product can create the need to develop methods and tools |
| | ip3 | 2 | Competence building process for the product will accelerate the product localization process |
| | ip4 | 3 | Competence building process for the product will be strong competitive advantage |
| | ep1 | 2 | Competence building process for the product will stimulate a quality relationship |
| | ep2 | 3 | Competence building process for the product will make more competencies available |
| | ep3 | 3 | Competence building process for the product will strongly improuve our market image |

TABLE 3
Production Value Flow Balance representation of influences

| | 6 | 5 | 4 | 4 | 3 | 4 | 11 | 8 | 11 | 9 | 1 | 6 | 8 | |
|---|---|---|---|---|---|---|---|---|---|---|---|---|---|---|
| Total | V1 | V2 | V3 | V4 | V5 | V6 | I1 | I2 | I3 | I4 | E1 | E2 | E3 | |
| | | | | | | X | | | | | 0 | | | E1 |
| | X | X | | | | X | | | | | | | | |
| | | X | X | X | X | X | | | | | X | 0 | | E2 |
| | X | X | | | | X | | | | | | | | |
| | X | X | | | X | X | X | X | | | X | X | 0 | E3 |
| | X | X | | | X | | | | | | | | | |
| I4 | X | X | X | X | X | X | | X | | 0 | X | | X | |
| | | | X | X | X | | | | | | | | | |
| I3 | X | X | X | X | X | | X | X | 0 | | | X | X | |
| | X | X | X | X | | | | | | | | | | |
| I2 | X | X | X | X | X | X | | 0 | | | X | X | | |
| | X | | X | X | | X | | | | | | | | |
| I1 | X | X | X | X | X | X | 0 | | X | X | X | X | X | |
| | X | X | X | X | X | X | | | | | | | | |
| | V1 | V2 | V3 | V4 | V5 | V6 | | | | | | | | |

TABLE 3a
PRODUCTION VALUE FLOW BALANCE

| | | 9 | 9 | 10 | 10 | 8 | 8 |
|---|---|---|---|---|---|---|---|
| | TOTAL | V1 | V2 | V3 | V4 | V5 | V6 |
| | | | | | | | 2 |
| | | 1 | 2 | | | | 3 |
| | | | 3 | 1 | 1 | 1 | 2 |
| | | 2 | 3 | | | | 3 |
| | | 1 | 3 | | | 3 | 3 |
| | | 2 | 2 | | | 3 | |
| Localization | I4 | 1 | 1 | 1 | 2 | 2 | 3 |
| and local | | | | 3 | 3 | 3 | |
| libraries | | | | | | | |
| for all | | | | | | | |
| products | | | | | | | |
| Training | I3 | 3 | 2 | 3 | 1 | 2 | |
| support for | | 1 | 1 | 1 | 2 | | |
| advanced and complex | I2 | 2 | 2 | 3 | 1 | | 1 |
| know-how & | | | | | | | |
| competencies | | | | | | | |
| Components | | | | | | | |
| development kit for | | | | | | | |
| simple projects fast | | 2 | | 3 | 2 | | 1 |
| implementation | | | | | | | |
| Methodologies, | I1 | 3 | 2 | 3 | 3 | 1 | 1 |
| tools, procedures | | 1 | 1 | 3 | 3 | 2 | 1 |
| for competitive | | | | | | | |
| advantage | | | | | | | |
| implementation | | | | | | | |
| | | V1 | V2 | V3 | V4 | V5 | V6 |
| | | Technologies | Pre-sales | Projects | GO-Live & | Customer | Marketing & |
| | | competencies and | Business capture | execution | Production | services | Public |
| | | know-how | and | | change | | relations, |
| | | management | technical | | management | | sales,CRM |
| | | for projects | solution | | assistance | | |

| | | 21 | 14 | 23 | 14 | 2 | 11 | 17 | | |
|---|---|---|---|---|---|---|---|---|---|---|
| | TOTAL | I1 | I2 | I3 | I4 | E1 | E2 | E3 | | |
| | | | | | | 0 | | | E1 | Presentation support for providing |
| | | | | | | | | | | modern, advanced solutions for |
| | | | | | | | | | | business |
| | | | | | | 3 | 0 | | E2 | Project execution like sample to |
| | | | | | | | | | | prospects to sustain our quality and |
| | | | | | | | | | | content of our offer |
| | | 2 | 1 | | | 2 | 2 | 0 | E3 | Customer services like premium |
| | | | | | | | | | | but also to optimize their business |
| Localization | I4 | | 2 | | 0 | 1 | | 1 | | |
| and local | | | | | | | | | | |
| libraries | | | | | | | | | | |
| for all | | | | | | | | | | |
| products | | | | | | | | | | |
| Training | I3 | 3 | 3 | 0 | | | 3 | 3 | | |
| support for | I2 | 1 | 0 | | | 1 | 3 | | | |
| advanced and complex | | | | | | | | | | |
| know-how & | | | | | | | | | | |
| competencies | | | | | | | | | | |
| Components | | | | | | | | | | |
| development kit for | | | | | | | | | | |
| simple projects fast | | | | | | | | | | |
| implementation | | | | | | | | | | |
| Methodologies, | I1 | 0 | | 1 | 1 | 2 | 3 | 1 | | |
| tools, procedures | | | | | | | | | | |
| for competitive | | | | | | | | | | |
| advantage | | | | | | | | | | |
| implementation | | | | | | | | | | |

TABLE 3b

| | | Influence | |
|---|---|---|---|
| | | value | Influence description |
| I1 | V1 | 3 | Management has to adapt to methodologies |
| | V2 | 2 | Business capture and tech.proposal are realised based on methodology |
| | V3 | 3 | Whole project execution is determined by methodology |
| | V4 | 3 | Go-live is determined by methodology |
| | V5 | 1 | part of our competitive advantage and might be included in the customer service |
| | V6 | 1 | development of tools, metodologies&procedures in order maintain the competitive advantage is reflected in marketing, |
| | | | sales&CRM activities. |
| | I1 | 0 | No added value detected |
| | I2 | | No added value detected |
| | I3 | 1 | in order to optain competitive advantage from the developed tools, training must be made |
| | I4 | 1 | Methodologies determine the way in which programs are executed and distributed to the customers |
| | E1 | 2 | Methodologies and tools drive the realisation of workshops and presentation |
| | E2 | 3 | The mini-projects are executed in accordance with the methodologies developed and using the tools |
| | E3 | 1 | part of internaly developed tools&metodologies become part of the free-distribution to the customer |
| I2 | V1 | 2 | Management has to adapt to the use of components, accelerators etc. |
| | V2 | 2 | Business capture and tech.proposal can be based on the usage of components and accelerators |
| | V3 | 3 | Project execution is influenced by the use of components and accelerators |
| | V4 | 1 | Training and testing in the Go-live phase are influenced by the use of preconfigured system |
| | V5 | | No added value detected |
| | V6 | 1 | CRM, sales&marketing must be informed and “popularise” at their turn our development of components and accelerators |
| | I1 | 1 | the development of accelerators must be quickly integrated in our metodologies, tools and procedures |
| | I2 | 0 | No added value detected |
| | I3 | | No added value detected |
| | I4 | | No added value detected |
| | E1 | 1 | part of our competitive advantage, so might be included in presentations |
| | E2 | 3 | The preconfigured client is the base for most ERP miniprojects |
| | E3 | | No added value detected |
| I3 | V1 | 3 | Management is based on the use of new technologies which requires training |
| | V2 | 2 | Technical proposal cannot be generated without training |
| | V3 | 3 | Project execution is based on team know-how (and therefore training) |
| | V4 | 1 | Go-live can be influenced by decisions taken in the modeling phase (determined by degree of training) |
| | V5 | 2 | Customer service is provided based on complex know-how and competences |
| | V6 | | No added value detected |
| | I1 | 3 | Presentations and workshops are executed by trained consultants |
| | I2 | 3 | Internal training must be performed both for the realisation of the components and for the use of the components and kits |
| | I3 | 0 | No added value detected |
| | 14 | | No added value detected |
| | E1 | | No added value detected |
| | E2 | 3 | Project execution must be performed by trained consultants |
| | E3 | 3 | The services provided to the customers are based on the internal training |
| I4 | V1 | 1 | Management must take in consideration the offering of free localisation offered |
| | V2 | 1 | Technical proposal will comprise free localisation offered |

TABLE 3c

| | | | |
|---|---|---|---|
| | V3 | 1 | Inside project execution can be included the testing and management of the localistion offered to the customer |
| | V4 | 2 | During Go-live all free localised programs will be also provided to end-users |
| | V5 | 2 | Customer service will include free localisation offered |
| | V6 | 3 | Marketing uses as selling point the free localisation offered |
| | I1 | | No added value detected |
| | I2 | 2 | The localised programes are delivered as part of a component (preconfigured client) |
| | I3 | | No added value detected |
| | I4 | 0 | No added value detected |
| | E1 | 1 | a competitive advantage, a part in presentations |
| | E2 | | No added value detected |
| | E3 | 1 | part of what is free distributed to the client in order to attract it |
| E1 | V1 | | No added value detected |
| | V2 | 0 | No added value detected |
| | V3 | | No added value detected |
| | V4 | | No added value detected |
| | V5 | | No added value detected |
| | V6 | 2 | Marketing and some of the sales activities require presentations |
| | I1 | | No added value detected |
| | I2 | | No added value detected |
| | I3 | | No added value detected |
| | I4 | | No added value detected |
| | E1 | 0 | No added value detected |
| | E2 | | No added value detected |
| | E3 | | No added value detected |
| E2 | V1 | | No added value detected |
| | V2 | 3 | Free mini-projects are a strong support for pre-sales activities |
| | V3 | 1 | provide inputs for the future project execution |
| | V4 | 1 | provide inputs for the future project execution and Go-Live |
| | V5 | 1 | provides import feedback for sales and customer service team |
| | V6 | 2 | Free mini-projects are sometimes used in marketing activities |
| | I1 | | No added value detected |
| | I2 | | No added value detected |
| | I3 | | No added value detected |
| | I4 | | No added value detected |
| | E1 | 3 | The free project can be the basis of workshops and presentations. |
| | E2 | 0 | No added value detected |
| | E3 | | No added value detected |
| E3 | V1 | 1 | important influence |
| | V2 | 3 | Special consulting issues (business optimisation) are support for pre-sales activities |
| | V3 | | No added value detected |
| | V4 | | No added value detected |
| | V5 | 3 | the value that is free-distributed to the client as premium provides an feedback to the customer service acitivity |
| | V6 | 3 | Special consulting issues (business optimisation) are support for marketing and sometimes constitute a basis for negotiation in sales |

TABLE 3d

| | | | |
|---|---|---|---|
| | I1 | 2 | value distributed free towards customers provides feedbacks and inputs to metodology and procedures |
| | I2 | 1 | feedback from clients might require the development of accelerators |
| | I3 | | No added value detected |
| | I4 | | No added value detected |
| | E1 | | No added value detected |
| | E2 | | No added value detected |
| | E3 | 0 | No added value detected |
| V1 | I1 | 1 | competencies and know-how management in projects provides inputs for procedures, metodologies and different tools. |
| | I2 | 2 | Technological management is a prerequisite for designing fast implementation kits |
| | I3 | 1 | project management experience (which includes management of competencies & knowhow) often provides support for training |
| | I4 | | No added value detected |
| | E1 | 1 | Project Management Know-how and technology competencies must be part in presentations |
| | E2 | 2 | Mini projects are executed based on the same Management tehniques developed |
| | E3 | 2 | Business optimization (as services provided to customer) are based on management of technologies and competences |
| V2 | I1 | 1 | presales experience in business capturing and modelling provides feedback to our tools and procedures |
| | I2 | | No added value detected |
| | I3 | 1 | pre-sales business capturing and technical solution provides inputs to the training support for consultants or commercials |
| | I4 | | No added value detected |
| | E1 | 2 | Pre-sales requires the presentation and business capture provides the business process |
| | E2 | 3 | Pre-sales activities identify the requirement to provide these samples |
| | E3 | 2 | Business capture provides the business process |
| V3 | I1 | 3 | Project execution is feed-back for developing new methodologies and correcting the existing ones |
| | I2 | 3 | Components, kits, accelerators are developed based on the project execution experience |
| | I3 | 1 | Whenever a new technology project is executed - this is the base for internal training preparation |
| | I4 | 3 | All localised programs were devloped based on project experience and requirements |
| | E1 | | No added value detected |
| | E2 | | No added value detected |
| | E3 | | No added value detected |
| V4 | I1 | 3 | Go-live is feed-back for developing new methodologies and correcting the existing ones |
| | I2 | 2 | Go live information is feedback for developing components and kits and for developing new accelerators |
| | I3 | 2 | Go live feedback is embedded into training |
| | I4 | 3 | Go Live experience and info is the basis for developing localisation programs |
| | E1 | | No added value detected |
| | E2 | | No added value detected |
| | E3 | | No added value detected |
| V5 | I1 | 2 | Customer services provides feed-back for methodologies, tools and procedures. |
| | I2 | | No added value detected |
| | I3 | | No added value detected |
| | I4 | 3 | Customer services provides feed-back for localisation |
| | E1 | | No added value detected |
| | E2 | | No added value detected |
| | E3 | | No added value detected |
| V6 | I1 | 1 | sales&CRM may identify and create the need for new tools in order to maintain the competitive advantage |

TABLE 3e

| | | |
|---|---|---|
| I2 | 1 | sales&CRM may identify and create the need for new tools in order to maintain the competitive advantage |
| I3 | | No added value detected |
| I4 | | No added value detected |
| E1 | 3 | Marketing, PR, sales activities identify the requirement to provide the presentation |
| E2 | 3 | Marketing, PR, sales provide the requirements for free-projects |
| E3 | | No added value detected |

TABLE 4
Competences Value Flow Balance

| | | | 6 | 19 | 17 | 9 | 23 | 13 |
|---|---|---|---|---|---|---|---|---|
| | | TOTAL | Vc1 | Vc2 | Vc3 | Vc4 | Ic1 | Ic2 |
| Scala | | Ec3 | | | | | | |
| Impact mic: 1 | | | | 2 | | 2 | | |
| Impact mediu: 2 | | Ec2 | | | | | 1 | |
| Impact mare: 3 | | | | 2 | 2 | 1 | | |
| | | Ec1 | | | | 2 | 2 | |
| | | | | 3 | 3 | 2 | | |
| Competitive | 19 | Ic4 | | 2 | 3 | 3 | 2 | 2 |
| advantage | | | 2 | 3 | 3 | 2 | | |
| competence | | | | | | | | |
| production | | | | | | | | |
| Conversion for | 20 | Ic3 | 3 | 3 | 3 | 3 | 3 | 2 |
| know-how in | | | | 3 | 3 | | | |
| competence | | | | | | | | |
| Competence | 13 | Ic2 | | 2 | 2 | 2 | 2 | |
| development for | | | 2 | 3 | 3 | | | |
| project | | | | | | | | |
| management | | | | | | | | |
| Competence | 23 | Ic1 | | 2 | 2 | 3 | | 2 |
| development | | | 2 | 3 | 3 | 3 | | |
| methodologies | | | | | | | | |
| tools in BM | | | | | | | | |
| | | | Vc1 | Vc2 | Vc3 | Vc4 | | |
| | | | 6 | 19 | 17 | 9 | | |
| | | | Competence | Competence | Competence | Competence | | |
| | | | identification | structuring, | monitoring: | production | | |
| | | | and selection | devoloping & | quality & | | | |
| | | | | maintaining | requirements | | | |

| | | | 19 | 18 | 3 | 7 | 6 | | | |
|---|---|---|---|---|---|---|---|---|---|---|
| | | TOTAL | Ic3 | Ic4 | Ec1 | Ec2 | Ec3 | | | |
| Scala | | Ec3 | 1 | 1 | 1 | | | Ec3 | Competence for free- | 3 |
| Impact mic: 1 | | | | | | | | | distribution on the market | |
| Impact mediu: 2 | | Ec2 | 2 | 2 | 1 | | 1 | Ec2 | Competence in free- | 7 |
| Impact mare: 3 | | | | | | | | | distribution for customer | |
| | | Ec1 | 2 | 2 | | | | Ec1 | Develop competence for | 6 |
| | | | | | | | | | partnership | |
| Competitive | 19 | Ic4 | 3 | | | 2 | 2 | | | |
| advantage | | | | | | | | | | |
| competence | | | | | | | | | | |
| production | | | | | | | | | | |
| Conversion for | 20 | Ic3 | | 3 | | | | | | |
| know-how in | | | | | | | | | | |
| competence | | | | | | | | | | |
| Competence | 13 | Ic2 | 3 | 2 | | | | | | |
| development for | | | | | | | | | | |
| project | | | | | | | | | | |
| management | | | | | | | | | | |
| Competence | 23 | Ic1 | 3 | 2 | 3 | 3 | 2 | | | |
| development | | | | | | | | | | |
| methodologies | | | | | | | | | | |
| tools in BM | | | | | | | | | | |

TABLE 4a

| Value centers | Name |
|---|---|
| Competence | |
| production | |
| Vc1 | Competence identification and selection |
| Vc2 | Competence structuring, developing & maintaining |
| Vc3 | Competence monitoring: quality & requiements |
| Vc4 | Competence production |
| Internal | |
| competence | |
| production | |
| Ic1 | Competence development methodologies tools in BM |
| Ic2 | Competence development for Project Management |
| Ic3 | Conversion from know-how in competence |
| Ic4 | Competitive advantage competence production |
| External | |
| competence | |
| production | |
| Ec1 | Develop competence for partnership |
| Ec2 | Competence in free-distribution for customer |
| Ec3 | Competence for free-distribution on the market |
| SCORE | 1-10 |
| 1-4 | Low |
| 5-7 | Medium |
| 8-10 | High |

TABLE 4b

| | | Influence | |
|---|---|---|---|
| | | Value | |
| | | 3 - Strong | |
| | | 2 - Medium | |
| | | 1 - Low | Influence description |
| Ic1 | Vc1 | | no value added detected |
| | Vc2 | 2 | The development of methodologies, tools in BM determines the evaluation of new codes or the cancellation of others |
| | Vc3 | 2 | Analyzes the competence requirements for the different values production. It sets up the competence procurement model |
| | | | with timeframes, minimum competence “stock”, and the production risk |
| | Vc4 | 3 | Development of methodologies, tools in BM determines a better formalization of the competences production, |
| | | | starting with the analysis of learning demand up to courses structuring |
| | Ic1 | 0 | |
| | Ic2 | 2 | the development of methodologies, tools in BM includes rules and procedures regarding competence development for Project |
| | | | Management. |
| | Ic3 | 3 | the development of methodologies, tools in BM establishes certain rules regarding the conversion from know-how in |
| | | | competence. |
| | Ic4 | 2 | The competence development methodologies, tools in BM involves and maintains the competitive advantage |
| | | | competence production. |
| | Ec1 | 3 | the development of methodologies, tools in BM increases the ability of creating competences for a partnership, too |
| | Ec2 | 3 | part of the internal competences (methodologies, tools, procedures) could be distributed free of charge to customer |
| | Ec3 | 2 | part of the internal competences (methodologies, tools, procedures) could be distributed free of charge to the market |
| Ic2 | Vc1 | | no value added detected |
| | Vc2 | 2 | competence development for project management helps to link the competence to different production aspects for the |
| | | | different values |
| | Vc3 | 2 | a good competence for project management may monitor the competences in production regarding quality and requirements |
| | Vc4 | 2 | a good competence for project management may ensure the control over competence production and the synchronization with |
| | | | the requirements |
| | Ic1 | 2 | competence development for project management include the competence for developing methodologies and tools in BM |
| | Ic2 | 0 | |
| | Ic3 | 3 | a good project management allows, by means of its documents, the ensurance of the conversion from know-how into |
| | | | competence |
| | Ic4 | 2 | competence development for project management contributes to a competitive advantage of competence production |
| | Ec1 | | no value added detected |
| | Ec2 | | no value added detected |
| | Ec3 | | no value added detected |
| Ic3 | Vc1 | 3 | the conversion from know-how in competences permits the creation of a set of conative and cognitive profiles |
| | Vc2 | 3 | the conversion from know-how in competence determines the competences structuring in a competence coding system |

TABLE 4c

| | | Influence | |
|---|---|---|---|
| | | Value | |
| | | 3 - Strong | |
| | | 2 - Medium | |
| | | 1 - Low | Influence description |
| | Vc3 | 3 | know-how acquisition and its conversion in competence keeps under control the competence cognitive results, |
| | | | updates the conative profiles, analyzes the competence requirements for the different values production |
| | Vc4 | 3 | know-how conversion in competences leads to competence production |
| | Ic1 | 3 | the internal know-how materialized in methodologies, tools and procedures will be converted in competence |
| | Ic2 | 2 | the conversion from know-how in competence will be entirely found in project management competence |
| | Ic3 | 0 | |
| | Ic4 | 3 | the main element which ensures a competitive advantage on the market is the conversion from know-how in competence |
| | Ec1 | | no value added detected |
| | Ec2 | | no value added detected |
| | Ec3 | | no value added detected |
| Ic4 | Vc1 | | no value added detected |
| | Vc2 | 2 | The advantage competence production implies the competences analysis and the development of competences list which |
| | | | could influence the individuals' careers |
| | Vc3 | 3 | The advantage competence production influences the development of the performance indicators list, in order to keeps |
| | | | under control the cognitive results, to update the conative profile, to change the individual map |
| | Vc4 | 3 | Helps to analyze more efficiently the learning demand coming from internal, to promote and to encourage this |
| | Ic1 | 2 | It maintains this advantage |
| | Ic2 | 2 | It maintains this advantage |
| | Ic3 | 3 | It determins the formalization of any type of know-how in competences |
| | Ic4 | 0 | |
| | Ec1 | | no value added detected |
| | Ec2 | 2 | The competitive advantage allows the free distribution of competences to a customer |
| | Ec3 | 2 | The competitive advantage allows the free distribution of competences to the market |
| Ec1 | Vc1 | | no value added detected |
| | Vc2 | | no value added detected |
| | Vc3 | | no value added detected |
| | Vc4 | 2 | partnerships may influence the development of new competences |
| | Ic1 | 2 | developing competencies for partnership implies the development of new competencies for certain methodologies and |
| | | | tools in BM |
| | Ic2 | | no value added detected |
| | Ic3 | 2 | the existant know-how plus the acquired know-how from the partnership lead to a conversion into new competences |
| | Ic4 | 2 | the competitive advantage is not entirely determined by the development of competences for partnership |
| | Ec1 | 0 | |

TABLE 4d

| | | Influence | |
|---|---|---|---|
| | | Value | |
| | | 3 - Strong | |
| | | 2 - Medium | |
| | | 1 - Low | Influence description |
| | Ec2 | | no value added detected |
| | Ec3 | | no value added detected |
| Ec2 | Vc1 | | no value added detected |
| | Vc2 | | no value added detected |
| | Vc3 | | no value added detected |
| | Vc4 | | no value added detected |
| | Ic1 | 1 | it has a low impact |
| | Ic2 | | no value added detected |
| | Ic3 | 2 | competence in free-distribution for customer has an indirect influence upon the conversion from know-how in competence |
| | Ic4 | 2 | it may influence the customer in his/her decision |
| | Ec1 | 1 | it has a low influence |
| | Ec2 | 0 | |
| | Ec3 | 1 | a free-distribution of competences extends its area to the whole market |
| Ec3 | Vc1 | | no value added detected |
| | Vc2 | | no value added detected |
| | Vc3 | | no value added detected |
| | Vc4 | | no value added detected |
| | Ic1 | | no value added detected |
| | Ic2 | | no value added detected |
| | Ic3 | 1 | the impact of a free distribution of competences may consist in a know-how that may be further converted in competence |
| | Ic4 | 1 | it may influence the impact degree and thus representing a further stept in acquiring a competitive advantage on the market |
| | Ec1 | 1 | it has a low influence |
| | Ec2 | | no value added detected |
| | Ec3 | 0 | |
| Vc1 | Ic1 | 2 | it is an important phase in elaborating methodologies in BM competences |
| | Ic2 | 2 | competence identification and selection contributes to competence development for Project Management |
| | Ic3 | | no value added detected |
| | Ic4 | 2 | it contributes to the competitive advantage |
| | Ec1 | | no value added detected |
| | Ec2 | | no value added detected |
| | Ec3 | | no value added detected |

TABLE 4e

| | | Influence | |
|---|---|---|---|
| | | Value | |
| | | 3 - Strong | |
| | | 2 - Medium | |
| | | 1 - Low | Influence description |
| Vc2 | Ic1 | 3 | Competence structuring, developing and maintaining represent the basic elements of a methodology |
| | Ic2 | 3 | in order to develop competences for a project management one should know how to structure, develop and maintain them |
| | Ic3 | 3 | |
| | Ic4 | 3 | it is another key-factor which contributes to the competitive advantage |
| | Ec1 | 3 | the ability of developing competences in BM may lead to the creation of new competences for partnership, too |
| | Ec2 | 2 | it helps to decide which competence has to be distributed free in order to attract the customer |
| | Ec3 | 2 | it helps to decide which competence has to be distributed free in order to attract the market |
| Vc3 | Ic1 | 3 | it contributes to the elaboration of methodologies |
| | Ic2 | 3 | it represents a key element in competence development for Project Management |
| | Ic3 | 3 | the performance indicators contribute to the know-how acquisition |
| | Ic4 | 3 | it is defintely an important step for the acquiring a competitive advantage |
| | Ec1 | 3 | the performance indicators keep under control the competence cognitive results and analyse the competence requirements |
| | | | for the different values production |
| | Ec2 | 2 | it helps to decide which competence has to be distributed free in order to attract the customer |
| | Ec3 | | no value added detected |
| Vc4 | Ic1 | 3 | leads to the elaboration of competence development metodologies tools in BM |
| | Ic2 | | no value added detected |
| | Ic3 | | no value added detected |
| | Ic4 | 2 | competence production in general may not necessarily conclude with an advantage |
| | Ec1 | 2 | competence production in general may not necessarily imply the development of new competences for partnership but does |
| | | | not exclude this possibility, on the contrary, the experience in competence production is very useful |
| | Ec2 | 1 | it helps to decide which competence has to be distributed free in order to attract the customer |
| | Ec3 | 1 | it helps to decide which competence has to be distributed free in order to attract several customers |

TABLE 5
Interpretation:

| | Vc1 | N/A - 0 |
|---|---|---|
| Vc1 Competence | V1 | R |
| identification and | Vk1 | 0 |
| selection | Vp1 | 0 |

V1(Vc1) is the value contribution from Vc1 to V1 value centre
If different than 0, the contribution from one value centre to another is through an ACTION:
DIRECT (workflow in a process) - A V1(Vc1)
INDIRECT (potential) - when a “recepient” is needed R V1(Vc1)

TABLE 5a

| Partnership | Vp1 | | Vp2 | | Vp3 | | Vp4 | | Vp5 | | Vp6 | |
|---|---|---|---|---|---|---|---|---|---|---|---|---|
| Vp1 | Vp1 | | Vp2 | R | Vp3 | 0 | Vp4 | 0 | Vp5 | 0 | Vp6 | 0 |
| Identification of the leading | V1 | 0 | V2 | 0 | V3 | 0 | V4 | 0 | V5 | 0 | V6 | R |
| technology partners | Vk1 | 0 | Vk2 | 0 | Vk3 | 0 | Vk4 | 0 | Vk5 | 0 | Vk6 | 0 |
| | Vc1 | 0 | Vc2 | 0 | Vc3 | 0 | Vc4 | 0 | | | | |
| Vp2 | Vp1 | 0 | Vp2 | | Vp3 | A | Vp4 | A | Vp5 | A | Vp6 | R |
| Making partner contracts with | V1 | 0 | V2 | R | V3 | A | V4 | A | V5 | A | V6 | R |
| the industry “leaders” and “stars” | Vk1 | 0 | Vk2 | 0 | Vk3 | 0 | Vk4 | 0 | Vk5 | 0 | Vk6 | 0 |
| | Vc1 | 0 | Vc2 | 0 | Vc3 | 0 | Vc4 | A | | | | |
| Vp3 | Vp1 | 0 | Vp2 | 0 | Vp3 | | Vp4 | R | Vp5 | A | Vp6 | R |
| Packaging the partnership | V1 | A | V2 | R | V3 | R | V4 | R | V5 | R | V6 | R |
| product with our own added value | Vk1 | 0 | Vk2 | R | Vk3 | R | Vk4 | R | Vk5 | R | Vk6 | R |
| | Vc1 | 0 | Vc2 | A | Vc3 | R | Vc4 | R | | | | |
| Vp4 | Vp1 | 0 | Vp2 | 0 | Vp3 | R | Vp4 | | Vp5 | R | Vp6 | R |
| Business development in partnership | V1 | R | V2 | R | V3 | R | V4 | R | V5 | R | V6 | R |
| | Vk1 | R | Vk2 | R | Vk3 | R | Vk4 | R | Vk5 | R | Vk6 | R |
| | Vc1 | 0 | Vc2 | R | Vc3 | R | Vc4 | R | | | | |
| Vp5 | Vp1 | 0 | Vp2 | 0 | Vp3 | R | Vp4 | R | Vp5 | | Vp6 | R |
| Partner technology localization | V1 | 0 | V2 | R | V3 | R | V4 | R | V5 | R | V6 | R |
| | Vk1 | 0 | Vk2 | R | Vk3 | R | Vk4 | R | Vk5 | R | Vk6 | R |
| | Vc1 | 0 | Vc2 | R | Vc3 | R | Vc4 | R | | | | |
| Vp6 | Vp1 | 0 | Vp2 | 0 | Vp3 | R | Vp4 | R | Vp5 | 0 | Vp6 | |
| Competence building for the product | V1 | 0 | V2 | R | V3 | R | V4 | R | V5 | R | V6 | R |
| | Vk1 | R | Vk2 | 0 | Vk3 | R | Vk4 | R | Vk5 | 0 | Vk6 | 0 |
| | Vc1 | 0 | Vc2 | R | Vc3 | R | Vc4 | A | | | | |

| Partnership | | | | | | | | | Sum (Vp) | |
|---|---|---|---|---|---|---|---|---|---|---|
| Vp1 | | | | | | | | | Vp | 1X |
| Identification of the leading | | | | | | | | | V | 1X |
| technology partners | Vk7 | 0 | Vk8 | 0 | Vk9 | 0 | Vk10 | 0 | Vk | 0 |
| | | | | | | | | | Vc | 0 |
| Vp2 | | | | | | | | | Vp | 4X |
| Making partner contracts with | | | | | | | | | V | 5X |
| the industry “leaders” and “stars” | Vk7 | 0 | Vk8 | 0 | Vk9 | 0 | Vk10 | R | Vk | 1X |
| | | | | | | | | | Vc | 1X |
| Vp3 | | | | | | | | | Vp | 3X |
| Packaging the partnership | | | | | | | | | V | 6X |
| product with our own added value | Vk7 | R | Vk8 | R | Vk9 | R | Vk10 | 0 | Vk | 8X |
| | | | | | | | | | Vc | 3X |
| Vp4 | | | | | | | | | Vp | 3X |
| Business development in partnership | | | | | | | | | V | 6X |
| | Vk7 | R | Vk8 | R | Vk9 | R | Vk10 | R | Vk | 10X |
| | | | | | | | | | Vc | 3X |
| Vp5 | | | | | | | | | Vp | 3X |
| Partner technology localization | | | | | | | | | V | 5X |
| | Vk7 | R | Vk8 | R | Vk9 | R | Vk10 | 0 | Vk | 8X |
| | | | | | | | | | Vc | 3X |
| Vp6 | | | | | | | | | Vp | 2X |
| Competence building for the product | | | | | | | | | V | 5X |
| | Vk7 | R | Vk8 | R | Vk9 | R | Vk10 | 0 | Vk | 6X |
| | | | | | | | | | Vc | 3X |

TABLE 5b

| | |
|---|---|
| Vp1 (Vp1) | |
| RVp2 (Vp1) | some of technology partners identified will be subjects of future partnership contracts |
| Vp3 (Vp1) | No value contribution identified |
| Vp4 (Vp1) | No value contribution identified |
| Vp5 (Vp1) | No value contribution identified |
| Vp6 (Vp1) | No value contribution identified |
| V1 (Vp1) | No value contribution identified |
| V2 (Vp1) | No value contribution identified |
| V3 (Vp1) | No value contribution identified |
| V4 (Vp1) | No value contribution identified |
| V5 (Vp1) | No value contribution identified |
| RV6 (Vp1) | Vp1 may generate assets in sales&CRM |
| Vk1 (Vp1) | No value contribution identified |
| Vk2 (Vp1) | No value contribution identified |
| Vk3 (Vp1) | No value contribution identified |
| Vk4 (Vp1) | No value contribution identified |
| Vk5 (Vp1) | No value contribution identified |
| Vk6 (Vp1) | No value contribution identified |
| Vk7 (Vp1) | No value contribution identified |
| Vk8 (Vc1) | No value contribution identified |
| Vk9 (Vp1) | No value contribution identified |
| Vk10 (Vp1) | No value contribution identified |
| Vc1 (Vp1) | No value contribution identified |
| Vc2 (Vp1) | No value contribution identified |
| Vc3 (Vp1) | No value contribution identified |
| Vc4 (Vp1) | No value contribution identified |
| VP2 | |
| Vp1 (Vp2) | No value contribution identified |
| Vp2 (Vp2) | |
| AVp3 (Vp2) | determines partners specific added values |
| AVp4 (Vp2) | Vp2 is basis for business development |
| AVp5 (Vp2) | in some cases Vp2 may generate partner technology localization |
| RVp6 (Vp2) | Vp2 normally generates the need for competence building in partner technology |
| V1 (Vp2) | No value contribution identified |
| RV2 (Vp2) | making contracts with leading technology partners is a strength in pre-sales business |
| | capture and building of technical solution |
| AV3 (Vp2) | a signed contract allows the usage of partner technology in projects |
| AV4 (Vp2) | a signed contract allows the usage of partner technology in projects |
| AV5 (Vp2) | contract frames determines the existence and types of customer services |
| RV6 (Vp2) | making new contracts is an incetive for marketing/sales/CRM |
| Vk1 (Vp2) | No value contribution identified |
| Vk2 (Vp2) | No value contribution identified |
| Vk3 (Vp2) | No value contribution identified |
| Vk4 (Vp2) | No value contribution identified |
| Vk5 (Vp2) | No value contribution identified |
| Vk6 (Vp2) | No value contribution identified |
| Vk7 (Vp2) | No value contribution identified |
| Vk8 (Vc2) | No value contribution identified |
| Vk9 (Vp2) | No value contribution identified |
| RVk10 (Vp2) | Vp2 gives know-how for Vk10 |
| Vc1 (Vp2) | No value contribution identified |
| Vc2 (Vp2) | No value contribution identified |
| Vc3 (Vp2) | No value contribution identified |
| AVc4 (Vp2) | formalised training to assimilate partner technology |
| Vp3 | |
| Vp1 (Vp3) | No value contribution identified |
| Vp2 (Vp3) | No value contribution identified |

TABLE 5c

| | |
|---|---|
| Vp3 (Vp3) | |
| RVp4 (Vp3) | packaging the partners added value may develop the partnership |
| AVp5 (Vp3) | partner technology localization could be a part of package offer |
| RVp6 (Vp3) | packaging the partnership product may increase the competencies |
| V1 (Vp3) | No value contribution identified |
| AV2 (Vp3) | the partnership package may be a part in pre-sales business capturing and technical solution |
| RV3 (Vp3) | the partnership package has to be followed in the project execution |
| RV4 (Vp3) | the partnership package has to be followed in the project execution |
| RV5 (Vp3) | the partnership package may impact the customer services |
| Rv6 (Vp3) | the partnership package may impact with marketing/sales/CRM |
| Vk1 (Vp3) | No value contribution identified |
| RVk2 (Vp3) | the product and value added packaging increases knowhow in usage of advanced metods for project |
| RVk3 (Vp3) | the partnership package is build in order to optain a competitive price/quality execution |
| RVk4 (Vp3) | the product and value added packaging increases knowhow in usage of advanced metods for project |
| RVk5 (Vp3) | the product and value added packaging increases knowhow |
| RVk6 (Vp3) | the product and value added packaging increases knowhow |
| RVk7 (Vp3) | the product and value added packaging increases knowhow |
| RVk8 (Vp3) | the product and value added packaging increases knowhow |
| RVk9 (Vp3) | the product and value added packaging increases knowhow |
| RVk10 (Vp3) | No value contribution identified |
| Vc1 (Vp3) | No value contribution identified |
| AVc2 (Vp3) | determines the need of additional competencies |
| RVc3 (Vp3) | might determine the need of additional competencies |
| RVc4 (Vp3) | might determine the need of additional competencies |
| Vp4 | |
| Vp1 (Vp4) | No value contribution identified |
| Vp2 (Vp4) | No value contribution identified |
| RVp3 (Vp4) | business development in partnership leads to value added package building |
| Vp4 (Vp4) | |
| RVp5 (Vp4) | business development in partnership may determines the need for localization |
| RVp6 (Vp4) | business development in partnership may determines product competence building |
| RV1 (Vp4) | business development in partnership provides input |
| RV2 (Vp4) | business development in partnership optimize the pre-sales effort and the building of the technical solution |
| RV3 (Vp4) | business development in partnership could benefit to the project execution |
| RV4 (Vp4) | business development in partnership could benefit |
| RV5 (Vp4) | business development in partnership increase the customer services level |
| RV6 (Vp4) | business development in partnership helps in the sales process |
| RVk1 (Vp4) | positive impact |
| RVk2 (Vp4) | positive impact |
| RVk3 (Vp4) | positive impact |
| RVk4 (Vp4) | positive impact |
| RVk5 (Vp4) | positive impact |
| RVk6 (Vp4) | positive impact |
| RVk7 (Vp4) | positive impact |
| RVk8 (Vp4) | positive impact |
| RVk9 (Vp4) | positive impact |
| RVk10 (Vp4) | positive impact |
| Vc1 (Vp4) | No value contribution identified |
| RVc2 (Vp4) | business development in parnership may determine the need for additional competencies |
| RVc3 (Vp4) | business development in parnership may determine the need for additional competencies |
| RVc4 (Vp4) | business development in parnership may determine the need for additional competencies |
| Vp5 | |
| Vp1 (Vp5) | No value contribution identified |
| Vp2 (Vp5) | No value contribution identified |
| RVp3 (Vp5) | the localization may be part of the added value package |
| RVp4 (Vp5) | packaging the partners added value may develop the partnership |

TABLE 5d

| | |
|---|---|
| Vp5 (Vp5) | |
| RVp6 (Vp5) | packaging the partnership product may increase the competencies |
| V1 (Vp5) | No value contribution identified |
| RV2 (Vp5) | the localization of the partner technology may be an asset in pre-sales business capturing and technical solution |
| RV3 (Vp5) | the localization of the partner technology may be part in the project execution |
| RV4 (Vp5) | the localization of the partner technology may be a part in go-live |
| RV5 (Vp5) | the localization of the partner technology may Impact the customer services |
| RV6 (Vp5) | the localization is an asset in marketing/sales/CRM |
| Vk1 (Vp5) | No value contribution identified |
| RVk2 (Vp5) | the localization of a partner technology may increase the know how |
| RVk3 (Vp5) | the localization of a partner technology may increase the know how |
| RVk4 (Vp5) | the localization of a partner technology may increase the know how |
| RVk5 (Vp5) | the localization of a partner technology may increase the know how |
| RVk6 (Vp5) | the localization of a partner technology may increase the know how |
| RVk7 (Vp5) | the localization of a partner technology may increase the know how |
| RVk8 (Vc5) | the localization of a partner technology may increase the know how |
| RVk9 (Vp5) | the localization of a partner technology may increase the know how |
| Vk10 (Vp5) | No value contribution identified |
| Vc1 (Vp5) | No value contribution identified |
| RVc2 (Vp5) | determines the need of additional competencies |
| RVc3 (Vp5) | might determine the need of additional competencies |
| RVc4 (Vp5) | might determine the need of additional competencies |
| Vp6 | |
| Vp1 (Vp6) | No value contribution identified |
| RVp2 (Vp6) | input for specifying in contracts different product competence buiding aspects |
| RVp3 (Vp6) | the level of product competence increase added value package |
| RVp4 (Vp6) | the level of product competence increase business development |
| RVp5 (Vp6) | the level of product competence increase the need product localization |
| Vp6 (Vp6) | |
| V1 (Vp6) | No value contribution identified |
| RV2 (Vp6) | business capture and technical solution will be more efficient if a product competence was build |
| RV3 (Vp6) | project execution is better in case of existing product competence |
| RV4 (Vp6) | project execution is better in case of existing product competence |
| RV5 (Vp6) | customer servies level are based on product competence building |
| Rv6 (Vp6) | product competence increase the sales |
| RVk1 (Vp6) | project management knowhow is inforced by the product competence |
| Vk2 (Vp6) | No value contribution identified |
| RVk3 (Vp6) | price/quality project execution is leveradge by product competence |
| RVk4 (Vp6) | product competence increase abillty for business capture |
| Vk5 (Vp6) | No value contribution identified |
| Vk6 (Vp6) | No value contribution identified |
| RVk7 (Vp6) | localization is fasten by product competence building |
| RVk8 (Vc6) | influences |
| RVk9 (Vp6) | influences |
| Vk10 (Vp6) | No value contribution identified |
| Vc1 (Vp6) | No value contribution identified |
| RVc2 (Vp6) | the product competence have to be structured |
| RVc3 (Vp6) | the product competence must be monitoried |
| AVc4 (Vp6) | may require the competence production |

TABLE 5e

| Know how | Vk1 | | Vk2 | | Vk3 | | Vk4 | | Vk5 | | Vk6 | |
|---|---|---|---|---|---|---|---|---|---|---|---|---|
| Vk1 | Vk1 | | Vk2 | A | Vk3 | A | Vk4 | 0 | Vk5 | 0 | Vk6 | R |
| Project Management | Vp1 | 0 | Vp2 | 0 | Vp3 | 0 | Vp4 | R | Vp5 | 0 | Vp6 | 0 |
| Knowhow | Vc1 | 0 | Vc2 | 0 | Vc3 | R | Vc4 | R | | | | |
| | V1 | A | V2 | R | V3 | A | V4 | A | V5 | 0 | V6 | R |
| Vk2 | Vk1 | R | Vk2 | | Vk3 | R | Vk4 | R | Vk5 | R | Vk6 | R |
| Usage of advanced | Vp1 | 0 | Vp2 | 0 | Vp3 | R | Vp4 | R | Vp5 | R | Vp6 | R |
| methods for project | Vc1 | 0 | Vc2 | 0 | Vc3 | R | Vc4 | A | | | | |
| execution | V1 | R | V2 | 0 | V3 | R | V4 | R | V5 | 0 | R | |
| Vk3 | Vk1 | 0 | Vk2 | R | Vk3 | | Vk4 | A | Vk5 | A | Vk6 | A |
| Competitive | Vp1 | 0 | Vp2 | 0 | Vp3 | A | Vp4 | R | Vp5 | A | Vp6 | R |
| price/quality project | Vc1 | 0 | Vc2 | 0 | Vc3 | 0 | Vc4 | R | | 0 | | |
| execution | V1 | A | V2 | 0 | V3 | A | V4 | A | V5 | 0 | V6 | R |
| Vk4 | Vk1 | 0 | Vk2 | 0 | Vk3 | R | Vk4 | | Vk5 | 0 | Vk6 | R |
| Business capture and | Vp1 | 0 | Vp2 | R | Vp3 | R | Vp4 | R | Vp5 | 0 | Vp6 | 0 |
| modelling | Vc1 | O | Vc2 | O | Vc3 | O | Vc4 | R | | | | |
| | V1 | 0 | V2 | A | V3 | 0 | V4 | 0 | V5 | 0 | V6 | R |
| Vk5 | Vk1 | 0 | Vk2 | 0 | Vk3 | R | Vk4 | 0 | Vk5 | 0 | Vk6 | R |
| Specific programming | Vp1 | 0 | Vp2 | 0 | Vp3 | 0 | Vp4 | R | Vp5 | A | Vp6 | 0 |
| ABAP, HTML, JAVA | Vc1 | 0 | Vc2 | 0 | Vc3 | 0 | Vc4 | R | | | | |
| | V1 | 0 | V2 | R | V3 | A | V4 | 0 | V5 | R | V6 | R |
| Vk6 | Vk1 | | Vk2 | | Vk3 | | Vk4 | | Vk5 | | Vk6 | |
| Go-live procedure & | Vp1 | | Vp2 | | Vp3 | | Vp4 | | Vp5 | | Vp6 | |
| production assitance | Vc1 | | Vc2 | | Vc3 | | Vc4 | | | | | |
| | V1 | | V2 | | V3 | | V4 | | V5 | | V6 | |
| Vk7 | Vk1 | | Vk2 | | Vk3 | | Vk4 | | Vk5 | | Vk6 | |
| Product localization | Vp1 | | Vp2 | | Vp3 | | Vp4 | | Vp5 | | Vp6 | |
| | Vc1 | | Vc2 | | Vc3 | | Vc4 | | | | | |
| | V1 | | V2 | | V3 | | V4 | | V5 | | V6 | |
| Vk8 | Vk1 | | Vk2 | | Vk3 | | Vk4 | | Vk5 | | Vk6 | |
| Infrastructure modelling | Vp1 | | Vp2 | | Vp3 | | Vp4 | | Vp5 | | Vp6 | |
| | Vc1 | | Vc2 | | Vc3 | | Vc4 | | | | | |
| | V1 | | V2 | | V3 | | V4 | | V5 | | V6 | |
| Vk9 | Vk1 | | Vk2 | | Vk3 | | Vk4 | | Vk5 | | Vk6 | |
| Business Intelligence | Vp1 | | Vp2 | | Vp3 | | Vp4 | | Vp5 | | Vp6 | |
| | Vc1 | | Vc2 | | Vc3 | | Vc4 | | | | | |
| | V1 | | V2 | | V3 | | V4 | | V5 | | V6 | |
| Vk10 | Vk1 | | Vk2 | | Vk3 | | Vk4 | | Vk5 | | Vk6 | |
| Customer service and | Vp1 | | Vp2 | | Vp3 | | Vp4 | | Vp5 | | Vp6 | |
| education | Vc1 | | Vc2 | | Vc3 | | Vc4 | | | | | |
| | V1 | | V2 | | V3 | | V4 | | V5 | | V6 | |

| Know how | Vk7 | | Vk8 | | Vk9 | | Vk10 | | Sum (Vk) | |
|---|---|---|---|---|---|---|---|---|---|---|
| Vk1 | Vk7 | R | Vk8 | R | Vk9 | R | Vk10 | R | Vk | 7X |
| Project Management | | | | | | | | | Vp | 1X |
| Knowhow | | | | | | | | | Vc | 2X |
| | | | | | | | | | V | 5X |
| Vk2 | Vk7 | R | Vk8 | R | Vk9 | R | Vk10 | 0 | Vk | 8X |
| Usage of advanced | | | | | | | | | Vp | 4X |
| methods for project | | | | | | | | | Vc | 2X |
| execution | | | | | | | | | V | 4X |
| Vk3 | Vk7 | A | Vk8 | A | Vk9 | A | Vk10 | 0 | Vk | 7X |
| Competitive | | | | | | | | | Vp | 4X |
| price/quality project | | | | | | | | | Vc | 1X |
| execution | | | | | | | | | V | 4X |
| Vk4 | Vk7 | R | Vk8 | R | Vk9 | R | Vk10 | R | Vk | 6X |
| Business capture and | | | | | | | | | Vp | 3X |
| modelling | | | | | | | | | Vc | 1X |
| | | | | | | | | | V | 2X |
| Vk5 | Vk7 | A | Vk8 | 0 | Vk9 | A | Vk10 | O | Vk | 4X |
| Specific programming | | | | | | | | | Vp | 2X |
| ABAP, HTML, JAVA | | | | | | | | | Vc | 1X |
| | | | | | | | | | V | 4X |
| Vk6 | Vk7 | | Vk8 | | Vk9 | | Vk10 | | Vk | |
| Go-live procedure & | | | | | | | | | Vp | |
| production assitance | | | | | | | | | Vc | |
| | | | | | | | | | V | |
| Vk7 | | | Vk8 | | Vk9 | | Vk10 | | Vk | |
| Product localization | | | | | | | | | Vp | |
| | | | | | | | | | Vc | |
| | | | | | | | | | V | |
| Vk8 | Vk7 | | Vk8 | | Vk9 | | Vk10 | | Vk | |
| Infrastructure modelling | | | | | | | | | Vp | |
| | | | | | | | | | Vc | |
| | | | | | | | | | V | |
| Vk9 | Vk7 | | Vk8 | | Vk9 | | Vk10 | | Vk | |
| Business Intelligence | | | | | | | | | Vp | |
| | | | | | | | | | Vc | |
| | | | | | | | | | V | |
| Vk10 | Vk7 | | Vk8 | | Vk9 | | Vk10 | | Vk | |
| Customer service and | | | | | | | | | Vp | |
| education | | | | | | | | | Vc | |
| | | | | | | | | | V | |

TABLE 5f
KNOW HOW

| | |
|---|---|
| Vk1 (Vk1) | |
| AVk2 (Vk1) | project management knowhow includes usage of advance methods |
| AVk3 (Vk1) | the objective of project management knowhow is to optain a competitive price at the same quality |
| Vk4 (Vk1) | No significant value contribution |
| Vk5 (Vk1) | No significant value contribution |
| RVk6 (Vk1) | project management knowhow helps in a smooth go-live |
| RVk7 (Vk1) | localization as a project may benefit from project management know how |
| RVk8 (Vk1) | provides feedback |
| RVk9 (Vk1) | provides feedback |
| RVk10 (Vk1) | project management knowhow its an asset for customer services |
| Vp1 (Vk1) | No significant value contribution |
| Vp2 (Vk1) | No significant value contribution |
| Vp3 (Vk1) | No significant value contribution |
| RVp4 (Vk1) | provides input |
| Vp5 (Vk1) | No significant value contribution |
| Vp6 (Vk1) | No significant value contribution |
| Vc1 (Vk1) | No significant value contribution |
| Vc2 (Vk1) | No significant value contribution |
| RVc3 (Vk1) | evaluation of the competencies by the project leader |
| RVc4 (Vk1) | the project metodology is included in the competence production |
| AV1 (Vk1) | project management knowhow is used in project management |
| RV2 (Vk1) | sometimes pre-sales activity might be assimilated to small projects |
| AV3 (Vk1) | project execution is done based on project management knowhow |
| AV4 (Vk1) | go-live is done based on PM knowhow |
| V5 (Vk1) | No significant value contribution |
| RV6 (Vk1) | provide references |
| Vk2 | |
| RVk1 (Vk2) | provides feedback |
| Vk2 (Vk2) | |
| RVk3 (Vk2) | the objective of advanced methods is to optain a competitive price at the same quality |
| RVk4 (Vk2) | the objective of advanced methods facilited business capturing |
| RVk5 (Vk2) | the objective of advanced methods facilited specific programming |
| RVk6 (Vk2) | the objective of advanced methods facilited go-live procedures |
| RVk7 (Vk2) | the objective of advanced methods facilited product localization |
| RVk8 (Vk2) | the objective of advanced methods facilited infrastructure modelling |
| RVk9 (Vk2) | the objective of advanced methods facilited business intelligence know-how production |
| Vk10 (Vk2) | No significant value contribution |
| Vp1 (Vk2) | No significant value contribution |
| Vp2 (Vk2) | No significant value contribution |
| RVp3 (Vk2) | The advanced methodes could be part of the partnership package |
| RVp4 (Vk2) | The advanced methodes usage contribues to business development partnership |
| RVp5 (Vk2) | The advanced methodes could be part of partner technology localization |
| RVp6 (Vk2) | The advanced methodes usage contribues to build competence for product |
| Vc1 (Vk2) | No significant value contribution |
| Vc2 (Vk2) | No significant value contribution |
| RVc3 (Vk2) | Usage of advanced methods determines competence monitoring |
| AVc4 (Vk2) | Usage of advanced methods determines competence production |
| RV1 (Vk2) | Provides feedback |
| V2 (Vk2) | No significant value contribution |
| RV3 (Vk2) | Advanced methods could be used in project execution |
| RV4 (Vk2) | Advanced methods could be used in go-live |
| V5 (Vk2) | No significant value contribution |
| RV6 (Vk2) | Advanced methods for project execution could be used as references in marketing/sales |

TABLE 5g
KNOW HOW

| | |
|---|---|
| Vk3 | |
| Vk1 (Vk3) | No significant value contribution |
| RVk2 (Vk3) | Competitive price requires the advanced methods |
| Vk3 (Vk3) | |
| AVk4 (Vk3) | Competitive price asks for business capture and modelling know how improvement |
| AVk5 (Vk3) | Competitive price asks for specific programming know how improvement |
| AVk6 (Vk3) | Competitive price asks for go-live know how improvement |
| AVk7 (Vk3) | Competitive price asks for product localization know how improvment |
| AVk8 (Vk3) | Competitive price asks for infrastructure modelling know how improvement |
| AVk9 (Vk3) | Competitive price asks for business inteligence know how improvement |
| Vk10 (Vk3) | No significant value contribution |
| Vp1 (Vk3) | No significant value contribution |
| Vp2 (Vk3) | No significant value contribution |
| AVp3 (Vk3) | competitive price requires determines the optim packaging solution |
| RVp4 (Vk3) | project quality contributes to business development in partnership |
| AVp5 (Vk3) | project price/quality contributes to localization |
| RVp6 (Vk3) | project quality contributes to build competence for the product |
| Vc1 (Vk3) | No significant value contribution |
| Vc2 (Vk3) | No significant value contribution |
| RVc3 (Vk3) | the need for competitive price/quality execution determines quality competence monitoring |
| Vc4 (Vk3) | No significant value contribution |
| AV1 (Vk3) | competitive price is a constraint for project management |
| V2 (Vk3) | No significant value contribution |
| AV3 (Vk3) | competitive price is a constraint for project execution |
| AV4 (Vk3) | competitive price is a constraint for project execution |
| V5 (Vk3) | No significant value contribution |
| RV6 (Vk3) | reference in marketing/sales/CRM |
| Vk4 | |
| Vk1 (Vk4) | No significant value contribution |
| Vk2 (Vk4) | No significant value contribution |
| RVk3 (Vk4) | a good business capture diminish the risk and the margin |
| Vk4 (Vk4) | |
| RVk5 (Vk4) | business capturing knowhow may identify the specific programming requirements |
| RVk6 (Vk4) | business capturing knowhow may diminish the risk |
| RVk7 (Vk4) | business capturing knowhow may diminish the risk |
| RVk8 (Vk4) | business capturing knowhow may identify the Infrastructure modelling requirements |
| RVk9 (Vk4) | business capturing knowhow may identify the business Intelligence requirements |
| RVk10 (Vk4) | No significant value contribution |
| Vp1 (Vk4) | No significant value contribution |
| RVp2 (Vk4) | represents an asset in making partner contract process |
| RVp3 (Vk4) | represents an asset |
| RVp4 (Vk4) | some of them |
| Vp5 (Vk4) | No significant value contribution |
| Vp6 (Vk4) | No significant value contribution |
| Vc1 (Vk4) | No significant value contribution |
| Vc2 (Vk4) | No significant value contribution |
| Vc3 (Vk4) | No significant value contribution |
| RVc4 (Vk4) | only in case of business modelling trainning |
| V1 (Vk4) | No significant value contribution |
| AV2 (Vk4) | business capturing knowhow helps in pre-sales business capturing |
| V3 (Vk4) | No significant value contribution |
| V4 (Vk4) | No significant value contribution |
| V5 (Vk4) | No significant value contribution |
| RV6 (Vk4) | business capturing knowhow influences (gives the dimmension) the commercial & technical solution in sales |

TABLE 5h
KNOW HOW

| | |
|---|---|
| Vk5 | |
| Vk1 (Vk5) | No significant value contribution |
| Vk2 (Vk5) | No significant value contribution |
| RVk3 (Vk5) | specific programming knowhow determines competitive price/quality project execution |
| Vk4 (Vk5) | No significant value contribution |
| Vk5 (Vk5) | |
| RVk6 (Vk5) | specific programming knowhow has impact on go-live knowhow |
| AVk7 (Vk5) | specific programming knowhow it is a part of product localization |
| Vk8 (Vk5) | No significant value contribution |
| AVk9 (Vk5) | specific programming knowhow is part of business intelligence knowhow |
| Vk10 (Vk5) | No significant value contribution |
| Vp1 (Vk5) | No significant value contribution |
| Vp2 (Vk5) | No significant value contribution |
| Vp3 (Vk5) | No significant value contribution |
| RVp4 (Vk5) | contributes to business development in partnership |
| AVp5 (Vk5) | specific programming it is a part of the localization |
| Vp6 (Vk5) | No significant value contribution |
| Vc1 (Vk5) | No significant value contribution |
| Vc2 (Vk5) | No significant value contribution |
| Vc3 (Vk5) | No significant value contribution |
| RVc4 (Vk5) | specific programming knowhow must be formalized in training |
| V1 (Vk5) | No significant value contribution |
| RV2 (Vk5) | specific programming helps |
| AV3 (Vk5) | specific programming knowhow fasten project execution |
| V4 (Vk5) | No significant value contribution |
| RV5 (Vk5) | specific programming knowhow helps to solve customer complaints |
| RV6 (Vk5) | it is an asset |
| Vk6 | |
| Vk1 (Vk6) | |
| Vk2 (Vk6) | |
| Vk3 (Vk6) | |
| Vk4 (Vk6) | |
| Vk5 (Vk6) | |
| Vk6 (Vk6) | |
| Vk7 (Vk6) | |
| Vk8 (Vk6) | |
| Vk9 (Vk6) | |
| Vk10 (Vk6) | |
| Vp1 (Vk6) | |
| Vp2 (Vk6) | |
| Vp3 (Vk6) | |
| Vp4 (Vk6) | |
| Vp5 (Vk6) | |
| Vp6 (Vk6) | |
| Vc1 (Vk6) | |
| Vc2 (Vk6) | |
| Vc3 (Vk6) | |
| Vc4 (Vk6) | |
| V1 (Vk6) | |
| V2 (Vk6) | |
| V3 (Vk6) | |
| V4 (Vk6) | |
| V5 (Vk6) | |
| V6 (Vk6) | |

TABLE 5i
Vk7

Vk1 (Vk7)
Vk2 (Vk7)
Vk3 (Vk7)
Vk4 (Vk7)
Vk5 (Vk7)
Vk6 (Vk7)
Vk7 (Vk7)
Vk8 (Vk7)
Vk9 (Vk7)
Vk10 (Vk7)
Vp1 (Vk7)
Vp2 (Vk7)
Vp3 (Vk7)
Vp4 (Vk7)
Vp5 (Vk7)
Vp6 (Vk7)
Vc1 (Vk7)
Vc2 (Vk7)
Vc3 (Vk7)
Vc4 (Vk7)
V1 (Vk7)
V2 (Vk7)
V3 (Vk7)
V4 (Vk7)
V5 (Vk7)
V6 (Vk7)

TABLE 5j
COMPETENCE

| Competence | Vc1 | | Vc2 | | Vc3 | | Vc4 | | | | | | | | | | | | | | Sum (Vc) | |
|---|---|---|---|---|---|---|---|---|---|---|---|---|---|---|---|---|---|---|---|---|---|---|
| Vc1 | Vc1 | | Vc2 | A | Vc3 | R | Vc4 | R | | | | | | | | | | | | | Vc | 3X |
| Competence | V1 | R | V2 | 0 | V3 | R | V4 | R | V5 | 0 | V6 | R | | | | | | | | | V | 4X |
| identification | Vk1 | 0 | Vk2 | 0 | Vk3 | 0 | Vk4 | 0 | Vk5 | 0 | Vk6 | 0 | Vk7 | 0 | Vk8 | 0 | Vk9 | 0 | Vk10 | 0 | Vk | 0 |
| and selection | Vp1 | 0 | Vp2 | 0 | Vp3 | 0 | Vp4 | 0 | Vp5 | 0 | Vp6 | 0 | | | | | | | | | Vp | 0 |
| Vc2 Competence | Vc1 | R | Vc2 | | Vc3 | A | Vc4 | R | | | | | | | | | | | | | Vc | 3X |
| structuring, | V1 | R | V2 | R | V3 | R | V4 | R | V5 | 0 | V6 | R | | | | | | | | | V | 5X |
| developing & | Vk1 | 0 | Vk2 | 0 | Vk3 | 0 | Vk4 | 0 | Vk5 | 0 | Vk6 | 0 | Vk7 | 0 | Vk8 | 0 | Vk9 | 0 | Vk10 | 0 | Vk | 0 |
| maintaining | Vp1 | 0 | Vp2 | 0 | Vp3 | R | Vp4 | R | Vp5 | R | Vp6 | R | | | | | | | | | Vp | 4X |
| Vc3 Competence | Vc1 | A | Vc2 | 0 | Vc3 | | Vc4 | A | | | | | | | | | | | | | Vc | 2X |
| monitoring: | V1 | R | V2 | R | V3 | R | V4 | R | V5 | 0 | V6 | 0 | | | | | | | | | V | 4X |
| quality & | Vk1 | 0 | Vk2 | 0 | Vk3 | 0 | Vk4 | 0 | Vk5 | 0 | Vk6 | 0 | Vk7 | 0 | Vk8 | 0 | Vk9 | 0 | Vk10 | 0 | Vk | 0 |
| requirements | Vp1 | 0 | Vp2 | A | Vp3 | R | Vp4 | R | Vp5 | R | Vp6 | R | | | | | | | | | Vp | 5X |
| Vc4 | Vc1 | 0 | Vc2 | R | Vc3 | R | Vc4 | | | | | | | | | | | | | | Vc | 2X |
| Competence | V1 | R | V2 | R | V3 | R | V4 | R | V5 | 0 | V6 | R | | | | | | | | | V | 5X |
| production | Vk1 | 0 | Vk2 | 0 | Vk3 | 0 | Vk4 | 0 | Vk5 | 0 | Vk6 | 0 | Vk7 | 0 | Vk8 | 0 | Vk9 | 0 | Vk10 | 0 | Vk | 0 |
| | Vp1 | 0 | Vp2 | 0 | Vp3 | R | Vp4 | R | Vp5 | R | Vp6 | 0 | | | | | | | | | Vp | 3X |

| Vc1 (Vc1) | |
|---|---|
| AVc2 (Vc1) | prerequisite |
| AVc3 (Vc1) | provides input |
| RVc4 (Vc1) | part of competences selected could be trainned |
| RV1 (Vc1) | selected competencies could be used in project management |
| V2 (Vc1) | No value contribution identified |
| RV3 (Vc1) | selected competencies could be used in project execution |
| RV4 (Vc1) | selected competencies could be used in go-live |
| V5 (Vc1) | No value contribution identified |
| RV6 (Vc1) | provides input |
| Vk1 (Vc1) | No value contribution identified |
| Vk2 (Vc1) | No value contribution identified |
| Vk3 (Vc1) | No value contribution identified |
| Vk4 (Vc1) | No value contribution identified |
| Vk5 (Vc1) | No value contribution identified |
| Vk6 (Vc1) | No value contribution identified |
| Vk7 (Vc1) | No value contribution identified |
| Vk8 (Vc1) | No value contribution identified |
| Vk9 (Vc1) | No value contribution identified |
| Vk10 (Vc1) | No value contribution identified |

TABLE 5k
COMPETENCE

| | |
|---|---|
| Vp1 (Vc1) | No value contribution identified |
| Vp2 (Vc1) | No value contribution identified |
| Vp3 (Vc1) | No value contribution identified |
| Vp4 (Vc1) | No value contribution identified |
| Vp5 (Vc1) | No value contribution identified |
| Vp6 (Vc1) | No value contribution identified |
| RVc1 (Vc2) | determines the need for additional competencies |
| Vc2 (Vc2) | |
| AVc3 (Vc2) | the structured competencies have to be continuous monitored |
| RVc4 (Vc2) | competence monitoring provides input for competence production |
| RV1 (Vc2) | project management is easier through the process of competence structuring |
| RV2 (Vc2) | competence structuring, developing & maintaining links the competencies to different production aspects |
| RV3 (Vc2) | competence structuring, developing & maintaining links the competencies to different production aspects |
| RV4 (Vc2) | competence structuring, developing & maintaining links the competencies to different production aspects |
| V5 (Vc2) | No value contribution identified |
| RV6 (Vc2) | competence structuring, developing & maintaining links the competencies to different commercial aspects |
| Vk1 (Vc2) | No value contribution identified |
| Vk2 (Vc2) | No value contribution identified |
| Vk3 (Vc2) | No value contribution identified |
| Vk4 (Vc2) | No value contribution identified |
| Vk5 (Vc2) | No value contribution identified |
| Vk6 (Vc2) | No value contribution identified |
| Vk7 (Vc2) | No value contribution identified |
| Vk8 (Vc2) | No value contribution identified |
| Vk9 (Vc2) | No value contribution identified |
| Vk10 (Vc2) | No value contribution identified |
| Vp1 (Vc2) | No value contribution identified |
| Vp2 (Vc2) | No value contribution identified |
| RVp3 (Vc2) | own developed competencies are part of the partnership package |
| RVp4 (Vc2) | own competencies influences the partnership development |
| RVp5 (Vc2) | own developed competencies are part of the localizing of the partner technology |
| RVp6 (Vc2) | own competencies influences the partnership development |
| AVc1 (Vc3) | quality/requirement monitoring provides the list of necessary competencies |
| AVc2 (Vc3) | Vc3 provides the input for developing and mantaining |
| Vc3 (Vc3) | |

TABLE 5l
COMPETENCE

| | |
|---|---|
| AVc4 (Vc3) | provides input |
| RV1 (Vc3) | competencies quality determines the election of a project leader |
| RV2 (Vc3) | competencies quality influences the pre-sales business capture and the tehnical solution |
| RV3 (Vc3) | competencies quality determines the project execution |
| RV4 (Vc3) | competencies quality determines the project execution |
| V5 (Vc3) | No value contribution identified |
| V6 (Vc3) | competencies quality determines the marketing and sales |
| Vk1 (Vc3) | No value contribution identified |
| Vk2 (Vc3) | No value contribution identified |
| Vk3 (Vc3) | No value contribution identified |
| Vk4 (Vc3) | No value contribution identified |
| Vk5 (Vc3) | No value contribution identified |
| Vk6 (Vc3) | No value contribution identified |
| Vk7 (Vc3) | No value contribution identified |
| Vk8 (Vc3) | No value contribution identified |
| Vk9 (Vc3) | No value contribution identified |
| Vk10 (Vc3) | No value contribution identified |
| Vp1 (Vc3) | No value contribution identified |
| AVp2 (Vc3) | need for additional competencies might materialize in partnership contracts |
| RVp3 (Vc3) | own competencies are part of the partnership package |
| RVp4 (Vc3) | own competencies influences the partnership development |
| RVp5 (Vc3) | own competencies are part of the localizing of the partner technology |
| RVp6 (Vc3) | own competencies influences the partnership development |
| Vc1 (Vc4) | No value contribution identified |
| RVc2 (Vc4) | provides feedback |
| RVc3 (Vc4) | provides feedback |
| Vc4 (Vc4) | No value contribution identified |
| RV1 (Vc4) | competencies production increases the pool of company competencies |
| RV2 (Vc4) | competencies production increases the pool of company competencies |
| RV3 (Vc4) | competencies production increases the pool of company competencies |
| RV4 (Vc4) | competencies production increases the pool of company competencies |
| V5 (Vc4) | No value contribution identified |
| RV6 (Vc4) | competencies production increases the pool of company competencies |
| Vk1 (Vc4) | No value contribution identified |
| Vk2 (Vc4) | No value contribution identified |
| Vk3 (Vc4) | No value contribution identified |
| Vk4 (Vc4) | No value contribution identified |

TABLE 5m
COMPETENCE

| | |
|---|---|
| Vk5 (Vc4) | No value contribution identified |
| Vk6 (Vc4) | No value contribution identified |
| Vk7 (Vc4) | No value contribution identified |
| Vk8 (Vc4) | No value contribution identified |
| Vk9 (Vc4) | No value contribution identified |
| Vk10 (Vc4) | No value contribution identified |
| Vp1 (Vc4) | No value contribution identified |
| Vp2 (Vc4) | No value contribution identified |
| RVp3 (Vc4) | competencies production inputs |
| | the partnership package |
| RVp4 (Vc4) | competencies production benefits |
| | partnership development |
| RVp5 (Vc4) | competencies production influences |
| | localizing of the partner technology |
| Vp6 (Vc4) | No value contribution identified |

TABLE 5n
PRODUCTION

| Product | V1 | | V2 | | V3 | | V4 | | V5 | | V6 | | | | | | | | | | Sum (V) | |
|---|---|---|---|---|---|---|---|---|---|---|---|---|---|---|---|---|---|---|---|---|---|---|
| V1 Technologies | V1 | | V2 | 0 | V3 | R | V4 | R | V5 | 0 | V6 | 0 | | | | | | | | | | 2X |
| competencies | Vc1 | 0 | Vc2 | 0 | Vc3 | R | Vc4 | R | | | | | | | | | | | | | Vc | 2X |
| and know-how | Vk1 | A | Vk2 | R | Vk3 | A | Vk4 | 0 | Vk5 | 0 | Vk6 | R | Vk7 | 0 | Vk8 | 0 | Vk9 | 0 | Vk10 | R | Vk | 5X |
| management for | Vp1 | 0 | Vp2 | R | Vp3 | R | Vp4 | 0 | Vp5 | R | Vp6 | R | | | | | | | | | Vp | 4X |
| projects | | | | | | | | | | | | | | | | | | | | | | |
| V2 Pre-sales | V1 | 0 | V2 | | V3 | R | V4 | R | V5 | 0 | V6 | A | | | | | | | | | | 3X |
| Business capture | Vc1 | 0 | Vc2 | 0 | Vc3 | 0 | Vc4 | 0 | | | | | | | | | | | | | Vc | 0 |
| and technical | Vk1 | 0 | Vk2 | 0 | Vk3 | R | Vk4 | A | Vk5 | A | Vk6 | 0 | Vk7 | R | Vk8 | R | Vk9 | R | Vk10 | 0 | Vk | 6X |
| solution | Vp1 | A | Vp2 | A | Vp3 | A | Vp4 | R | Vp5 | A | Vp6 | R | | | | | | | | | Vp | 6X |
| V3 Projects | V1 | A | V2 | R | V3 | | V4 | A | V5 | A | V6 | R | | | | | | | | | | 5X |
| execution | Vc1 | R | Vc2 | A | Vc3 | A | Vc4 | 0 | | | | | | | | | | | | | Vc | 3X |
| | Vk1 | R | Vk2 | R | Vk3 | R | Vk4 | R | Vk5 | R | Vk6 | R | Vk7 | R | Vk8 | R | Vk9 | R | Vk10 | R | Vk | 10X |
| | Vp1 | 0 | Vp2 | 0 | Vp3 | 0 | Vp4 | 0 | Vp5 | 0 | Vp6 | 0 | | | | | | | | | Vp | 0 |
| V4 GO-Live & | V1 | A | V2 | R | V3 | R | V4 | | V5 | A | V6 | 0 | | | | | | | | | | 4X |
| Production | Vc1 | R | Vc2 | A | Vc3 | A | Vc4 | 0 | | | | | | | | | | | | | Vc | 3X |
| change | Vk1 | R | Vk2 | R | Vk3 | R | Vk4 | R | Vk5 | R | Vk6 | R | Vk7 | R | Vk8 | R | Vk9 | R | Vk10 | R | Vk | 10X |
| management | Vp1 | 0 | Vp2 | 0 | Vp3 | 0 | Vp4 | 0 | Vp5 | 0 | Vp6 | 0 | | | | | | | | | Vp | 0 |
| assistance | | | | | | | | | | | | | | | | | | | | | | |
| V5 | V1 | 0 | V2 | 0 | V3 | 0 | V4 | 0 | V5 | | V6 | 0 | | | | | | | | | | 0 |
| Customer services | Vc1 | 0 | Vc2 | 0 | Vc3 | 0 | Vc4 | 0 | | | | | | | | | | | | | Vc | 0 |
| | Vk1 | 0 | Vk2 | 0 | Vk3 | R | Vk4 | 0 | Vk5 | 0 | Vk6 | 0 | Vk7 | 0 | Vk8 | 0 | Vk9 | 0 | Vk10 | R | Vk | 2X |
| | Vp1 | 0 | Vp2 | 0 | Vp3 | 0 | Vp4 | 0 | Vp5 | 0 | Vp6 | 0 | | | | | | | | | Vp | 0 |
| V6 | V1 | 0 | V2 | R | V3 | A | V4 | 0 | V5 | 0 | V6 | | | | | | | | | | | 2X |
| Marketing & | Vc1 | 0 | Vc2 | 0 | Vc3 | 0 | Vc4 | 0 | | | | | | | | | | | | | Vc | 0 |
| Public relations, | Vk1 | 0 | Vk2 | 0 | Vk3 | R | Vk4 | 0 | Vk5 | 0 | Vk6 | 0 | Vk7 | 0 | Vk8 | 0 | Vk9 | 0 | Vk10 | R | Vk | 2X |
| sales, CRM | Vp1 | 0 | Vp2 | A | Vp3 | 0 | Vp4 | R | Vp5 | 0 | Vp6 | R | | | | | | | | | Vp | 3X |

TABLE 5o
PRODUCTION

| | |
|---|---|
| V1 (V1) | No value contribution detected |
| V2 (V1) | No value contribution detected |
| AV3 (V1) | Project execution is based on project management know how & competencies |
| AV4 (V1) | Go live phase is is determined by project management know how & competencies |
| V5 (V1) | No value contribution detected |
| V6 (V1) | No value contribution detected |
| Vc1 (V1) | No value contribution detected |
| Vc2 (V1) | No value contribution detected |
| RVc3 (V1) | Feed back In competencies monitoring |
| RVc4 (V1) | Transforming project know how and competencies in competence production by formalising |
| AVk1 (V1) | Obvious |
| RVk2 (V1) | Technologies competencies and know how management for project increases know how usage of advanced methods |
| AVk3 (V1) | Technologies competencies and know how management for project reduces price at the same quality |
| Vk4 (V1) | No value contribution detected |
| Vk5 (V1) | No value contribution detected |
| RVk6 (V1) | Feed back on Go live optimization |
| Vk7 (V1) | No value contribution detected |
| Vk8 (V1) | No value contribution detected |
| Vk9 (V1) | No value contribution detected |
| RVk10 (V1) | during the project we train the customer project team |
| Vp1 (V1) | No value contribution detected |
| RVp2 (V1) | V1 is an asset in partner contract making |
| RVp3 (V1) | V1 is an asset packaging the partner's added value |
| Vp4 (V1) | No value contribution detected |
| RVp5 (V1) | V1 is an asset in product localization |
| RVp5 (V1) | V1 may demand increasing product competence |
| V1 (V2) | No value contribution detected |
| V2 (V2) | |
| RV3 (V2) | A good business capture smooths project execution |
| RV4 (V2) | Same |
| V5 (V2) | No value contribution detected |
| AV6 (V2) | Base of sales contract signature |
| Vc1 (V2) | No value contribution detected |
| Vc2 (V2) | No value contribution detected |
| Vc3 (V2) | No value contribution detected |
| Vc4 (V2) | No value contribution detected |
| Vk1 (V2) | No value contribution detected |
| Vk2 (V2) | No value contribution detected |
| RVk3 (V2) | A good business capture and an adeqvate technical solution determines Vk3 |
| AVk4 (V2) | Provides feedback |
| AVk5 (V2) | Technical solution Influences the volum of work in specific programming |
| Vk6 (V2) | No value contribution detected |
| RVk7 (V2) | Input for localization is generated by business capture |
| RVk8 (V2) | Provides inputs |
| RVk9 (V2) | Provides inputs |
| Vk10 (V2) | No value contribution detected |
| AVp1 (V2) | Pre-sales business capture might create the need for identification of a partner |
| AVp2 (V2) | Contracts may be signed with some of these technology partners |
| AVp3 (V2) | Technical solutions specify what we require from the partner |
| RVp4 (V2) | Presales result determines the level of partnership development |
| AVp5 (V2) | Presales result determines the need of partner technology localization |
| RVp6 (V2) | Technical solution determines the structure of competence building |
| AV1 (V3) | Provides input |
| RV2 (V3) | Provides feedback |
| V3 (V3) | |
| AV4 (V3) | Provides input |
| AV5 (V5) | Determines the volum of customer service |
| RV6 (V3) | References in marketing and sales and determines the volume of sales |
| RVc1 (V3) | During the project execution you may need additional competencies |
| AVc2 (V3) | Project execution determines developing competencies |
| AVc3 (V3) | Project execution provides feed back about competencies quality |
| Vc4 (V3) | No value contribution detected |
| RVk1 (V3) | Project execution provides feedback about competencies quality |
| RVk2 (V3) | project execution identify the need of developing and usage of advanced methods |
| RVk3 (V3) | professional project execution creates a prerequisite for a price/quality equation |
| RVk4 (V3) | provides feedback |
| RVk5 (V3) | provides feedback |
| RVk6 (V3) | provides feedback |
| RVk7 (V3) | provides feedback |
| RVk8 (V3) | provides feedback |
| RVk9 (V3) | provides feedback |
| RVk10 (V3) | provides feedback |
| Vp1 (V3) | No value contribution detected |
| Vp2 (V3) | No value contribution detected |
| Vp3 (V3) | No value contribution detected |
| Vp4 (V3) | No value contribution detected |
| Vp5 (V3) | No value contribution detected |
| Vp6 (V3) | No value contribution detected |
| AV1 (V4) | provides input |
| RV2 (V4) | provides feedback |
| RV3 (V4) | provides feedback |
| V4 (V4) | |
| AV5 (V4) | Determines the volum of customer service |
| V6 (V4) | References in marketing and sales and determines the volume of sales |

TABLE 5p
PRODUCTION

| | |
|---|---|
| RVc1 (V4) | During the Go-Live you may need additional competencies |
| AVc2 (V4) | go-live determines developing competencies |
| AVc3 (V4) | go-live provides feed back about competencies quality |
| Vc4 (V4) | No value contribution detected |
| RVk1 (V4) | go-live provides feedback about competencies quality |
| RVk2 (V4) | go-live Identify the need of developing and usage of advanced methods |
| RVk3 (V4) | professional project execution & go-live creates a prerequisite for a price/quality equation |
| RVk4 (V4) | provides feedback |
| RVk5 (V4) | provides feedback |
| RVk6 (V4) | provides feedback |
| RVk7 (V4) | provides feedback |
| RVk8 (V4) | provides feedback |
| RVk9 (V4) | provides feedback |
| RVk10 (V4) | provides feedback |
| Vp1 (V4) | No value contribution detected |
| Vp2 (V4) | No value contribution detected |
| Vp3 (V4) | No value contribution detected |
| Vp4 (V4) | No value contribution detected |
| Vp5 (V4) | No value contribution detected |
| Vp6 (V4) | No value contribution detected |
| V1 (V5) | No value contribution detected |
| V2 (V5) | No value contribution detected |
| V3 (V5) | No value contribution detected |
| V4 (V5) | No value contribution detected |
| V5 (V5) | No value contribution detected |
| RV6 (V5) | high level of customer services may increase the sales volume |
| Vc1 (V5) | No value contribution detected |
| Vc2 (V5) | No value contribution detected |
| Vc3 (V5) | No value contribution detected |
| Vc4 (V5) | No value contribution detected |
| Vk1 (V5) | No value contribution detected |
| Vk2 (V5) | No value contribution detected |
| RVk3 (V5) | high level of customer services reduces the TCO |
| Vk4 (V5) | No value contribution detected |
| Vk5 (V5) | No value contribution detected |
| Vk6 (V5) | No value contribution detected |
| Vk7 (V5) | No value contribution detected |
| Vk8 (V5) | No value contribution detected |
| Vk9 (V5) | No value contribution detected |
| RVk10 (V5) | employees involved in customer service will achieve practical experience |
| Vp1 (V5) | No value contribution detected |
| Vp2 (V5) | No value contribution detected |
| Vp3 (V5) | No value contribution detected |
| Vp4 (V5) | No value contribution detected |
| Vp5 (V5) | No value contribution detected |
| Vp6 (V5) | No value contribution detected |
| V1 (V6) | No value contribution detected |
| RV2 (V6) | provides input in presales |
| AV3 (V6) | sales determines project execution |
| V4 (V6) | No value contribution detected |
| V5 (V6) | No value contribution detected |
| V6 (V6) | |
| Vc1 (V6) | No value contribution detected |
| Vc2 (V6) | No value contribution detected |
| Vc3 (V6) | No value contribution detected |
| Vc4 (V6) | No value contribution detected |
| Vk1 (V6) | No value contribution detected |
| Vk2 (V6) | No value contribution detected |
| RVk3 (V6) | high level of CRM reduces the TCO |
| Vk4 (V6) | No value contribution detected |
| Vk5 (V6) | No value contribution detected |
| Vk6 (V6) | No value contribution detected |
| Vk7 (V6) | No value contribution detected |
| Vk8 (V6) | No value contribution detected |
| Vk9 (V6) | No value contribution detected |
| RVk10 (V6) | CRM team experience Improves the knowhow in customer services |
| Vp1 (V6) | No value contribution detected |
| AVp2 (V6) | new customer requirement captured through CRM&sales determines making partners contract |
| Vp3 (V6) | No value contribution detected |
| RVp4 (V6) | business plan provides the input for partnership development |
| Vp5 (V6) | No value contribution detected |
| RVp6 (V6) | business plan provides the input for competence building inside a partnership |

TABLE 5q

| Partnership | Vp1 | | Vp2 | | Vp3 | | Vp4 | | Vp5 | | Vp6 | | | | | | | | | | Sum (Vp) | |
|---|---|---|---|---|---|---|---|---|---|---|---|---|---|---|---|---|---|---|---|---|---|---|
| Vp1 | Vp1 | | Vp2 | R | Vp3 | 0 | Vp4 | 0 | Vp5 | 0 | Vp6 | 0 | | | | | | | | | Vp | 1X |
| Identification of | V1 | 0 | V2 | 0 | V3 | 0 | V4 | 0 | V5 | 0 | V6 | R | | | | | | | | | V | 1X |
| the leading | Vk1 | 0 | Vk2 | 0 | Vk3 | 0 | Vk4 | 0 | Vk5 | 0 | Vk6 | 0 | Vk7 | 0 | Vk8 | 0 | Vk9 | 0 | Vk10 | 0 | Vk | 0 |
| technology | Vc1 | 0 | Vc2 | 0 | Vc3 | 0 | Vc4 | 0 | | | | | | | | | | | | | Vc | 0 |
| partners | | | | | | | | | | | | | | | | | | | | | | |
| Vp2 | Vp1 | 0 | Vp2 | | Vp3 | A | Vp4 | A | Vp5 | A | Vp6 | R | | | | | | | | | Vp | 4X |
| Making partner | V1 | 0 | V2 | R | V3 | A | V4 | A | V5 | A | V6 | R | | | | | | | | | V | 5X |
| contracts with | Vk1 | 0 | Vk2 | 0 | Vk3 | 0 | Vk4 | 0 | Vk5 | 0 | Vk6 | 0 | Vk7 | 0 | Vk8 | 0 | Vk9 | 0 | Vk10 | R | Vk | 1X |
| the industry | Vc1 | 0 | Vc2 | 0 | Vc3 | 0 | Vc4 | A | | | | | | | | | | | | | Vc | 1X |
| “leaders” | | | | | | | | | | | | | | | | | | | | | | |
| Vp3 | Vp1 | 0 | Vp2 | 0 | Vp3 | | Vp4 | R | Vp5 | A | Vp6 | R | | | | | | | | | Vp | 3X |
| Packaging the | V1 | A | V2 | R | V3 | R | V4 | R | V5 | R | V6 | R | | | | | | | | | V | 6X |
| partnership | Vk1 | 0 | Vk2 | R | Vk3 | R | Vk4 | R | Vk5 | R | Vk6 | R | Vk7 | R | Vk8 | R | Vk9 | R | Vk10 | 0 | Vk | 8X |
| product with | Vc1 | 0 | Vc2 | A | Vc3 | R | Vc4 | R | | | | | | | | | | | | | Vc | 3X |
| our own | | | | | | | | | | | | | | | | | | | | | | |
| Vp4 | Vp1 | 0 | Vp2 | 0 | Vp3 | R | Vp4 | | Vp5 | R | Vp6 | R | | | | | | | | | Vp | 3X |
| Business | V1 | R | V2 | R | V3 | R | V4 | R | V5 | R | V6 | R | | | | | | | | | V | 6X |
| development | Vk1 | R | Vk2 | R | Vk3 | R | Vk4 | R | Vk5 | R | Vk6 | R | Vk7 | R | Vk8 | R | Vk9 | R | Vk10 | R | Vk | 10X |
| in partnership | Vc1 | 0 | Vc2 | R | Vc3 | R | Vc4 | R | | | | | | | | | | | | | Vc | 3X |
| Vp5 | Vp1 | 0 | Vp2 | 0 | Vp3 | R | Vp4 | R | Vp5 | | Vp6 | R | | | | | | | | | Vp | 3X |
| Partner | V1 | 0 | V2 | R | V3 | R | V4 | R | V5 | R | V6 | R | | | | | | | | | V | 5X |
| technology | Vk1 | 0 | Vk2 | R | Vk3 | R | Vk4 | R | Vk5 | R | Vk6 | R | Vk7 | R | Vk8 | R | Vk9 | R | Vk10 | 0 | Vk | 8X |
| localization | Vc1 | 0 | Vc2 | R | Vc3 | R | Vc4 | R | | | | | | | | | | | | | Vc | 3X |
| Vp6 | Vp1 | 0 | Vp2 | 0 | Vp3 | R | Vp4 | R | Vp5 | 0 | Vp6 | | | | | | | | | | Vp | 2X |
| Competence | V1 | 0 | V2 | R | V3 | R | V4 | R | V5 | R | V6 | R | | | | | | | | | V | 5X |
| building for the | Vk1 | R | Vk2 | 0 | Vk3 | R | Vk4 | R | Vk5 | 0 | Vk6 | 0 | Vk7 | R | Vk8 | R | Vk9 | R | Vk10 | 0 | Vk | 6X |
| product | Vc1 | 0 | Vc2 | R | Vc3 | R | Vc4 | A | | | | | | | | | | | | | Vc | 3X |

TABLE 5r

| Know how | Vk1 | | Vk2 | | Vk3 | | Vk4 | | Vk5 | | Vk6 | | Vk7 | | Vk8 | | Vk9 | | Vk10 | | Sum (Vk) | |
|---|---|---|---|---|---|---|---|---|---|---|---|---|---|---|---|---|---|---|---|---|---|---|
| Vk1 | Vk1 | | Vk2 | A | Vk3 | A | Vk4 | 0 | Vk5 | 0 | Vk6 | R | Vk7 | R | Vk8 | R | Vk9 | R | Vk10 | R | Vk | 7X |
| Project | Vp1 | 0 | Vp2 | 0 | Vp3 | 0 | Vp4 | R | Vp5 | 0 | Vp6 | 0 | | | | | | | | | Vp | 1X |
| Management | Vc1 | 0 | Vc2 | 0 | Vc3 | R | Vc4 | R | | | | | | | | | | | | | Vc | 2X |
| Knowhow | V1 | A | V2 | R | V3 | A | V4 | A | V5 | 0 | V6 | R | | | | | | | | | V | 5X |
| Vk2 | Vk1 | R | Vk2 | | Vk3 | R | Vk4 | R | Vk5 | R | Vk6 | R | Vk7 | R | Vk8 | R | Vk9 | R | Vk10 | 0 | Vk | 8X |
| Usage of | Vp1 | 0 | Vp2 | 0 | Vp3 | R | Vp4 | R | Vp5 | R | Vp6 | R | | | | | | | | | Vp | 4X |
| advanced | Vc1 | 0 | Vc2 | 0 | Vc3 | R | Vc4 | A | | | | | | | | | | | | | Vc | 2X |
| methods for | V1 | R | V2 | 0 | V3 | R | V4 | R | V5 | 0 | R | | | | | | | | | | V | 4X |
| project execution | | | | | | | | | | | | | | | | | | | | | | |
| Vk3 | Vk1 | 0 | Vk2 | R | Vk3 | | Vk4 | A | Vk5 | A | Vk6 | A | Vk7 | A | Vk8 | A | Vk9 | A | Vk10 | 0 | Vk | 7X |
| Competitive | Vp1 | 0 | Vp2 | 0 | Vp3 | A | Vp4 | R | Vp5 | A | Vp6 | R | | | | | | | | | Vp | 4X |
| price/quality | Vc1 | 0 | Vc2 | 0 | Vc3 | 0 | Vc4 | R | | 0 | | | | | | | | | | | Vc | 1X |
| project execution | V1 | A | V2 | 0 | V3 | A | V4 | A | V5 | 0 | V6 | R | | | | | | | | | V | 4X |
| Vk4 | Vk1 | 0 | Vk2 | 0 | Vk3 | R | Vk4 | | Vk5 | 0 | Vk6 | R | Vk7 | R | Vk8 | R | Vk9 | R | Vk10 | R | Vk | 6X |
| Business capture | Vp1 | 0 | Vp2 | R | Vp3 | R | Vp4 | R | Vp5 | 0 | Vp6 | 0 | | | | | | | | | Vp | 3X |
| and modelling | Vc1 | O | Vc2 | O | Vc3 | O | Vc4 | R | | | | | | | | | | | | | Vc | 1X |
| | V1 | 0 | V2 | A | V3 | 0 | V4 | 0 | V5 | 0 | V6 | R | | | | | | | | | V | 2X |
| Vk5 | Vk1 | 0 | Vk2 | 0 | Vk3 | R | Vk4 | 0 | Vk5 | 0 | Vk6 | R | Vk7 | A | Vk8 | 0 | Vk9 | A | Vk10 | O | Vk | 4X |
| Specific | Vp1 | 0 | Vp2 | 0 | Vp3 | 0 | Vp4 | R | Vp5 | A | Vp6 | 0 | | | | | | | | | Vp | 2X |
| programming | Vc1 | 0 | Vc2 | 0 | Vc3 | 0 | Vc4 | R | | | | | | | | | | | | | Vc | 1X |
| ABAP, HTML, | V1 | 0 | V2 | R | V3 | A | V4 | 0 | V5 | R | V6 | R | | | | | | | | | V | 4X |
| JAVA | | | | | | | | | | | | | | | | | | | | | | |
| Vk6 | Vk1 | | Vk2 | | Vk3 | | Vk4 | | Vk5 | | Vk6 | | Vk7 | | Vk8 | | Vk9 | | Vk10 | | Vk | |
| Go-live | Vp1 | | Vp2 | | Vp3 | | Vp4 | | Vp5 | | Vp6 | | | | | | | | | | Vp | |
| procedure & | Vc1 | | Vc2 | | Vc3 | | Vc4 | | | | | | | | | | | | | | Vc | |
| production | V1 | | V2 | | V3 | | V4 | | V5 | | V6 | | | | | | | | | | V | |
| assitance | | | | | | | | | | | | | | | | | | | | | | |
| Vk7 | Vk1 | | Vk2 | | Vk3 | | Vk4 | | Vk5 | | Vk6 | | | | Vk8 | | Vk9 | | Vk10 | | Vk | |
| Product | Vp1 | | Vp2 | | Vp3 | | Vp4 | | Vp5 | | Vp6 | | | | | | | | | | Vp | |
| localization | Vc1 | | Vc2 | | Vc3 | | Vc4 | | | | | | | | | | | | | | Vc | |
| | V1 | | V2 | | V3 | | V4 | | V5 | | V6 | | | | | | | | | | V | |
| Vk8 | Vk1 | | Vk2 | | Vk3 | | Vk4 | | Vk5 | | Vk6 | | Vk7 | | Vk8 | | Vk9 | | Vk10 | | Vk | |
| Infrastructure | Vp1 | | Vp2 | | Vp3 | | Vp4 | | Vp5 | | Vp6 | | | | | | | | | | Vp | |
| modelling | Vc1 | | Vc2 | | Vc3 | | Vc4 | | | | | | | | | | | | | | Vc | |
| | V1 | | V2 | | V3 | | V4 | | V5 | | V6 | | | | | | | | | | V | |
| Vk9 | Vk1 | | Vk2 | | Vk3 | | Vk4 | | Vk5 | | Vk6 | | Vk7 | | Vk8 | | Vk9 | | Vk10 | | Vk | |
| Business | Vp1 | | Vp2 | | Vp3 | | Vp4 | | Vp5 | | Vp6 | | | | | | | | | | Vp | |
| intelligence | Vc1 | | Vc2 | | Vc3 | | Vc4 | | | | | | | | | | | | | | Vc | |
| | V1 | | V2 | | V3 | | V4 | | V5 | | V6 | | | | | | | | | | V | |
| Vk10 | Vk1 | | Vk2 | | Vk3 | | Vk4 | | Vk5 | | Vk6 | | Vk7 | | Vk8 | | Vk9 | | Vk10 | | Vk | |
| Customer service | Vp1 | | Vp2 | | Vp3 | | Vp4 | | Vp5 | | Vp6 | | | | | | | | | | Vp | |
| and education | Vc1 | | Vc2 | | Vc3 | | Vc4 | | | | | | | | | | | | | | Vc | |
| | V1 | | V2 | | V3 | | V4 | | V5 | | V6 | | | | | | | | | | V | |

TABLE 5s

| Competence | Vc1 | | Vc2 | | Vc3 | | Vc4 | | | | | | | | | | | | | | Sum (Vc) | |
|---|---|---|---|---|---|---|---|---|---|---|---|---|---|---|---|---|---|---|---|---|---|---|
| Vc1 | Vc1 | | Vc2 | A | Vc3 | R | Vc4 | R | | | | | | | | | | | | | Vc | 3X |
| Competence | V1 | R | V2 | 0 | V3 | R | V4 | R | V5 | 0 | V6 | R | | | | | | | | | V | 4X |
| Identification and | Vk1 | 0 | Vk2 | 0 | Vk3 | 0 | Vk4 | 0 | Vk5 | 0 | Vk6 | 0 | Vk7 | 0 | Vk8 | 0 | Vk9 | 0 | Vk10 | 0 | Vk | 0 |
| selection | Vp1 | 0 | Vp2 | 0 | Vp3 | 0 | Vp4 | 0 | Vp5 | 0 | Vp6 | 0 | | | | | | | | | Vp | 0 |
| Vc2 | Vc1 | R | Vc2 | | Vc3 | A | Vc4 | R | | | | | | | | | | | | | Vc | 3X |
| Competence | V1 | R | V2 | R | V3 | R | V4 | R | V5 | 0 | V6 | R | | | | | | | | | V | 5X |
| structuring, | Vk1 | 0 | Vk2 | 0 | Vk3 | 0 | Vk4 | 0 | Vk5 | 0 | Vk6 | 0 | Vk7 | 0 | Vk8 | 0 | Vk9 | 0 | Vk10 | 0 | Vk | 0 |
| developing & | Vp1 | 0 | Vp2 | 0 | Vp3 | R | Vp4 | R | Vp5 | R | Vp6 | R | | | | | | | | | Vp | 4X |
| maintaining | | | | | | | | | | | | | | | | | | | | | | |
| Vc3 | Vc1 | A | Vc2 | 0 | Vc3 | | Vc4 | A | | | | | | | | | | | | | Vc | 2X |
| Competence | V1 | R | V2 | R | V3 | R | V4 | R | V5 | 0 | V6 | 0 | | | | | | | | | V | 4X |
| monitoring: | Vk1 | 0 | Vk2 | 0 | Vk3 | 0 | Vk4 | 0 | Vk5 | 0 | Vk6 | 0 | Vk7 | 0 | Vk8 | 0 | Vk9 | 0 | Vk10 | 0 | Vk | 0 |
| quality & | Vp1 | 0 | Vp2 | A | Vp3 | R | Vp4 | R | Vp5 | R | Vp6 | R | | | | | | | | | Vp | 5X |
| requirements | | | | | | | | | | | | | | | | | | | | | | |
| Vc4 | Vc1 | 0 | Vc2 | R | Vc3 | R | Vc4 | | | | | | | | | | | | | | Vc | 2X |
| Competence | V1 | R | V2 | R | V3 | R | V4 | R | V5 | 0 | V6 | R | | | | | | | | | V | 5X |
| production | Vk1 | 0 | Vk2 | 0 | Vk3 | 0 | Vk4 | 0 | Vk5 | 0 | Vk6 | 0 | Vk7 | 0 | Vk8 | 0 | Vk9 | 0 | Vk10 | 0 | Vk | 0 |
| | Vp1 | 0 | Vp2 | 0 | Vp3 | R | Vp4 | R | Vp5 | R | Vp6 | 0 | | | | | | | | | Vp | 3X |
| Product | V1 | | V2 | | V3 | | V4 | | V5 | | V6 | | | | | | | | | | Sum (V) | |
| V1 | V1 | | V2 | 0 | V3 | R | V4 | R | V5 | 0 | V6 | 0 | | | | | | | | | | 2X |
| Technologies | Vc1 | 0 | Vc2 | 0 | Vc3 | R | Vc4 | R | | | | | | | | | | | | | Vc | 2X |
| competencies and | Vk1 | A | Vk2 | R | Vk3 | A | Vk4 | 0 | Vk5 | 0 | Vk6 | R | Vk7 | 0 | Vk8 | 0 | Vk9 | 0 | Vk10 | R | Vk | 5X |
| know-how | Vp1 | 0 | Vp2 | R | Vp3 | R | Vp4 | 0 | Vp5 | R | Vp6 | R | | | | | | | | | Vp | 4X |
| management for | | | | | | | | | | | | | | | | | | | | | | |
| V2 | V1 | 0 | V2 | | V3 | R | V4 | R | V5 | 0 | V6 | A | | | | | | | | | | 3X |
| Pre-sales | Vc1 | 0 | Vc2 | 0 | Vc3 | 0 | Vc4 | 0 | | | | | | | | | | | | | Vc | 0 |
| Business capture | Vk1 | 0 | Vk2 | 0 | Vk3 | R | Vk4 | A | Vk5 | A | Vk6 | 0 | Vk7 | R | Vk8 | R | Vk9 | R | Vk10 | 0 | Vk | 6X |
| solution | Vp1 | A | Vp2 | A | Vp3 | A | Vp4 | R | Vp5 | A | Vp6 | R | | | | | | | | | Vp | 6X |
| and technical | | | | | | | | | | | | | | | | | | | | | | |
| V3 | V1 | A | V2 | R | V3 | | V4 | A | V5 | A | V6 | R | | | | | | | | | | 5X |
| Projects execution | Vc1 | R | Vc2 | A | Vc3 | A | Vc4 | 0 | | | | | | | | | | | | | Vc | 3X |
| | Vk1 | R | Vk2 | R | Vk3 | R | Vk4 | R | Vk5 | R | Vk6 | R | Vk7 | R | Vk8 | R | Vk9 | R | Vk10 | R | Vk | 10X |
| | Vp1 | 0 | Vp2 | 0 | Vp3 | 0 | Vp4 | 0 | Vp5 | 0 | Vp6 | 0 | | | | | | | | | Vp | 0 |
| V4 | V1 | A | V2 | R | V3 | R | V4 | | V5 | A | V6 | 0 | | | | | | | | | | 4X |
| Go-Live & | Vc1 | R | Vc2 | A | Vc3 | A | Vc4 | 0 | | | | | | | | | | | | | Vc | 3X |
| Production | Vk1 | R | Vk2 | R | Vk3 | R | Vk4 | R | Vk5 | R | Vk6 | R | Vk7 | R | Vk8 | R | Vk9 | R | Vk10 | R | Vk | 10X |
| change | Vp1 | 0 | Vp2 | 0 | Vp3 | 0 | Vp4 | 0 | Vp5 | 0 | Vp6 | 0 | | | | | | | | | Vp | 0 |
| management | | | | | | | | | | | | | | | | | | | | | | |
| assistance | | | | | | | | | | | | | | | | | | | | | | |
| V5 | V1 | 0 | V2 | 0 | V3 | 0 | V4 | 0 | V5 | | V6 | 0 | | | | | | | | | | 0 |
| Customer | Vc1 | 0 | Vc2 | 0 | Vc3 | 0 | Vc4 | 0 | | | | | | | | | | | | | Vc | 0 |
| services | Vk1 | 0 | Vk2 | 0 | Vk3 | R | Vk4 | 0 | Vk5 | 0 | Vk6 | 0 | Vk7 | 0 | Vk8 | 0 | Vk9 | 0 | Vk10 | R | Vk | 2X |
| | Vp1 | 0 | Vp2 | 0 | Vp3 | 0 | Vp4 | 0 | Vp5 | 0 | Vp6 | 0 | | | | | | | | | Vp | 0 |
| V6 | V1 | 0 | V2 | R | V3 | A | V4 | 0 | V5 | 0 | V6 | | | | | | | | | | | 2X |
| Marketing & | Vc1 | 0 | Vc2 | 0 | Vc3 | 0 | Vc4 | 0 | | | | | | | | | | | | | Vc | 0 |
| Public relations, | Vk1 | 0 | Vk2 | 0 | Vk3 | R | Vk4 | 0 | Vk5 | 0 | Vk6 | 0 | Vk7 | 0 | Vk8 | 0 | Vk9 | 0 | Vk10 | R | Vk | 2X |
| sales, CRM | Vp1 | 0 | Vp2 | A | Vp3 | 0 | Vp4 | R | Vp5 | 0 | Vp6 | R | | | | | | | | | Vp | 3X |

What is claimed is:

1. A method for optimizing a company structure comprising the following steps:
(a) subdividing the company structure in at least a producing section and a non-producing section;
generating a value chain for said producing section by assigning a value to each participating structure element;
generating a value chain for said non-producing section by assigning a value to each participating structure element,
(b) building a matrix by the said chains; and
(c) optimizing every value in the said matrix and considering the influence to the whole company structure, which is represented by the said matrix.

2. A method for optimizing a company structure as claimed in claim 1, wherein a multi dimensional matrix is built from the value chains.

3. A method for optimizing a company structure as claimed in claim 1, further comprising the step of generating a value chain of competence.

4. A method for optimizing a company structure as claimed in claim 1, further comprising the step of generating a value chain of internal and/or external competence.

5. A method for optimizing a company structure as claimed in claim 1, further comprising the step of generating a value chain of internal production.

6. A method for optimizing a company structure as claimed in claim 1, further comprising the step of generating a value chain of partnership.

7. A method for optimizing a company structure as claimed in claim 1, further comprising the step of generating a value chain of internal and/or external know-how.

8. A method for optimizing a company structure as claimed in claim 1, further comprising the step of standardizing the values of the value chains in comparable values.

9. A device for optimizing a company structure containing
(a) a computer device including an input device and an output device;
(b) a value chain generator which generates digital value chains of different company components by assigning a value to each participating structure element of the said company components;
(c) an evaluation unit for building and evaluating a matrix representing the company structure generated by the said value chains; and
(d) optimizing means for optimizing each value of the value chains.

10. A device for optimizing a company structure as claimed in claim 9, wherein the optimizing means contain a mathematical optimization algorithm.

11. A device for optimizing a company structure as claimed in claim 9, wherein the said matrix is a multi dimensional matrix.

12. A device for optimizing a company structure as claimed in claim 9, wherein the value chain generator generates a value chain of competence.

13. A device for optimizing a company structure as claimed in claim 9, wherein the value chain generator generates a value chain of internal and/or external competence.

14. A device for optimizing a company structure as claimed in claim 9, wherein the value chain generator generates a value chain of internal and/or external production.

15. A device for optimizing a company structure as claimed in claim 9, wherein the value chain generator generates a value chain of partnership.

16. A device for optimizing a company structure as claimed in claim 9, wherein the value chain generator generates a value chain of know-how.

17. A device for optimizing a company structure as claimed in claim 9, wherein standardizing means for standardizing the values of the value chains in comparable values.
